(19) United States
(12) Patent Application Publication
(10) Pub. No.: US 2025/0392699 A1
(43) Pub. Date: Dec. 25, 2025

(54) POINT CLOUD ENCODING METHOD, POINT CLOUD DECODING METHOD, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/311,125

(22) Filed: Aug. 27, 2025

Related U.S. Application Data
(63) Continuation of application No. PCT/CN2023/078814, filed on Feb. 28, 2023.

(51) Int. Cl. H04N 19/105; H04N 19/159; H04N 19/196; H04N 19/597

(52) U.S. Cl. CPC H04N 19/105; H04N 19/159; H04N 19/196; H04N 19/597

(57) ABSTRACT

A point cloud decoding method includes: determining a decoding mode of a current point in a current node, where the current node is a node to be decoded in a current picture to be decoded; in a case where the decoding mode of the current point is a skipDecodeMode, determining at least one prediction point of the current point among points included in N prediction nodes of the current node, where the prediction nodes are nodes corresponding to the current node in prediction reference pictures of the current picture to be decoded, the skipDecodeMode is a mode for skipping decoding of geometric information of the current point, and N is a positive integer; and determining the geometric information of the current point based on geometric information of the at least one prediction point.

### CROSS-REFERENCE TO RELATED APPLICATION

This application is a Continuation application of International Application No. PCT/CN2023/078814 filed on Feb. 28, 2023, which is incorporated herein by reference in its entirety.

### TECHNICAL FIELD

The present application relates to the field of point cloud technology, and in particular, to point cloud encoding and decoding methods, apparatuses, a device, and a storage medium.

### BACKGROUND

A surface of an object is captured by an acquisition device to create point cloud data, and the point cloud data includes hundreds of thousands or even more points. During a video production process, the point cloud data is transmitted between a point cloud encoding device and a point cloud decoding device in the form of a point cloud media file. However, such a large number of points poses a challenge for transmission. Thus, the point cloud encoding device needs to compress the point cloud data before transmission.

Point cloud compression is also called point cloud encoding. In a point cloud encoding process, for points that are isolated in the geometric space, use of the infer direct coding model (DCM) may greatly reduce complexity. In a case where the DCM is used to encode and decode a current node, geometric information of a point of a current node is directly coded. However, in the related art, in a case where the geometric information of the point of the current node is directly encoded and decoded, there is a problem of low coding performance.

### SUMMARY

In a first aspect, the embodiments of the present application provide a point cloud decoding method, which includes:
determining a decoding mode of a current point in a current node, where the current node is a node to be decoded in a current picture to be decoded;
in a case where the decoding mode of the current point is a skip decode mode (skipDecodeMode), determining at least one prediction point of the current point among points included in N prediction nodes of the current node, where the prediction nodes are nodes corresponding to the current node in prediction reference pictures of the current picture to be decoded, the skipDecodeMode is a mode for skipping decoding of geometric information of the current point, and N is a positive integer; and
determining the geometric information of the current point based on geometric information of the at least one prediction point.

In a second aspect, the present application provides a point cloud encoding method, which includes:
determining an encoding mode of a current point in a current node, where the current node is a node to be encoded in a current picture to be encoded; and
in a case where the encoding mode of the current point is a skip encode mode (skipCodeMode), skipping encoding of geometric information of the current point.

In a third aspect, the present application provides a point cloud decoding apparatus, which is used to perform the method in the first aspect or in various implementations thereof. In some embodiments, the apparatus includes functional units used to perform the method in the first aspect or in various implementations thereof.

In a fourth aspect, the present application provides a point cloud encoding apparatus, which is used to perform the method in the second aspect or in various implementations thereof. The apparatus includes functional units used to perform the method in the second aspect or in various implementations thereof.

In a fifth aspect, a point cloud decoder is provided, which includes a processor and a memory. The memory is used to store a computer program, and the processor is used to call the computer program stored in the memory and run the computer program, to perform the method in the first aspect or in various implementations thereof.

In a sixth aspect, a point cloud encoder is provided, which includes a processor and a memory. The memory is used to store a computer program, and the processor is used to call the computer program stored in the memory and run the computer program, to perform the method in the second aspect or in various implementations thereof.

In a seventh aspect, a point cloud encoding and decoding system is provided, which includes a point cloud encoder and a point cloud decoder. The point cloud decoder is used to perform the method in the first aspect or in various implementations thereof, and the point cloud encoder is used to perform the method in the second aspect or in various implementations thereof.

In an eighth aspect, a chip is provided, which is used to implement the method in any one of the first aspect to the second aspect or in various implementations thereof. In some embodiments, the chip includes: a processor, which is used to call a computer program from a memory and run the computer program, to enable a device equipped with the chip to perform the method in any one of the first aspect to the second aspect or in various implementations thereof.

In a ninth aspect, a non-transitory computer-readable storage medium is provided, which is used to store a computer program enabling a computer to perform the method in any one of the first aspect to the second aspect or in various implementations thereof.

In a tenth aspect, a computer program product is provided, which includes computer program instructions enabling a computer to perform the method in any one of the first aspect to the second aspect or in various implementations thereof.

In an eleventh aspect, a computer program is provided, and the computer program, when run on a computer, enables the computer to perform the method in any one of the first aspect to the second aspect or in various implementations thereof.

### BRIEF DESCRIPTION OF THE DRAWINGS

FIG. 1A is a schematic diagram of a point cloud;

FIG. 1B is a partially enlarged diagram of a point cloud;

FIG. 2 is a schematic diagram of a point cloud picture at six viewing angles;

FIG. 3 is a schematic block diagram of a point cloud encoding and decoding system involved in embodiments of the present application;

FIG. 4A is a schematic block diagram of a point cloud encoder provided in embodiments of the present application;

FIG. 4B is a schematic block diagram of a point cloud decoder provided in embodiments of the present application;

FIG. 5A is a schematic diagram of a plane;

FIG. 5B is a schematic diagram of a node encoding sequence;

FIG. 5C is a schematic diagram of a planar flag;

FIG. 5D is a schematic diagram of sibling nodes;

FIG. 5E is a schematic diagram of an intersection of a laser radar and a node;

FIG. 5F is a schematic diagram of a neighborhood node at the same partition depth and the same coordinate;

FIG. 5G is a schematic diagram of neighborhood nodes in a case where a node is located at a low planar position of a parent node;

FIG. 5H is a schematic diagram of neighborhood nodes in a case where a node is located at a high planar position of a parent node;

FIG. 5I is a schematic diagram of a predictive encoding of planar position information of a laser radar point cloud;

FIG. 6A is a schematic diagram of an IDCM encoding;

FIG. 6B is a schematic diagram of a coordinate transform of a point cloud obtained by a rotating laser radar;

FIG. 6C is a schematic diagram of a predictive encoding in an X axis direction or a Y axis direction;

FIG. 6D is a schematic diagram of a prediction of an angle of an X or Y plane based on a horizontal azimuth angle;

FIG. 6E is a schematic diagram of a predictive encoding of an X axis or Y axis;

FIGS. 7A to 7C are schematic diagrams of a geometric information encoding based on triangle soup;

FIG. 8A is a schematic diagram of a distance-based LOD construction;

FIG. 8B is a subjective schematic diagram of a distance-based LOD generation process;

FIG. 8C is a flowchart of a predictive encoding;

FIG. 8D is a schematic diagram of a LOD partition;

FIG. 8E is a schematic diagram of an inter-layer nearest-neighbor search;

FIG. 8F is a schematic diagram of a nearest-neighbor search based on spatial relationships;

FIG. 8G is a schematic diagram of a nearest-neighbor search for coplanar, co-edge and co-pointed;

FIG. 8H is a schematic diagram of a neighboring points search;

FIG. 8I is a schematic diagram of a neighboring points search;

FIG. 8J is a schematic diagram of a neighboring points search based on a fast search algorithm;

FIG. 8K is a schematic diagram of an inter nearest-neighbor search;

FIG. 8L is a flowchart of a lifting transform;

FIG. 8N is a schematic diagram of a RAHT transform process along x, y, and z directions;

FIG. 8M is a schematic diagram of a RAHT transform;

FIG. 8O is a schematic diagram of a RAHT forward transform and inverse transform;

FIG. 9 is a flowchart schematic of a point cloud decoding method provided by an embodiment of the present application;

FIG. 10 is a schematic diagram of an octree partition;

FIG. 11 is a schematic diagram of a prediction node;

FIG. 12 is a schematic diagram of a neighborhood node;

FIG. 13A is a schematic diagram of a prediction node of a current node in a prediction reference picture;

FIG. 13B is a schematic diagram of prediction nodes of a current node in two prediction reference pictures;

FIG. 14 is a schematic diagram of a corresponding node of a neighborhood node;

FIG. 15 is a schematic flowchart of a point cloud encoding method provided in an embodiment of the present application;

FIG. 16 is a schematic block diagram of a point cloud decoding apparatus provided in embodiments of the present application;

FIG. 17 is a schematic block diagram of a point cloud encoding apparatus provided in embodiments of the present application;

FIG. 18 is a schematic block diagram of an electronic device provided in embodiments of the present application; and

FIG. 19 is a schematic block diagram of a point cloud encoding and decoding system provided in embodiments of the present application.

### DETAILED DESCRIPTION

The present application may be applied to the field of point cloud up-sampling technology, for example, may be applied to the field of point cloud compression technology.

To facilitate the understanding of the embodiments of the present application, related concepts involved in the embodiments of the present application are briefly introduced as follows.

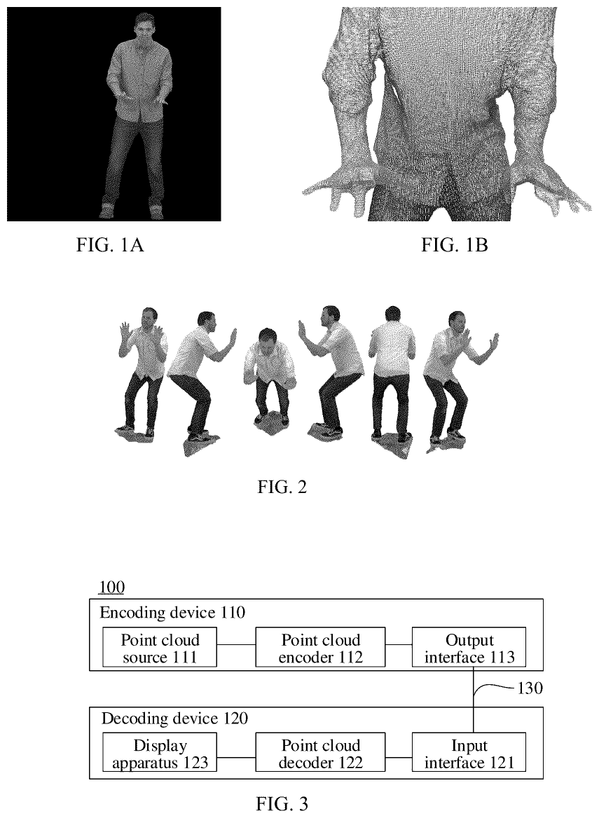

A point cloud refers to a set of discrete points in space that are irregularly distributed and expresses spatial structures and surface attributes of three-dimensional objects or three-dimensional scenes. FIG. 1A is a schematic diagram of a three-dimensional point cloud picture. FIG. 1B is a partially enlarged diagram of FIG. 1A. It may be seen from FIG. 1A and FIG. 1B that a point cloud surface is composed of densely distributed points.

A two-dimensional picture has information expression at each sample point, with a regular distribution, so there is no need to record position information of the two-dimensional picture additionally. However, distribution of points in a point cloud in three-dimensional space is random and irregular, so it is necessary to record a position of each point in space in order to fully express the entire point cloud. Similar to the two-dimensional picture, each position in a collection process has corresponding attribute information.

Point cloud data is a record form of a point cloud. A point in the point cloud may include position information and attribute information of the point. For example, the position information of the point may be three-dimensional coordinate information of the point. The position information of the point may also be referred to as geometric information of the point. For example, the attribute information of the point may include color information, reflectance information, normal vector information, or the like. The color information reflects a color of an object. The reflectance information reflects a surface material of an object. The color information may be information in any color space. For example, the color information may be RGB. As another example, the color information may be luma and chroma (YCbCr, YUV) information. For example, Y represents luma, Cb (U) represents blue color difference, Cr (V) represents red, and U and V represent chroma for describing color difference information. For example, for a point cloud obtained according to a laser measurement principle, a point in the point cloud may include three-dimensional coordinate information of the point and laser reflectance intensity of the point. As another example, for a point cloud obtained according to a photogrammetry principle, a point in the point cloud may include three-dimensional coordinate information of the point and color information of the point. As yet another example, for a point cloud obtained by combining the laser measurement principle and the photogrammetry principle, a point in the point cloud may include three-dimensional coordinate information of the point, laser reflectance intensity of the point, and color information of the point. FIG. 2 shows a point cloud picture, where FIG. 2 shows the point cloud picture at six viewing angles. Table 1 shows a point cloud data storage format consisting of a file header information part and a data part.

TABLE 1

| | |
|---|---|
| 1 | ply |
| 2 | format ascii 1.0 |
| 3 | element vertex 207242 |
| 4 | property float x |
| 5 | property float y |
| 6 | property float z |
| 7 | property uchar red |
| 8 | property uchar green |
| 9 | property uchar blue |
| 10 | end_header |
| 11 | 75 318 0 0 142 0 |
| 12 | 75 319 0 0 143 0 |
| 13 | 75 319 1 1 9 9 |
| 14 | 77 315 0 1 9 9 |

In Table 1, the header information includes data format, data representation type, a total number of points in the point cloud, and the content represented by the point cloud. For example, the point cloud in this example is in “.ply” format, represented by ASCII code, with a total of 207,242 points. Each point has three-dimensional position information XYZ and three-dimensional color information RGB.

The point cloud may flexibly and conveniently express spatial structures and surface attributes of three-dimensional objects or scenes. Moreover, the point cloud is obtained by directly sampling real objects, and the point cloud may provide a strong sense of reality under the premise of ensuring accuracy; therefore, the point cloud has a wide range of applications, which include virtual reality games, computer-aided design, geographic information systems, automatic navigation systems, digital cultural heritage, free-viewpoint broadcasting, three-dimensional immersive remote presentation, and three-dimensional reconstruction of biological tissues and organs.

Acquisition approaches for the point cloud data may include, but are not limited to, at least one of the following: (1) generated by a computer device, where the computer device may generate the point cloud data based on virtual three-dimensional objects and virtual three-dimensional scenes; (2) acquired by 3-Dimension (3D) laser scanning, where point cloud data of three-dimensional objects or three-dimensional scenes of static real world may be acquired by the 3D laser scanning, and millions of point cloud data may be acquired per second; (3) acquired by 3D photogrammetry, where visual scenes of real world are collected by a 3D photography device (i.e., a group of cameras or a camera device with multiple lenses and multiple sensors), to acquire point cloud data of the visual scenes in real world, and point cloud data of three-dimensional objects or three-dimensional scenes of dynamic real world may be acquired by 3D photography; or (4) point cloud data of biological tissues and organs acquired by a medical device, where in the medical field, the point cloud data of biological tissues and organs may be acquired by a medical device such as magnetic resonance imaging (MRI), computed tomography (CT), and electromagnetic positioning systems.

Point clouds may be classified into dense point clouds and sparse point clouds based on acquisition approaches.

The point clouds are classified into the following types based on a time series of the data:
first type: static point clouds, where an object is stationary and a device for acquiring the point cloud is also stationary;
second type: dynamic point clouds, where an object is in motion but a device for acquiring the point cloud is stationary; and
third type: dynamically acquired point clouds, where a device for acquiring the point cloud is in motion.

The point clouds may be classified into two types based on uses of point clouds:
type 1: point clouds perceived by machines, which may be used in scenes such as autonomous navigation systems, real-time inspection systems, geographic information systems, visual sorting robots, and emergency rescue and disaster relief robots; and
type 2: point clouds perceived by human eyes, which may be used in point cloud application scenes such as digital cultural heritage, free-viewpoint broadcasting, three-dimensional immersive communication, and three-dimensional immersive interaction.

Through the above point cloud acquisition technologies, the cost and time period of acquiring the point cloud data are reduced and the accuracy of the data is improved. Change in the acquisition approaches of the point cloud data makes it possible to acquire a large amount of point cloud data. However, with growth of application requirements, processing of massive 3D point cloud data encounters bottlenecks caused by storage space and transmission bandwidth limitations.

Considering a point cloud video with a frame rate of 30 fps (frames per second) as an example, the number of points in each point cloud picture is 700,000, and each point has coordinate information XYZ (float) and color information RGB (uchar), so a data volume of the point cloud video for 10 s is approximately 0.7 million×(4 Byte×3+1 Byte×3)×30 fps×10 s=3.15 GB. However, for a 1,280×720 two-dimensional video with a YUV sampling format of 4:2:0 and the frame rate of 24 fps, its data volume for 10 s is approximately 1,280×720× 12 bits×24 frames×10 s≈0.33 GB; and a data volume for a 10 s two-viewing angle 3D video is approximately 0.33×2=0.66 GB. It can be seen that the data volume of the point cloud video far exceeds that of 2D video and 3D video of the same length. Therefore, in order to better fulfill data management, save server storage space, and reduce transmission traffic and transmission time between a server and a client, point cloud compression has become a key issue in promoting the development of point cloud industry.

Related knowledge of point cloud encoding and decoding will be introduced below.

FIG. 3 is a schematic block diagram of a point cloud encoding and decoding system involved in the embodiments of the present application. It will be noted that FIG. 3 only shows an example, and the point cloud encoding and decoding system in the embodiments of the present application includes but is not limited to that shown in FIG. 3. As shown in FIG. 3, the point cloud encoding and decoding system 100 includes an encoding device 110 and a decoding device 120. The encoding device is configured to encode (which may be understood as compress) point cloud data to generate a bitstream, and transmit the bitstream to the decoding device. The decoding device decodes the bitstream generated by the encoding device to obtain decoded point cloud data.

The encoding device 110 in the embodiments of the present application can be understood as a device with a point cloud encoding function, and the decoding device 120 can be understood as a device with a point cloud decoding function. That is, in the embodiments of the present application, the encoding device 110 and the decoding device 120 contain a plurality of apparatuses, such as smartphones, desktop computers, mobile computing apparatuses, notebook (e.g., laptop) computers, tablet computers, set-top boxes, televisions, cameras, display apparatuses, digital media players, point cloud game consoles, and in-vehicle computers.

In some embodiments, the encoding device 110 may transmit encoded point cloud data (e.g., the bitstream) to the decoding device 120 via a channel 130. The channel 130 may include one or more media and/or apparatuses which are capable of transmitting the encoded point cloud data from the encoding device 110 to the decoding device 120.

In an instance, the channel 130 includes one or more communication media that enable the encoding device 110 to transmit the encoded point cloud data directly to the decoding device 120 in real time. In this instance, the encoding device 110 may modulate the encoded point cloud data based on a communication standard and transmit modulated point cloud data to the decoding device 120. The communication media includes a wireless communication media, e.g., a radio frequency spectrum. Optionally, the communication media may also include a wired communication media, e.g., one or more physical transmission lines.

In another instance, the channel 130 includes a storage medium, and the storage medium may store the point cloud data encoded by the encoding device 110. The storage medium includes a variety of locally accessible data storage media, such as an optical disk, a DVD, and a flash memory. In this instance, the decoding device 120 may acquire the encoded point cloud data from the storage medium.

In yet another instance, the channel 130 may include a storage server, and the storage server may store the point cloud data encoded by the encoding device 110. In this instance, the decoding device 120 may download the encoded point cloud data stored in the storage server from the storage server. Optionally, the storage server may store the encoded point cloud data and transmit the encoded point cloud data to the decoding device 120. For example, the storage server is a web server (e.g., for a website), a file transfer protocol (FTP) server, etc.

In some embodiments, the encoding device 110 includes a point cloud encoder 112 and an output interface 113. The output interface 113 may include a modulator/demodulator (a modem) and/or a transmitter.

In some embodiments, the encoding device 110 may further include a point cloud source 111 in addition to the point cloud encoder 112 and the output interface 113.

The point cloud source 111 may include at least one of: a point cloud collection apparatus (e.g., a scanner), a point cloud archive, a point cloud input interface, or a computer graphics system. The point cloud input interface is used to receive point cloud data from a point cloud content provider. The computer graphics system is used to generate point cloud data.

The point cloud encoder 112 encodes the point cloud data from the point cloud source 111 to generate a bitstream. The point cloud encoder 112 transmits the encoded point cloud data directly to the decoding device 120 via the output interface 113. The encoded point cloud data may further be stored on a storage medium or a storage server for subsequent reading by the decoding device 120.

In some embodiments, the decoding device 120 includes an input interface 121 and a point cloud decoder 122.

In some embodiments, the decoding device 120 may further include a display apparatus 123 in addition to the input interface 121 and the point cloud decoder 122.

The input interface 121 includes a receiver and/or a modem. The input interface 121 receives the encoded point cloud data via the channel 130.

The point cloud decoder 122 is used to: decode the encoded point cloud data to obtain decoded point cloud data, and transmit the decoded point cloud data to the display apparatus 123.

The display apparatus 123 displays the decoded point cloud data. The display apparatus 123 may be integrated with or external to the decoding device 120. The display apparatus 123 may include various display apparatuses, such as a liquid crystal display (LCD), a plasma display, an organic light-emitting diode (OLED) display, or other types of display apparatuses.

In addition, FIG. 3 only shows an example, and the technical solution of the embodiments of the present application is not limited to FIG. 3. For example, the technology of the present application may further be applied to unilateral point cloud encoding or unilateral point cloud decoding.

The current point cloud encoder may adopt two point cloud compression encoding technology routes proposed by the moving picture experts group (MPEG) of the international standards organization, namely video-based point cloud compression (VPCC) and geometry-based point cloud compression (GPCC). The VPCC projects a 3D point cloud into 2D, and encodes a projected 2D picture using existing 2D encoding tools. The GPCC partitions a point cloud into multiple units step by step using a hierarchical structure, and encodes the entire point cloud by encoding and recording the partition process.

The point cloud encoder and the point cloud decoder applicable to the embodiments of the present application will be described below by taking a GPCC encoding and decoding framework as an example.

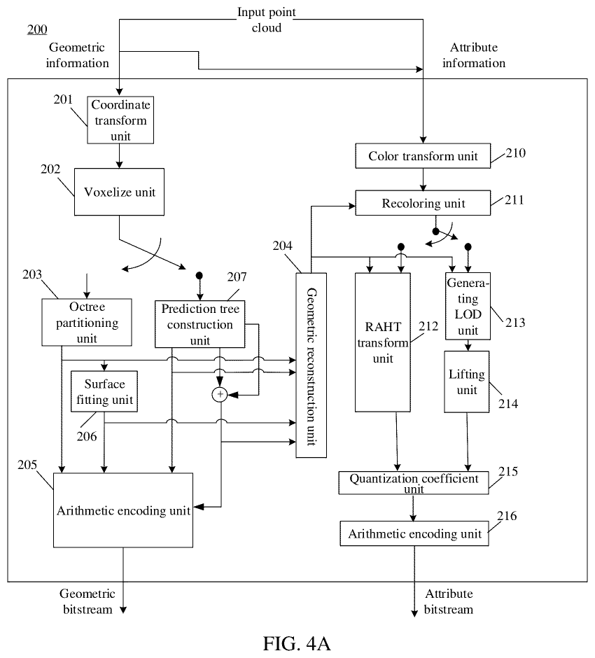

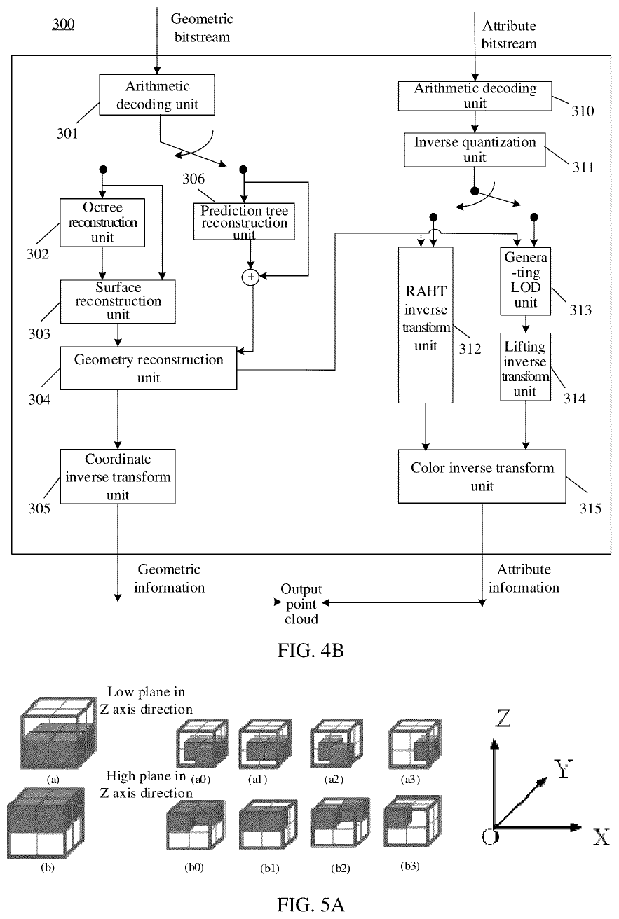

FIG. 4A is a schematic block diagram of a point cloud encoder provided in the embodiments of the present application.

As can be seen from the above, a point in the point cloud may include position information of the point and attribute information of the point. Therefore, the encoding of the point in the point cloud mainly includes position encoding and attribute encoding. In some examples, the position information of the point in the point cloud is referred to as geometric information; correspondingly, the position encoding of the point in the point cloud may be referred to as geometric encoding.

In a GPCC encoding architecture, the geometric information of the point cloud and the corresponding attribute information are encoded separately.

As shown in FIG. 4A, the current geometric encoding and decoding of GPCC may be classified into octree-based geometric encoding and decoding and prediction tree-based geometric encoding and decoding.

A process of the position encoding includes: performing preprocessing (e.g., coordinate transformation, quantization, and removal of duplicate points) on the points in the point cloud; then, performing geometric encoding on the preprocessed point cloud, e.g., constructing an octree or a prediction tree; and performing geometric encoding on the constructed octree or prediction tree to form a geometric bitstream. At the same time, based on position information output by the constructed octree or prediction tree, position information of each point in the point cloud data is reconstructed to obtain a reconstructed value of the position information of each point.

A process of the attribute encoding includes: selecting, by giving reconstruction information of position information and an original value of attribute information of an input point cloud, one of three prediction modes to perform point cloud prediction; quantizing the predicted result; and performing arithmetic encoding to generate an attribute bitstream.

As shown in FIG. 4A, the position encoding may be implemented by the following units:
a coordinate transform (transform coordinates) unit 201, a voxelize unit 202, an octree partitioning (analyze octree) unit 203, a geometry reconstruction (reconstruct geometry) unit 204, an arithmetic encoding (arithmetic encode) unit 205, a surface fitting (analyze surface approximation) unit 206, and a prediction tree construction unit 207.

The coordinate transform unit 201 may be used to transform world coordinates of a point in the point cloud into relative coordinates. For example, minimum values of X, Y and Z coordinate axes are subtracted from geometric coordinates of the point respectively, which is equivalent to a de-direct current operation, to implement transformation of the coordinates of the point in the point cloud from the world coordinates to the relative coordinates.

The voxelize unit 202 is also called a quantize and remove duplicate points (quantize and remove points) unit; the number of coordinates may be reduced through quantization; after quantization, originally different points may be assigned the same coordinates, based on which, duplicate points may be removed through a deduplication operation; for example, multiple point clouds with the same quantized position and different pieces of attribute information may be merged into one cloud by attribute transformation. In some embodiments of the present application, the voxelize unit 202 is an optional unit module.

The octree partitioning unit 203 may encode the position information of the quantized points using an octree encoding manner. For example, the point cloud is partitioned into an octree form, so that positions of the points may be in one-to-one correspondence with positions in the octree. Positions of the points in the octree are counted and flags thereof are marked as 1 for geometric encoding.

In some embodiments, in a process of geometric information encoding based on triangle soup (trisoup), the point cloud is also partitioned into an octree by the octree partitioning unit 203. However, different from the octree-based geometric information encoding, the trisoup does not need to partition the point cloud into unit cubes with side lengths of 1×1×1 step by step, but stops partitioning once there exist blocks (sub-blocks) with a side length of W. Based on a surface formed in each block by distribution of the point cloud, at most twelve vertices (intersections) generated by this surface and twelve sides of the block are obtained, surface fitting is performed on the vertices by the surface fitting unit 206, and geometric encoding is performed on the fitted vertices.

The prediction tree construction unit 207 may encode the position information of the quantized points using a prediction tree encoding manner. For example, the point cloud is partitioned in the form of a prediction tree, whereby positions of the points may be in one-to-one correspondence with positions of nodes in the prediction tree. The positions of the nodes in the prediction tree are counted, different prediction modes are selected for predicting geometric position information of the nodes to obtain prediction residuals, and geometric prediction residuals are quantized using a quantization parameter. Next, the prediction residuals of the position information of the nodes of the prediction tree, a structure of the prediction tree, and the quantization parameter are encoded through continuous iteration, to generate a binary bitstream.

The geometric reconstruction unit 204 may perform position reconstruction based on the position information output by the octree partitioning unit 203 or the vertices fitted by the surface fitting unit 206, to obtain a reconstructed value of the position information of each point in the point cloud data. Alternatively, the geometric reconstruction unit 204 performs position reconstruction based on the position information output by the prediction tree construction unit 207, to obtain a reconstructed value of the position information of each point in the point cloud data.

The arithmetic encoding unit 205 may perform, by using entropy coding, arithmetic encoding on the position information output by the octree partitioning unit 203 or the vertices fitted by the surface fitting unit 206 or the geometric prediction residual values output by the prediction tree construction unit 207, to generate a geometric bitstream, where the geometric bitstream may also be referred to as a geometry bitstream.

The attribute encoding may be implemented by the following units:
a color transform (transform colors) unit 210, a recoloring (transfer attributes) unit 211, a region adaptive hierarchical transform (RAHT) unit 212, a generating LOD (generate LOD) unit 213, a lifting (lifting transform) unit 214, a quantization coefficient (quantize coefficients) unit 215, and an arithmetic encoding unit 216.

It will be noted that a point cloud encoder 200 may include more, fewer, or different functional components than those shown in FIG. 4A.

The color transform unit 210 may be used to transform an RGB color space of the points in the point cloud into a YCbCr format or other formats.

The recoloring unit 211 performs recoloring on color information using reconstructed geometric information such that uncoded attribute information corresponds to the reconstructed geometric information.

After an original value of the attribute information of the point is obtained through transformation by the recoloring unit 211, any of transformation units may be selected to transform the point in the point cloud. The transform units may include: the RAHT transform unit 212 and the lifting (lifting transform) unit 214. Lifting transform depends on generated level of detail (LOD).

Any one of the RAHT transform and lifting transform may be understood as being used to predict attribute information of a point in the point cloud to obtain a prediction value of the attribute information of the point, and to obtain a residual value of the attribute information of the point based on the prediction value of the attribute information of the point. For example, the residual value of the attribute information of the point may be obtained by subtracting the prediction value of the attribute information of the point from the original value of the attribute information of the point.

In an embodiment of the present application, a process of generating the LOD by the LOD generating unit includes: obtaining Euclidean distances between points based on position information of the points in the point cloud; and partitioning the points into different detail expression layers based on the Euclidean distances. In an embodiment, after the Euclidean distances are sorted, Euclidean distances in different ranges may be partitioned into different detail expression layers. For example, one point may be randomly selected as a first detail expression layer; then, Euclidean distances between remaining points and this point are calculated, and points whose Euclidean distances meet a first threshold requirement are classified as a second detail expression layer; a centroid of the points in the second detail expression layer is obtained, Euclidean distances between points other than the first and second detail expression layers and the centroid are calculated, and points whose Euclidean distances meet a second threshold are classified as a third detail expression layer; and so forth, all the points are classified into the detail expression layers. By adjusting a threshold of Euclidean distance, it is possible to make the number of points in each LOD layer incremental. It can be understood that the LOD partitioning may also be performed using other manners, which is not limited in the present application.

It will be noted that the point cloud may be directly partitioned into one or more detail expression layers; alternatively, the point cloud may be first partitioned into multiple point cloud slices, and then each point cloud slice may be partitioned into one or more LOD layers.

For example, the point cloud may be partitioned into multiple point cloud slices, and the number of points in each point cloud slice may be in a range from 550 thousand to 1.1 million. Each point cloud slice may be considered as a separate point cloud. Each point cloud slice may be partitioned into multiple detail expression layers, with each detail expression layer including multiple points. In an embodiment, the detail expression layers may be partitioned based on Euclidean distances between the points.

The quantization coefficient unit 215 may be used to quantize the residual value of the attribute information of the point. For example, in a case where the quantization coefficient unit 215 is connected to the RAHT transform unit 212, the quantization coefficient unit 215 may be used to quantize the residual value of the attribute information of the point output by the RAHT transform unit 212.

The arithmetic encoding unit 216 may perform, using zero run length coding, entropy coding on the residual value of the attribute information of the point, so as to obtain an attribute bitstream. The attribute bitstream may be bitstream information.

FIG. 4B is a schematic block diagram of a point cloud decoder provided in the embodiments of the present application.

As shown in FIG. 4B, a decoder 300 may obtain a point cloud bitstream from an encoding device, and obtain position information and attribute information of a point in the point cloud by parsing the bitstream. Decoding of the point cloud includes position decoding and attribute decoding.

A process of the position decoding includes: performing arithmetic decoding on a geometric bitstream; performing merge after constructing an octree, and reconstructing the position information of the point to obtain reconstructed information of the position information of the point; and performing coordinate transformation on the reconstructed information of the position information of the point to obtain the position information of the point. Position information of a point may also be called geometric information of the point.

A process of the attribute decoding includes: obtaining a residual value of the attribute information of the point in the point cloud by parsing an attribute bitstream; obtaining an inverse-quantized residual value of the attribute information of the point by performing inverse quantization on the residual value of the attribute information of the point; selecting, based on the reconstruction information of the position information of the point obtained in the process of the position decoding, one of the RAHT inverse transform and the lifting inverse transform to perform point cloud prediction to obtain a prediction value, and adding the prediction value to the residual value to obtain a reconstructed value of the attribute information of the point; and performing color space inverse transformation on the reconstructed value of the attribute information of the point to obtain a decoded point cloud.

As shown in FIG. 4B, the position decoding may be implemented by the following units:
an arithmetic decoding unit 301, an octree reconstruction (synthesize octree) unit 302, a surface reconstruction (synthesize surface approximation) unit 303, a geometry reconstruction (reconstruct geometry) unit 304, a coordinate inverse transform (inverse transform coordinates) unit 305, and a prediction tree reconstruction unit 306.

The attribute encoding may be implemented by the following units:
an arithmetic decoding unit 310, an inverse quantization (inverse quantize) unit 311, an RAHT inverse transform unit 312, a generating LOD (generate LOD) unit 313, a lifting inverse transform (inverse lifting) unit 314, and a color inverse transform (inverse transform colors) unit 315.

It will be noted that decompression is an inverse process of compression. Similarly, as for functions of all units in the decoder 300, reference may be made to the functions of the corresponding units in the encoder 200. In addition, the point cloud decoder 300 may include more, fewer, or different functional components than those shown in FIG. 4B.

For example, the decoder 300 may partition the point cloud into multiple LODs based on Euclidean distances between points in the point cloud, and decode attribute information of the points in the LODs in turn, e.g., compute the number of zeros (zero_cnt) in a zero-run encoding technique to decode a residual based on zero_cnt. Then, the decoder 300 may perform inverse quantization based on the decoded residual value, and obtain a reconstructed value of the point cloud by adding an inverse-quantized residual value and a prediction value of a current point, until all point clouds are decoded. The current point will serve as the nearest-neighbor point to points in a subsequent LOD, and attribute information of the subsequent points will be predicted using the reconstructed value of the current point.

The above is a basic process of the point cloud encoder and decoder based on the GPCC encoding and decoding architecture. With the development of technology, some modules or steps of the architecture or process may be optimized. The present application is applicable to the basic process of the point cloud encoder and decoder based on the GPCC encoding and decoding architecture, but is not limited to the architecture and process.

Next, the octree-based geometric encoding and the prediction tree-based geometric encoding will be introduced.

The octree-based geometric encoding includes the following steps. First, coordinate transformation is performed on geometric information, such that the entire point cloud are contained in a bounding box. Then, quantization is performed, where the step of quantization mainly plays a role in scaling. Due to quantization rounding, geometric information of some points is the same. Whether to remove duplicate points is determined based on a parameter. A process of quantization and removal of duplicate points is referred to as voxelization. Next, tree partition (octree/quadtree/binary tree) is continuously performed on the bounding box in an order of breadth-first traversal, and a placeholder code of each node is encoded. In an implicit geometric partitioning manner, the bounding box (2^{d}^{ₓ}, 2^{d}^{_{y}}, 2^{d}^{_{z}}) of the point cloud is first calculated. It is assumed that the bounding box with dₓ>d_{y}>d_{z} corresponds to a cuboid. During geometric partitioning, binary tree partitioning is first performed based on the x axis all the time to obtain two child nodes; until a condition of dₓ=d_{y}>d_{z} is met, quadtree partitioning is performed based on the x and y axes all the time to obtain four child nodes; and then in a case where a condition of dₓ=d_{y}=d_{z} is finally met, octree partitioning is performed all the time until leaf nodes obtained by partitioning are each a unit cube of 1×1×1, the partitioning will be stopped, and points in the leaf nodes are encoded to generate a binary bitstream. In the process of performing partitioning based on binary tree/quadtree/octree, two parameters are introduced: K and M, in which the parameter K indicates the maximum number that the binary tree/quadtree partitioning is performed before octree partitioning; and the parameter M is used for indicating that a side length of the minimum block corresponding to the binary tree/quadtree partitioning is 2^{M}. At the same time, K and M must meet the following conditions: it is assumed that dₘₐₓ=max (dₓ, d_{y}, d_{z}), dₘᵢₙ=min (dₓ, d_{y}, d_{z}), the parameter K meets K>=dₘₐₓ−dₘᵢₙ; and the parameter M meets M>=dₘᵢₙ. The reason why the parameters K and M meet the above conditions is that in a current process of geometric implicit partitioning of GPCC, the priority of the partitioning manner is binary tree, quadtree and octree. Only in a case where the size of the node block does not meet the conditions of binary tree/quadtree, octree partitioning is performed on the nodes all the time until the nodes are partitioned into leaf nodes with the minimum unit of 1×1×1.

The octree-based geometric information encoding mode may effectively encode the geometric information of the point cloud by using correlation between neighboring points in space. Whereas for some relatively flat nodes or nodes with planar characteristics, the encoding efficiency of the geometric information of the point cloud may be further improved by using planar encoding.

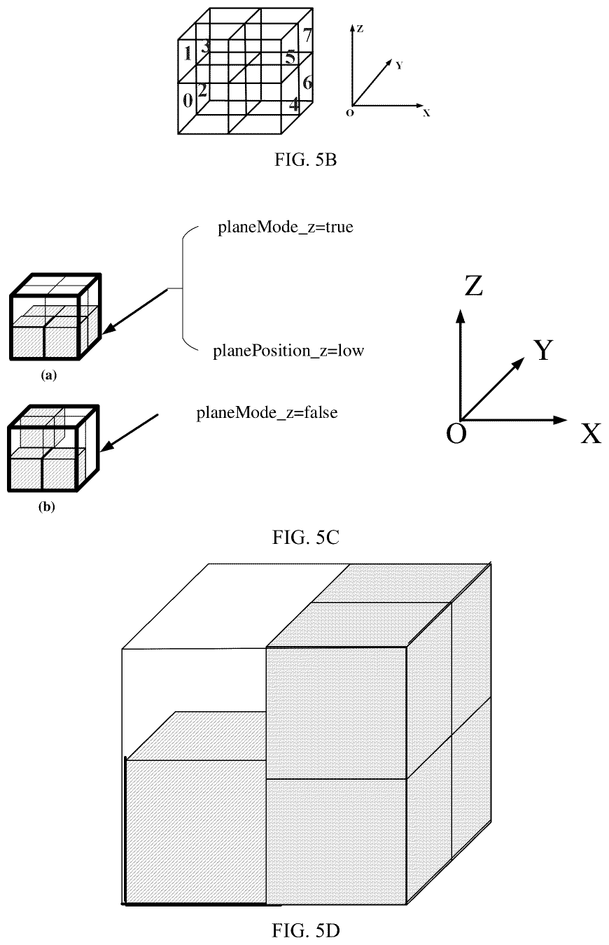

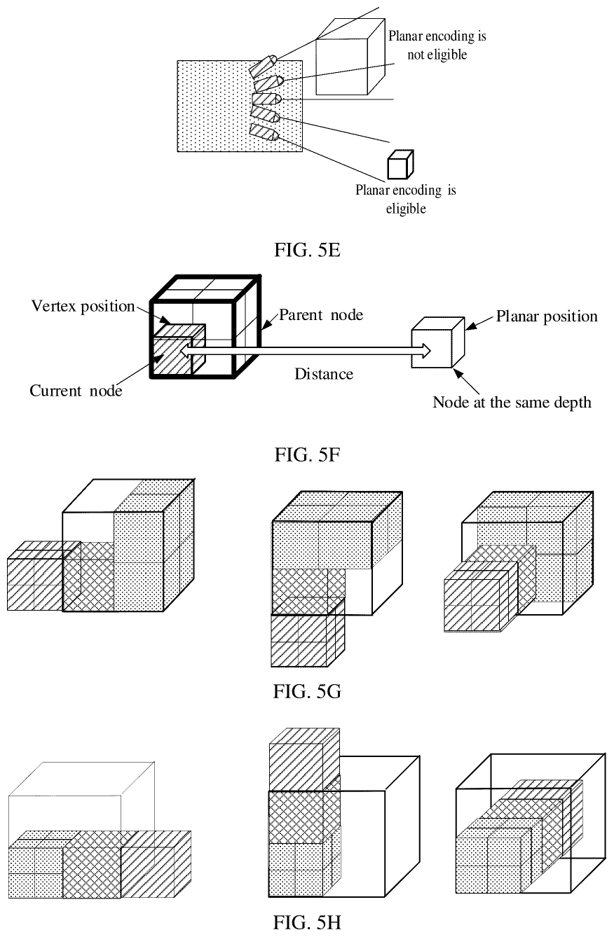

For example, as shown in FIG. 5A, (a) series belongs to a low planar position in a Z axis direction, and (b) series belongs to a high planar position in the Z axis direction. Considering (a) as an example, it can be seen that four occupied child nodes in a current node are all positioned in a low planar position of the current node in the Z axis direction. Therefore, it may be considered that the current node belongs to a Z plane and is a low plane in the Z axis direction. Similarly, (b) indicates that occupied child nodes in the current node are positioned at a high planar position of the current node in the Z axis direction.

Considering (a) as an example, the octree encoding and the planar encoding are compared in terms of efficiency. As shown in FIG. 5B, if an octree encoding manner is used for (a) in FIG. 5A, occupancy information of the current node is represented as: 11001100. Whereas if a planar encoding manner is used, first, an identifier needs to be encoded to represent that the current node is a plane in the Z axis direction; second, if the current node is a plane in the Z axis direction, the planar position of the current node needs to be represented; and then only occupancy information of low planar nodes in the Z axis direction needs to be encoded (e.g., occupancy information of four child nodes 0246). Therefore, based on the planar encoding manner, only 6 bits are needed to encode the current node, which may reduce 2 bits of representation compared to the original octree encoding. Based on this analysis, the planar encoding has more significant encoding efficiency than the octree encoding. Therefore, for an occupied node, if the planar coding is used for encoding in a certain dimension, as shown in FIG. 5C, first, planar flag (planarMode) information and planar position (PlanePos) information of the current node in this dimension need to be represented, and then occupancy information of the current node is encoded based on planar information of the current node. It will be noted that: for PlaneModeᵢ (i is equal to 0, 1 or 2): 0 represents that the current node is not a plane in an i-axis direction. In a case where the node is a plane in the i-axis direction, for PlanePositionᵢ: 0 represents that the current node is a plane in the i-axis direction with the planar position being a low plane, 1 represents that the current node is a high plane in the i-axis direction. For example, i=0 represents the X axis, i=1 represents the Y axis, and i=2 represents the Z axis.

In the current GPCC standard, determining whether a node meets conditions of the planar encoding and predictive encoding of planar flag and planar position information of the node in a case where the current node meets the conditions of the planar encoding, will be introduced in detail below.

There are three types of determination conditions in the current GPCC for determining whether a node meets the planar encoding, which will described below one by one.

The first type: determining is performed based on the plane probability of the node in each dimension.

First, a local area density (local_node_density) of a current node and the probability Prob(i) of the current node in each dimension are determined.

In a case where the local area density of the node is less than a threshold Th (Th is equal to 3), the plane probabilities Prob(i) of the current node in three dimensions are compared with thresholds Th0, Th1 and Th2, where Th1 is less than Th2 and greater than Th0 (Th0<Th1<Th2) (Th0 is equal to 0.6, Th1 is equal to 0.77, and Th2 is equal to 0.88). Eligibleᵢ (i is equal to 0, 1 or 2) is used below to represent whether the planar encoding is enabled in each dimension, where a determination process of Eligibleᵢ is shown in formula (1). For example, if Eligibleᵢ is greater than or equal to the threshold (Eligibleᵢ>=threshold), it represents that the planar encoding is enabled in an i-th dimension:

$${Eligible}_{i} = Prob ( i ) >= threshold \qquad ( 1 )$$

It will be noted that the threshold is changed adaptively. For example, in a case where Prob(1) is greater than Prob(0) and less than Prob(2) (Prob(0)>Prob(1)>Prob(2)), a value of the threshold is as shown in formula (2):

$${Eligible}_{i} = Prob ( 0 ) >= Th 0 \qquad ( 2 )$$

$${Eligible}_{1} = Prob ( 1 ) >= Th 1$$

$${Eligible}_{2} = Prob ( 2 ) >= Th 2$$

An update process of local_node_density and the updating of Prob(i) will be described below.

In an example, Prob(i) is updated by the following formula (3):

$$Prob {( i )}_{n e w} = ( Lx Prob ( i ) + δ ( coded node ) ) / L + 1 \qquad ( 3 )$$

Here, L is equal to 255 (L=255); and in a case where the coded node is a plane, L is 1, otherwise L is 0.

In an example, local_node_density is updated by the following formula (4):

$$local\_node {\_density}_{new} = local\_node \_density + 4 * numSiblings \qquad ( 4 )$$

Here, local_node_density is initialized to 4, and numSiblings is the number of siblings of the node. As shown in FIG. 5D, in a case where the current node is a left node and the right nodes are siblings of the current node, the number of the siblings of the current node is 5 (including the current node itself).

The second type: whether a node of a current layer meets the planar encoding is determined based on the point cloud density of the current layer.

Whether the planar encoding is performed on the node of the current layer is determined using the density of points in the current layer. It is assumed that the number of points in a current point cloud to be encoded is pointCount and the number of points reconstructed after IDCM encoding is numPointCountRecon, since the encoding for the octree is performed based on an order of breadth-first traversal, the number of nodes to be encoded in the current layer may be obtained, assuming as nodeCount. As a result, it is assumed that planarEligibleKOctreeDepth is used for representing whether the planar encoding is enabled in the current layer, where the determination process of planarEligibleKOctreeDepth is shown in formula (5):

$$planarEligibleKOctreeDepth = ( pointCount - numPointCountRecon ) < nodeCount * 1.3 \qquad ( 5 )$$

In a case where planarEligibleKOctreeDepth is true, the planar encoding is performed on all nodes in the current layer; otherwise, no planar encoding is performed and only the octree encoding is used.

The third type: whether the current node meets the planar encoding is determined based on a collection parameter of a laser radar point cloud.

As shown in FIG. 5E, it may be seen that a node of large cube at top is passed through by two lasers simultaneously, so the current node is not a plane in a direction perpendicular to the Z axis, and a node of small cube at bottom is small enough that it cannot be passed through by two nodes simultaneously, so the current node is likely to be a plane. Therefore, whether the current node meets the planar encoding is determined based on the number of lasers corresponding to the current node.

For nodes meeting the conditions of the planar encoding, the current predictive encoding of the planar flag information and the planar position information will be introduced below.

First, the predictive encoding of the planer identification information

Currently, the planar flag information is encoded using three contexts. That is, the context is designed separately for planar representations in each dimension.

Encoding of planar position information of non-lidar point clouds and encoding of planar position information of laser radar point clouds will be introduced separately below.

### 1) Encoding of the Planar Position Information of the Non-Lidar Point Clouds

### 1. Predictive Encoding of the Planar Position Information

The predictive encoding is performed on the planar position information based on the following information:
(1) the planar position information of the current node being obtained as three elements through predicting by using the occupancy information of the neighborhood node: predicted to be a low plane, predicted to be a high plane, or unpredictable;
(2) a spatial distance between a node at the same partition depth and the same coordinate as the current node and the current node being “close” or “far”;
(3) a planar position of a node at the same partition depth and the same coordinate as the current node; or
(4) a coordinate dimension i being equal to 0, 1 or 2.

As shown in FIG. 5F, the current node to be encoded is a left node, a neighborhood node is searched for as a right node at the same octree partition depth level and the same vertical coordinate, a distance between those two nodes is determined as “close” or “far”, with reference to the planar position of the node.

In an example, as shown in FIG. 5G, a black node is the current node; and if the current node is located at a low plane of a parent node, the planar position of the current node is determined in manners as follows.
a) If any one of child nodes 4 to 7 of a node shown with oblique lines is occupied and none of nodes shown in dots is occupied, it is very likely that there is a plane in the current node, with a relatively low planar position.
b) If none of child nodes 4 to 7 of a node shown with oblique lines is occupied and any node shown with dots is occupied, it is very likely that there is a plane in the current node, with a relatively high planar position.
c) If all of child nodes 4 to 7 of a node shown with oblique lines are empty nodes and all of nodes shown with dots are empty nodes, the planar position cannot be inferred and is therefore marked as unknown.
d) If any one of child nodes 4 to 7 of a node shown with oblique lines is occupied and any one of nodes shown with dots is occupied, the planar position cannot be inferred and is therefore marked as unknown.

In another example, as shown in FIG. 5H, a black node is the current node; and if the current node is located at a high planar position of a parent node, the planar position of the current node is determined in manners as follows.
a) If any one of child nodes 4 to 7 of a node shown with dots is occupied and a node shown with oblique lines is not occupied, it is very likely that there is a plane in the current node, with a relatively low planar position.
b) If none of child nodes 4 to 7 of a node shown with dots is occupied and a node shown with oblique lines is occupied, it is very likely that there is a plane in the current node, with a relatively high planar position.
c) If none of child nodes 4 to 7 of a node shown with dots is occupied and a node shown with oblique lines is not occupied, the planar position cannot be inferred and is therefore marked as unknown.
d) If one of child nodes 4 to 7 of a node shown with dots is occupied and a node shown with oblique lines is occupied, the planar position cannot be inferred and is therefore marked as unknown.

### 2) Encoding of the Planar Position Information of Laser Radar Point Clouds

FIG. 5I shows the predictive encoding of the planar position information of the laser radar point cloud. The planar position of the current node is predicted by using parameters collected by a laser radar, and the position is quantized into four intervals by using positions of intersection of the current node and laser rays, which finally serve as the context of the planar position of the current node. A calculation process is the following: assuming that coordinates of the laser radar are (x_{Lidar}, y_{Lidar}, z_{Lidar}) and geometric coordinates of the current node are (x, y, z), a vertical tangent value tan θ of the current node relative to the laser radar is first calculated, with the calculation process shown in formula (6):

$$tan θ = \frac{z - {z}_{Lidar}}{\sqrt{{( x - {x}_{Lidar} )}^{2} + {( y - {y}_{Lidar} )}^{2}}} \qquad ( 6 )$$

In addition, since each laser has a certain offset angle relative to the laser radar, a relative tangent value tan θ_{corr,L} of the current node relative to the laser is calculated, with the calculation process shown in formula (7):

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 7 )$$

Finally, the planar position of the current node is predicted by using a corrected tangent value of the current node. In some embodiments, assuming that a tangent value of a lower boundary of the current node is tan (θ bottom), and a tangent value of an upper boundary is tan (θ top), the planar position is quantized into 4 quantization intervals based on tan θ_{corr,L}, that is, the context of the planar position.

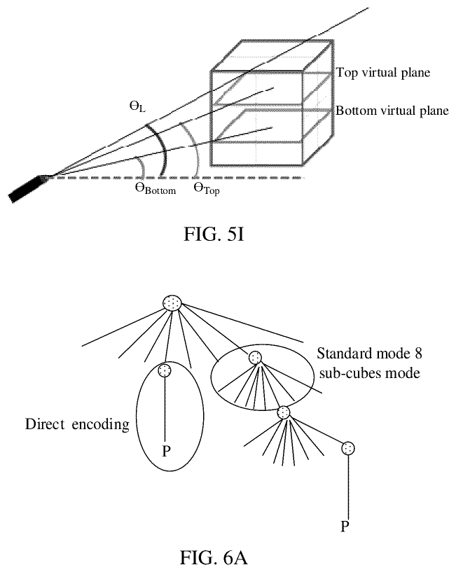

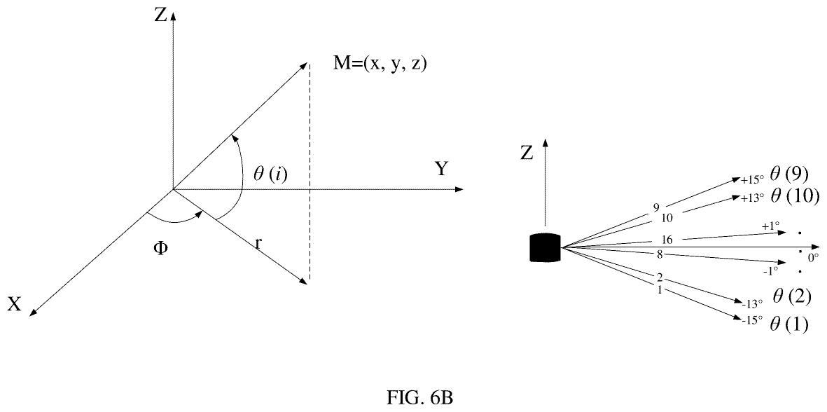

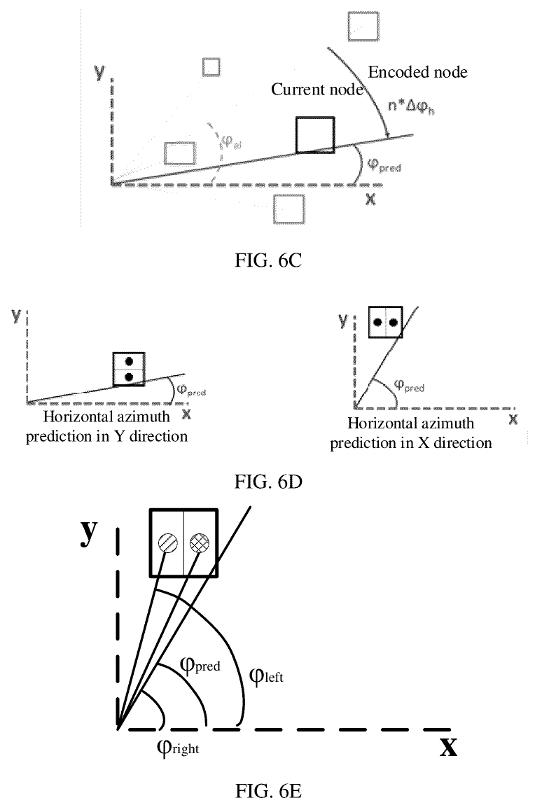

However, the octree-based geometric information encoding mode only has an efficient compression rate for points that are correlated in space. For points that are isolated in the geometric space, use of the direct coding model (DCM) may greatly reduce complexity. For all nodes in the octree, use of DCM is not represented by flag information, but is inferred from the parent node and neighboring information of the current node. There are three manners to determine whether the current node is eligible for the DCM encoding, as shown in FIG. 6A.
(1) The current node has no sibling child nodes, that is, the parent node of the current node has only one child node, and a parent node of the parent node of the current node has only two occupied child nodes, that is, the current node has at most one neighborhood node.
(2) The parent node of the current node has only one occupied child node, i.e., the current node, and six neighborhood nodes sharing a face with the current node are also empty nodes.
(3) The number of sibling nodes of the current node is greater than 1.

If the current node is not eligible for the DCM encoding, octree partitioning will be performed on the current node. If the current node is eligible for the DCM encoding, the number of points included in the node will be further determined. In a case where the number of points is less than a threshold of 2, the DCM encoding is performed on the node, otherwise the octree partitioning will be performed continuously. In a case where the DCM encoding mode is applied, it is first necessary to encode whether the current node is a true isolated point, that is, IDCM_flag. In a case where IDCM_flag is true, the DCM encoding is performed on the current node; otherwise, the octree encoding is still performed. In a case where the current node meets the DCM encoding, a DCM encoding mode of the current node needs to be encoded. There exist two current DCM modes which are: 1. only one point exists (or multiple points exist, but they are duplicate points); and 2. two points are contained. Finally, it is necessary to encode geometric information of each point. Assuming that a side length of the node is 2^{d}, it takes d bits to encode each component of the geometric coordinates of the node, and the bit information is directly encoded into a bitstream. It will be noted here that in a case of encoding the laser radar point cloud, predictive encoding is performed on the three-dimensional coordinate information by using the parameters collected by a laser radar, which may further improve the encoding efficiency of the geometric information.

Next, a process of the IDCM encoding will be introduced in detail.

In a case where a current node meets the direct coding model (DCM), a number of points numPoints of the current node is first encoded. The number of points of the current node is encoded based on different DirectModes, including the following methods.
1. If the current node does not meet requirements of the DCM node, the process is directly exited (that is, the number of points is greater than 2 and the points are not duplicate points).
2. If the number of points numPonts contained in the current node is less than or equal to 2, the encoding process is as follows.
1) First, whether the numPonts of the current node is greater than 1 is encoded;
2) If the current node has only one point and the geometry encoding environment is geometry lossless encoding, it is necessary to encode that a second point of the current node is not a duplicate point.
3. If the number of points numPonts contained in the current node is greater than 2, the encoding process is as follows.
1) First, the numPonts of the current node to be less than or equal to 1 is encoded.
2) Secondly, whether the second point of the current node is a duplicate point is encoded, and then whether the number of duplicate points of the current node is greater than 1 is encoded. In a case where the number of duplicate points is greater than 1, the remaining number of duplicate points needs to be decoded using exponential Golombus decoding.

After encoding the number of points in the current node, the coordinate information of the points contained in the current node is encoded. The laser radar point cloud and point cloud for human eyes will be introduced separately below.

### Point Cloud for Human Eyes

1) If the current node contains only one point, the geometric information of the point in three-dimensions will be directly encoded (bypass coding).
2) If the current node contains two points, the priority encoding coordinate axis dirextAxis will be first obtained using the geometric coordinates of the points. It should be noted that the currently compared coordinate axes only include the x and y axes, excluding the z axis. Assuming that the geometric coordinates of the current node are nodePos, the priority encoding coordinate axis is determined using the method shown in formula (8):

$$dirextAxis = ! ( nodePos [ 0 ] < nodePos [ 1 ] ) \qquad ( 8 )$$

That is, the axis with the smaller node coordinate geometric position is used as the priority encoding coordinate axis dirextAxis.

Secondly, the geometry information of the priority encoding coordinate axis dirextAxis is first encoded as follows, assuming that the bit depth of the geometry to be encoded corresponding to the priority encoding coordinate axis is nodeSizeLog 2, and assuming that the coordinates of the two points are pointPos[a] and pointPos[b] respectively:

| | |
|---|---|
| | Bool sameBit=true; |
| | while(nodeSizeLog2&& sameBit){ |
| | int mask=1<< nodeSizeLog2; |
| | −−nodeSizeLog2; |
| | bool bit0=!!( pointPos[a]& mask) |
| | bool bit1=!!( pointPos[b]& mask) |
| | sameBits=bit0==bit1; |
| | entropyCodeSameBit(sameBits); ///<entropy coding |
| | if(sameBits) |
| | encodePosBit(bit0);///<Bypass coding |
| } | |

After encoding the priority encoding axis dirextAxis, the geometric coordinates of the current point are directly encoded. Assuming that the remaining encoding bit depth of each point is nodeSizeLog 2, the encoding process is as follows:

$$for ( int axisIdx = 0 ; axisIdx < 3 ; ++ axisIdx )$$

$$for ( int mask = ( 1 ≪ nodeSize Log 2 [ axisIdx ] ) ≫ 1 ; mask ; mask ≫ 1 )$$

$$encodePosBit ( ! ! ( pointPos [ axisIdx ] \& mask ) ) ;$$

For laser radar point cloud
1) If the current node contains two points, the priority encoding coordinate axis dirextAxis will be obtained using the geometric coordinates of the points. Assuming that the geometric coordinates of the current node are nodePos, the priority encoding coordinate axis is determined by the method shown in formula (9):

$$dirextAxis = ! ( nodePos [ 0 ] < nodePos [ 1 ] ) \qquad ( 9 )$$

That is, the axis with the smaller node coordinate geometric position is used as the priority encoding coordinate axis dirextAxis. It should be noted that the currently compared coordinate axes only include the x and y axes, excluding the z axis.

Secondly, the geometry information of the priority encoding coordinate axis dirextAxis is first encoded as follows, assuming that the bit depth of the geometry to be encoded corresponding to the priority encoding axis is nodeSizeLog 2, and assuming that the coordinates of the two points are pointPos[a] and pointPos[b] respectively:

| | |
|---|---|
| | Bool sameBit=true; |
| | while(nodeSizeLog2&& sameBit){ |
| | int mask=1<< nodeSizeLog2; |
| | −−nodeSizeLog2; |
| | bool bit0=!!( pointPos[a]& mask) |
| | bool bit1=!!( pointPos[b]& mask) |
| | sameBits=bit0==bit1; |
| | entropyCodeSameBit(sameBits); |
| | if(sameBits) |
| | encodePosBit(bit0); |
| } | |

After encoding the priority encoding axis dirextAxis, the geometric coordinates of the current point are encoded.

The laser radar point cloud may obtain the collection parameters of the laser radar point cloud, and the geometric coordinate information of the current node may be predicted by using the collection parameters, thereby further improving the geometric information encoding efficiency of the point cloud. Similarly, a directly encoded main axis direction may be first obtained using the geometric information nodePos of the current node, and then predictive encoding is performed on the geometric information of another dimension using the geometric information of the encoded direction. Also assuming that the axis direction of direct encoding is directAxis, and assuming that the bit depth to be encoded in direct encoding is nodeSizeLog 2, the encoding method is as follows:

$$for ( int mask = ( 1 ≪ nodeSize Log 2 ) ≫ 1 ; mask ; mask ≫ 1 )$$

$$encodePosBit ( ! ! ( pointPos [ directAxis ] \& mask ) ) ;$$

It should be noted that all geometric accuracy information in the directAxis direction will be encoded.

After encoding all the accuracy of the directAxis coordinate direction, the LaserIdx corresponding to the current point, i.e., the pointLaserIdx number in FIG. 6B, is calculated first, and the LaserIdx of the current node, i.e., nodeLaserIdx, is calculated. Then, predictive encoding is performed on the LaserIdx of the point, i.e., pointLaserIdx, by using the LaserIdx of the node, i.e., nodeLaserIdx. The calculation method of the LaserIdx of the node or point is as follows.

Assuming that the geometric coordinates of the point are pointPos, a starting coordinates of the laser ray are LidarOrigin, and the number of lasers is LaserNum, a tangent value of each laser is tan θᵢ, and an offset position of each laser in the vertical direction is Zᵢ, then:

```
      Int bestLaserIdx=0;
      Int Distoration = INT_MAX;
    For(int LaserIdx=0; LaserIdx<numLaser;++ LaserIdx){
      int radius = {square root over ((pointPos[0] − LidarOrigin[0])² + (pointPos[1] −)}
      {square root over (LidarOrigin[1])²)}
      int invRadius=1/ radius
      int Z=pointPos[2]+Zᵢ
      int tanTheta = ZinvRadius
      if(std::abs(tanTheta−tanθᵢ)< Distoration){
    Distoration= std::abs(tanTheta−tanθᵢ);
    bestLaserIdx= LaserIdx;
  }
}
```

After calculating the LaserIdx of the current point, the LaserIdx of the current node is first used to predict the pointLaserIdx of the point. After encoding the LaserIdx of the current point, predictive encoding is performed on the three-dimensional geometric information of the current point by using the parameters collected by the laser radar.

The algorithm is shown in FIG. 6C. First, the corresponding prediction value of the horizontal azimuth angle, i.e., φpred, is obtained using the LaserIdx corresponding to the current point. Then, the horizontal azimuth angle corresponding to the node φ_{node} is obtained using the node geometry information corresponding to the current point. The calculation method between the horizontal azimuth angle φ and the node geometric information is shown in formula (10), assuming that the geometric coordinates of the node are nodePos:

$$ϕ = arctan ( nodePos [ 1 ] / nodePos [ 0 ] ) \qquad ( 10 )$$

By using the collection parameters of the laser radar, the number of rotation points numPoints of each laser may be obtained, which represents the number of points obtained in a case where each laser ray rotates one circle. The rotation angular velocity deltaPhi of each laser may then be calculated using the number of rotation points of each laser, as shown in formula (11):

$$deltaPhi = \frac{2 π}{numPoints} \qquad ( 11 )$$

As shown in FIG. 6D, the horizontal azimuth angle prediction value corresponding to the current point φ_{predPoint} is calculated using the horizontal azimuth angle φ_{node} of the node and the horizontal azimuth angle φ_{pred} of the previous laser encoding point corresponding to the current point. The calculation formula is shown in formula (12):

$${φ}_{predPoint} = \frac{φ pred - φnode}{deltaPhi} \times deltaPhi + φ pred \qquad ( 12 )$$

Finally, as shown in FIG. 6E, predictive encoding is performed on the geometric information of the current node by using the horizontal azimuth angle prediction value φ_{predPoint} and the horizontal azimuth angle of a low plane φ_{left} and the horizontal azimuth angle of a high plane φ_{right} of the current node. The details are as follows:

$$int angLel {=}_{{φ}_{left} - {φ}_{predPoint}}$$

$$int angLeR {=}_{{φ}_{right} - {φ}_{predPoint}}$$

$$int context = ( angLel \geq 0 \&\& angLeR \geq 0 ) ‖ ( angLel < 0 \&\& angLeR < 0 ) ? 0 : 2$$

$$int abs AngleL = abs ( angLel )$$

$$int abs AngleR = abs ( angLeR )$$

$$context += abs AngleL > abs AngleR ? 0 : 1$$

$$context += max Angle > min Angle ≪ 1 ? 4 : 0$$

After encoding the LaserIdx of the point, predictive encoding is performed on the Z axis direction of the current point using the LaserIdx corresponding to the current point. That is, the depth information radius of the cylindrical coordinate system is calculated using the x and y information of the current point. Then, the tangent value of the current point and the vertical offset are obtained using the laser LaserIdx of the current point. Then, the prediction value of the Z axis direction of the current point, namely Z_pred, may be obtained:

$$int radius = \sqrt{{( pointPos [ 0 ] - LidarOrigin [ 0 ] )}^{2} + {( pointPos [ 1 ] - LidarOrigin [ 1 ] )}^{2}}$$

$$int tan Theta = tan {θ}_{laserIdx}$$

$$int zOffset = {Z}_{laserIdx}$$

$$Z\_pred = tan Theta - zOffset$$

Finally, predictive encoding is performed on the geometric information of Z axis direction of the current point by using Z_pred, to obtain a prediction residual Z_res, and finally Z_res is encoded.

It will be noted that as the node partitioning proceeds to leaf nodes, the number of duplicate points in the leaf nodes needs to be encoded in a case of geometric lossless encoding. Finally, occupancy information of all nodes is encoded to generate a binary bitstream. In addition, a planar encoding mode is currently introduced in GPCC. In a process of geometric partitioning, whether child nodes of the current node are in the same plane will be determined; and if the child nodes of the current node meet the condition of being in the same plane, the child nodes of the current node will be represented by the plane.

For the octree-based geometric decoding, before decoding the occupancy information of each node, a decoding side will first determine, in the order of breadth-first traversal, whether to perform the planar decoding or the IDCM decoding on the current node by using the reconstructed geometric information. If the current node meets a condition for the planar decoding, the decoding side will first decode the planar flag and planar position information of the current node, and then decode the occupancy information of the current node based on the planar information. If the current node meets a condition for the IDCM decoding, the decoding side will first decode whether the current node is a true IDCM node; and if the current node is a true IDCM node, the decoding side will continue to parse the DCM decoding mode of the current node, and then the decoding side may obtain the number of points in the current DCM node and finally decode the geometric information of each point. For a node that does not meet either the planar decoding or the DCM decoding, the occupancy information of the current node will be decoded. By continuously parsing in this manner, an occupancy code of each node is obtained, and the partitioning is continued for the nodes in turn until unit cubes of 1×1×1 are obtained. The number of points included in each leaf node is parsed, and geometric reconstruction point cloud information is restored finally.

A process of the IDCM decoding will be introduced in detail.

The same process as encoding, firstly, whether the node starts IDCM is decided using prior information That is, starting conditions of IDCM are as follows.
(1) The current node has no sibling child nodes. That is, the parent node of the current node has only one child node, and a parent node of the parent node of the current node has only two occupied child nodes. That is, the current node has at most one neighborhood node.
(2) The parent node of the current node has only one occupied child node, i.e., the current node, and six neighborhood nodes sharing a face with the current node are also empty nodes.
(3) The number of sibling nodes of the current node is greater than 1.

In a case where a current node meets a condition for DCM encoding, whether the current node is a true DCM node, that is, IDCM_flag, is first decoded. In a case where IDCM_flag is true, the DCM encoding is performed on the current node; otherwise, the octree encoding is still performed.

Next, the number of points numPoints of the current node is decoded. The decoding mode is as follows.
1) First, whether the numPonts of the current node is greater than 1 is decoded.
2) If the decoded numPonts of the current node is greater than 1, whether the second point is a duplicate point is further decoded. If the second point is not a duplicate point, it may be implicitly inferred that the second case of DCM mode is met, where only two points are contained.
3) If the decoded numPonts of the current node is less than or equal to 1, whether the second point is a duplicate point is further decoded. If the second point is not a duplicate point, it may be implicitly inferred that the second case of DCM mode is met, where only one point is contained. If the decoded second point is a duplicate point, it may be inferred that the third case of DCM mode is met, where multiple points are contained, but they are all duplicate points. Then, whether the number of duplicate points is greater than 1 (entropy decoding) is further decoded, and if it is greater than 1, the number of remaining duplicate points is further decoded (decoded using exponential Columbus).

If the current node does not meet the requirements of the DCM node, that is, the number of points is greater than 2 and the points are not duplicate points, the process is directly exited.

After decoding the number of points in the current node, the coordinate information of the points contained in the current node is decoded. The laser radar point cloud and the point cloud for human eyes will be introduced separately below.

### Point Cloud for Human Eyes

1) If the current node contains only one point, the geometric information of the point in three-dimensions will be directly decoded (bypass coding).
2) If the current node contains two points, the priority decoding coordinate axis dirextAxis will be first obtained using the geometric coordinates of the points. It should be noted that the currently compared coordinate axes only include the x and y axes, excluding the z axis. Assuming that the geometric coordinates of the current node are nodePos, the priority decoding coordinate axis is determined using the method shown in formula (13):

$$dirextAxis = ! ( nodePos [ 0 ] < nodePos [ 1 ] ) \qquad ( 13 )$$

That is, the axis with the smaller node coordinate geometric position is used as the priority decoding coordinate axis dirextAxis.

Secondly, the geometry information of the priority decoding coordinate axis dirextAxis is first decoded as follows, assuming that the bit depth of the geometry to be decoded corresponding to the priority decoding axis is nodeSizeLog 2, and assuming that the coordinates of the two points are pointPos[0] and pointPos[1] respectively:

```
  Bool sameBit=true;
  while(nodeSizeLog2&& sameBit){
    pointPos[0][ dirextAxis]<<1;
    pointPos[1][ dirextAxis]<<1;
    −−nodeSizeLog2;
    int bit=0;
  deEntropyCodeSameBit(sameBits); ///<entropy coding
    if(sameBits){
      bit =decodePosBit( );///<Bypass coding
      pointPos[0][ dirextAxis]|= bit
    pointPos[1][ dirextAxis]|= bit
    }else
    pointPos[1][ dirextAxis]|= 1 ///< The reason here is that in a case of encoding,
  the two points will be sorted in the direction of the priority encoding axis, so it may
  be guaranteed that pointPos[0][ dirextAxis]< pointPos[1][ dirextAxis]. Therefore,
  in a case of decoding, if the bit information of the two points is different, it may be
  inferred that the bit of the first point is 0 and the bit of the second point is 1.
}
```

After decoding the priority decoding axis dirextAxis, the geometric coordinates of the current point are directly decoded. Assuming that the remaining decoding bit depth of each point is nodeSizeLog 2, the decoding process is as follows, assuming that the coordinate information of the point is pointPos:

```
for(int axisIdx=0;axisIdx<3;++axisIdx)
for(int idx= nodeSizeLog2[axisIdx]; idx; idx−−){
  pointPos[axisIdx]<<1;
  pointPos[axisIdx]|=decodePosBit( );
}
```

### For Laser Radar Point Cloud

1) If the current node contains two points, the priority decoding coordinate axis dirextAxis will be obtained using the geometric coordinates of the points. Assuming that the geometric coordinates of the current node are nodePos, the priority encoding coordinate axis is determined by the method shown in formula (14):

$$dirextAxis = ! ( nodePos [ 0 ] < nodePos [ 1 ] ) \qquad ( 14 )$$

That is, the axis with the smaller node coordinate geometric position is used as the priority decoding coordinate axis dirextAxis. It should be noted that the currently compared coordinate axes only include the x and y axes, excluding the z axis.

Secondly, the geometry information of the priority encoding coordinate axis dirextAxis is first decoded as follows, assuming that the bit depth of the geometry to be encoded corresponding to the priority decoding axis is nodeSizeLog 2, and assuming that the coordinates of the two points are pointPos[0] and pointPos[1] respectively:

```
  Bool sameBit=true;
  while(nodeSizeLog2&& sameBit){
    pointPos[0][ dirextAxis]<<1;
    pointPos[1][ dirextAxis]<<1;
    −−nodeSizeLog2;
    int bit=0;
  deEntropyCodeSameBit(sameBits); ///<entropy coding
    if(sameBits){
      bit =decodePosBit( );///<Bypass coding
      pointPos[0][ dirextAxis]|= bit
    pointPos[1][ dirextAxis]|= bit
    }else
    pointPos[1][ dirextAxis]|= 1 ///< The reason here is that in a case of encoding,
  the two points will be sorted in the direction of the priority encoding axis, so it may
  be guaranteed that pointPos[0][ dirextAxis]< pointPos[1][ dirextAxis]. Therefore,
  in a case of decoding, if the bit information of the two points is different, it may be
  inferred that the bit of the first point is 0 and the bit of the second point is 1.
}
```

After decoding the priority decoding axis dirextAxis, the geometric coordinates of the current point are decoded.

Similarly, a directly decoded main axis direction may be first obtained using the geometric information nodePos of the current node, and then predictive decoding is performed on the geometric information of another dimension using the geometric information of the decoded direction. Also assuming that the axis direction of direct decoding is directAxis, and assuming that the bit depth to be decoded in direct decoding is nodeSizeLog 2, the decoding method is as follows:

```
for(int idx= nodeSizeLog2[directAxis]; idx; idx−−){
  pointPos[directAxis]<<1;
  pointPos[directAxis]|=decodePosBit( );
}
```

It should be noted that all geometric accuracy information in the directAxis direction will be decoded.

After decoding all the accuracy of the directAxis coordinate direction, the LaserIdx of the current node, i.e., nodeLaserIdx, is calculated first. Then, predictive decoding is performed on the LaserIdx of the point, i.e., pointLaserIdx, by using the LaserIdx of the node, i.e., nodeLaserIdx. The calculation method of the LaserIdx of the node or point is the same as that of the encoding side. Finally, the residual prediction information between the LaserIdx of the current point and the LaserIdx of the node is decoded to obtain ResLaserIdx, and the calculation formula is shown in formula (15):

$$PointLaserIdx = nodeLaserIdx + ResLaserIdx \qquad ( 15 )$$

After decoding the LaserIdx of the current point, predictive decoding is performed on the three-dimensional geometric information of the current point by using the parameters collected by the laser radar.

In some embodiments, as shown in FIG. 6B, the corresponding prediction value of the horizontal azimuth angle, i.e., φpred is first obtained using the LaserIdx corresponding to the current point. Then, the horizontal azimuth angle corresponding to the node φ_{node} is obtained using the node geometry information corresponding to the current point. Assuming that the geometric coordinates of the node are nodePos, the calculation method between the horizontal azimuth angle φ and the node geometric information is shown in formula (16):

$$φ = arctan ( nodePos [ 1 ] / nodePos [ 0 ] ) \qquad ( 16 )$$

By using the collection parameters of the laser radar, the number of rotation points numPoints of each laser may be obtained, which represents the number of points obtained in a case where each laser ray rotates one circle. The rotation angular velocity deltaPhi of each laser may then be calculated using the number of rotation points of each laser, as shown in formula (17):

$$deltaPhi = \frac{2 π}{numPoints} \qquad ( 17 )$$

Next, as shown in FIG. 6D, the horizontal azimuth angle prediction value corresponding to the current point φ_{predPoint} is calculated using the horizontal azimuth angle φ_{node} of the node and the horizontal azimuth angle φ_{pred} of the previous laser encoding point corresponding to the current point. The calculation formula is shown in formula (18):

$${φ}_{predPoint} = \frac{φ pred - φnode}{deltaPhi} \times deltaPhi + φ pred \qquad ( 18 )$$

Finally, predictive encoding is performed on the geometric information of the current node by using the horizontal azimuth angle prediction value φ_{predPoint} and the horizontal azimuth angle of a low plane φ_{left} and the horizontal azimuth angle of a high plane φ_{right} of the current node. The details are as follows:

$$int angLel {=}_{{φ}_{left} - {φ}_{predPoint}}$$

$$int angLeR {=}_{{φ}_{right} - {φ}_{predPoint}}$$

$$int context = ( angLel \geq 0 \&\& angLeR \geq 0 ) ‖ ( angLel < 0 \&\& angLeR < 0 ) ? 0 : 2$$

$$int abs AngleL = abs ( angLel )$$

$$int abs AngleR = abs ( angLeR )$$

$$context += abs AngleL > abs AngleR ? 0 : 1$$

$$context += max Angle > min Angle ≪ 1 ? 4 : 0$$

After decoding the LaserIdx of the point, predictive decoding is performed on the Z axis direction of the current point by using the LaserIdx corresponding to the current point. That is, the depth information radius of the cylindrical coordinate system is calculated by using the x and y information of the current point. Then, the tangent value of the current point and the vertical offset are obtained by using the laser LaserIdx of the current point. Then, the prediction value of the Z axis direction of the current point, namely Z_pred, may be obtained:

$$int radius = \sqrt{{( pointPos [ 0 ] - LidarOrigin [ 0 ] )}^{2} + {( pointPos [ 1 ] - LidarOrigin [ 1 ] )}^{2}}$$

$$int tan Theta = tan {θ}_{laserIdx}$$

$$int zOffset = {Z}_{laserIdx}$$

$$Z\_pred = tan Theta - zOffset$$

Finally, the decoded Z_res and Z_pred are used to reconstruct and restore the geometric information of the current point in the Z axis direction.

In a geometric information encoding architecture based on trisoup (triangle soup), similarly, geometric partitioning is also performed first. However, unlike the binary tree/quadtree/octree-based geometric information encoding, this method does not need to partition the point cloud into unit cubes with side lengths of 1×1×1 step by step, but stops partitioning once there exist blocks (sub-blocks) with a side length of W. Based on a surface formed in each block by the distribution of the point cloud, at most twelve vertices (intersections) generated by this surface and twelve sides of the block are obtained. Vertex coordinates of each block are encoded in turn to generate a binary bitstream.

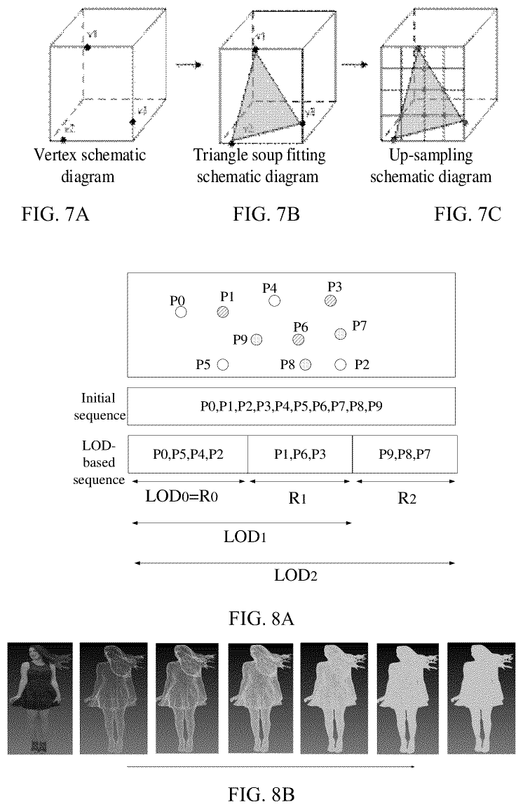

For trisoup-based point cloud geometric information reconstruction, in a case where performing the point cloud geometric information reconstruction, the decoding side first decodes the vertex coordinates to complete triangle soup reconstruction, a process of which is shown in FIG. 7A to FIG. 7C. There are three vertices (v1, v2, v3) in a block shown in FIG. 7A, and the triangle soup, i.e., trisoup, formed by these three vertices in a certain order is shown in FIG. 7B. Afterwards, sampling is performed on the triangle soup to obtain sampling points, which will serve as a reconstructed point cloud within the block, as shown in FIG. 7C.

The prediction tree-based geometric encoding includes steps as follows. First, an input point cloud is sorted, and the sorting methods currently used include unordered, Morton order, azimuth order, and radial distance order. An encoding side establishes a prediction tree structure by using two different manners including a high-latency slow mode (KD-Tree), and a low-latency fast mode in which each point is assigned to a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream.

For the prediction tree-based on the geometric decoding, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometric information is reconstructed after the geometric encoding is completed.

Currently, attribute encoding is mainly performed on color information. First, the color information is transformed from an RGB color space to a YUV color space. The point cloud is then recolored by using the reconstructed geometric information, to enable unencoded attribute information to correspond to the reconstructed geometric information. In color information encoding, there are two main transformation manners: one is distance-based lifting transformation that relies on LOD (level of detail) partitioning, and the other is that RAHT (Region Adaptive Hierarchal Transform) transformation is performed directly. Both manners can transform the color information from a spatial domain to a frequency domain, a high-frequency coefficient and a low-frequency coefficient are obtained through the transformation, and finally the coefficients are quantized and encoded to generate a binary bitstream.

In a case where the attribute information is predicted by using the geometric information, Morton code may be used for performing nearest-neighbor search, where the Morton code corresponding to each point in the point cloud may be obtained from geometric coordinates of this point. A method for calculating the Morton code is described below. For a three-dimensional coordinate with each component represented by a d-bit binary value, its three components may be represented as formula (19):

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} , \qquad ( 19 )$$

Here, [symbol] , [symbol] , [symbol] ∈{0,1} are binary values corresponding to bits, from the highest ( [symbol] =1) to the lowest ( [symbol] =d), of x, y, z, respectively. For x, y, z, starting from the highest bit, [symbol] , [symbol] , [symbol] are crosswise arranged in e-quaintance by using the Morton code M up to the lowest bit. Calculation formula of M is shown in formula (20):

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 20 )$$

Here, mₗ′∈{0,1} are values of M from the highest bit ( [symbol] =1) to the lowest bit ( [symbol] =3d), respectively. After the Morton code M of each point in the point cloud is obtained, the points in the point cloud are arranged in order of Morton code from small to large, and a weighting factor w of each point is set to 1.

There are 4 general test conditions for GPCC:
condition 1: the geometric position being limitedly lossy, and the attributes being lossy;
condition 2: the geometric position being lossless, and the attributes being lossy;
condition 3: the geometric position being lossless, and the attributes being limitedly lossy; and
condition 4: the geometric position being lossless, and the attributes being lossless.

General test sequences include four types: Cat1A, Cat1B, Cat3-fused, and Cat3-frame, where Cat2-frame point cloud includes only reflectance attribute information, Cat1A point cloud and Cat1B point cloud include only color attribute information, and Cat3-fused point cloud includes both the color attribute information and the reflectance attribute information.

There are two technical routes for GPCC, differentiated by an algorithm used for geometric compression, which are classified into an octree encoding branch and a prediction tree encoding branch.

In the octree coding branch, at the encoding side, a bounding box is continuously partitioned into sub-cubes; and partitioning is continued for non-empty sub-cubes (including points in the point cloud) until leaf nodes obtained by partitioning are unit cubes of 1×1×1. In a case of geometric lossless encoding, the number of points included in the leaf node needs to be encoded to finally complete the encoding of the geometric octree and generate the binary bitstream. At the decoding side, the decoding side obtains, in the order of breadth-first traversal, an occupancy code of each node by continuous parsing, and the partitioning is continued for the nodes in turn until unit cubes of 1×1×1 are obtained. In the case of the geometric lossless decoding, the number of points included in each leaf node needs to be parsed, and the geometric reconstruction point cloud information is restored finally.

In the prediction tree encoding branch, at the encoding side, a prediction tree structure is established by using two different manners including a high-latency slow mode (KD-Tree), and a low-latency fast mode in which each point is assigned into a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream. At the decoding side, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The above introduces the geometric encoding and decoding under the G-PCC coding framework. The attribute encoding and decoding under the G-PCC coding framework will be introduced below.

As shown in FIG. 4A, the current G-PCC coding framework includes three attribute encoding methods: predicting transform (PT), lifting transform (LT), and region adaptive hierarchical transform (RAHT). The first two methods perform predictive encoding on point clouds based on the generation order of LODs, and the RAHT adaptively transforms attribute information from bottom to top based on the construction hierarchy of the octree. These three point cloud attribute encoding methods will be explained separately below.

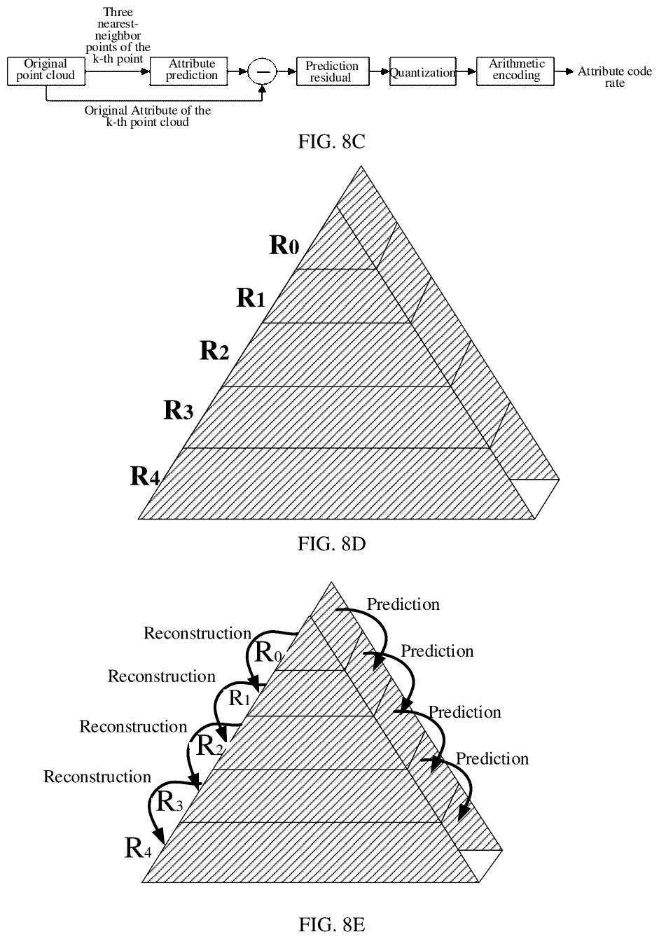

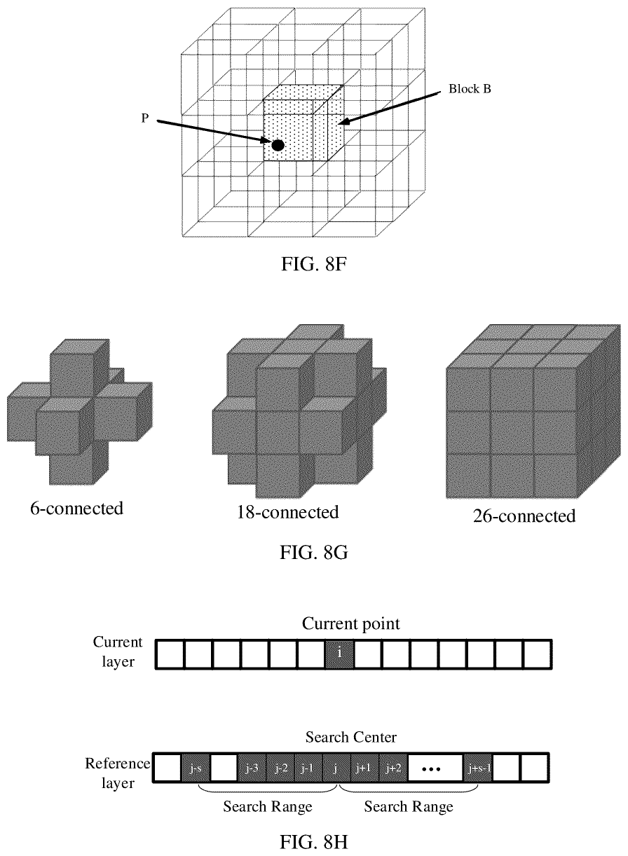

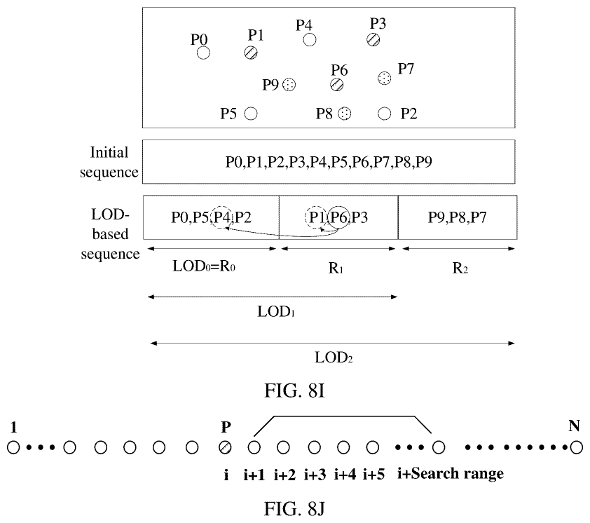

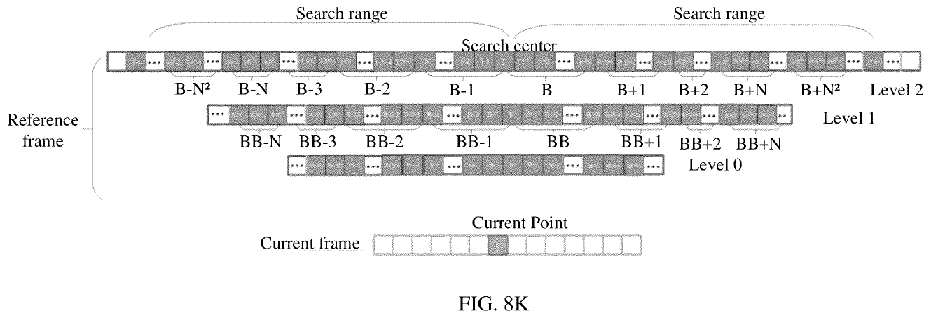

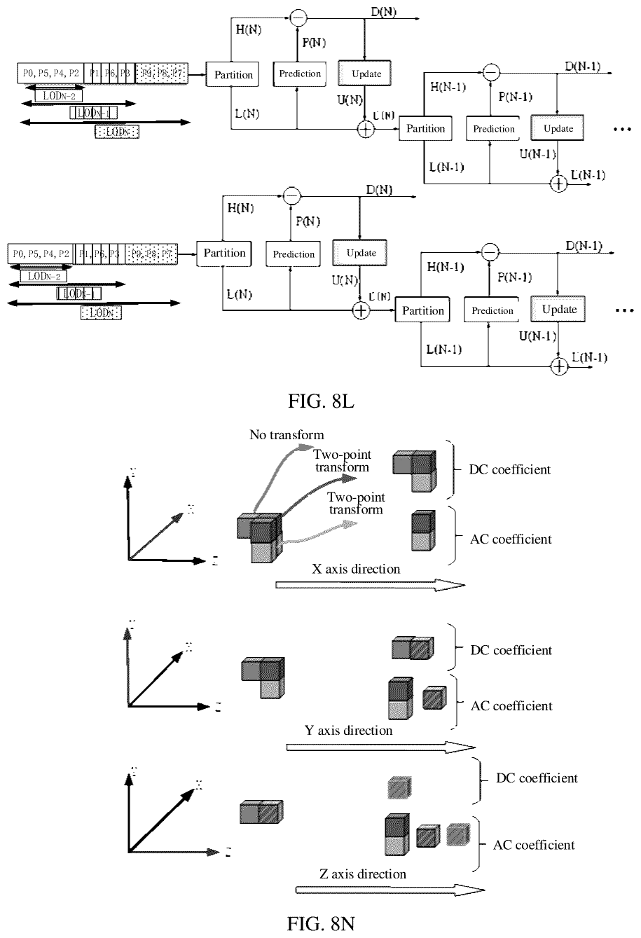

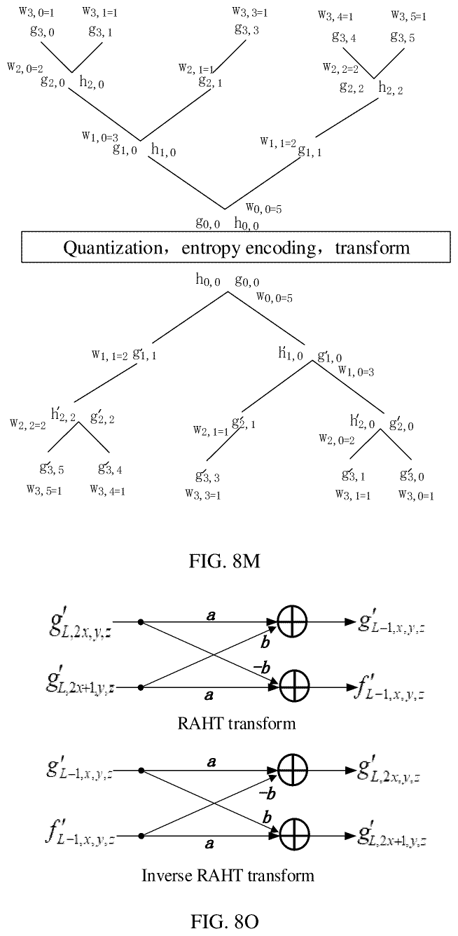

The current attribute prediction module of G-PCC uses a nearest-neighbor attribute prediction encoding scheme based on a level-of-details (LoDs) structure. The LOD construction methods include a distance-based LOD construction scheme, a fixed sampling rate-based LOD construction scheme, and an octree-based LOD construction scheme. In the LOD construction scheme based on a distance threshold, the point cloud is first Morton sorted before constructing LOD to ensure that there is a strong attribute correlation between neighboring points. As shown in FIG. 8A, an example of a distance-based LOD construction process is given, in which the point clouds are partitioned into L different point cloud layers of detail (Rl) l=0,1, . . . . L−1 based on L Manhattan distances (dl) 1=0, 1, . . . . L−1 preset by the user, where (dl) l=0, 1, . . . . L−1 meets dl less than dl−1. The construction process of LOD is as follows. (1) First, all points in the point cloud are marked as unvisited, and a set V is established to store the visited point set; (2) For each iteration 1, by traversing the points in the point cloud, if the current point has been visited, the current point is skipped, otherwise the minimum distance D from the current point to the point set V is calculated, if D less than dl, the point is skipped; otherwise, the current point is marked as visited and add the current point to the layers of detail Rl and the point set V; (3) The points in the layer of detail LODl are composed of the points in the layers of detail R0, R1, R2 . . . . Rl; (4) The above steps are repeated until all points have been marked as visited.

Based on the LOD structure, the attribute value of each point is linearly weighted predicted by using the reconstructed attribute value of the point in the same or higher LOD layer, where the maximum number of reference prediction neighbors is determined based on the encoder high-level syntax elements. For the attributes of each point, the rate-distortion optimization algorithm is used at the encoding side to select weighted prediction by using the attributes of the N nearest-neighbor points searched or selecting the attributes of a single nearest-neighbor point for prediction, and finally the selected prediction mode and prediction residual are encoded.

For example, the attribute prediction value is determined based on the following formula (21):

$${{Attr}_{i}}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 21 )$$

N represents the number of prediction points in the nearest-neighbor point set of point i, pᵢ represents a sum of the N nearest-neighbor points of point i, Dₘ represents a spatial geometric distance from the nearest-neighbor point m to the current point i, Attrₘ represents the attribute value of the nearest-neighbor point m after reconstruction, Attrᵢ′ represents the attribute prediction value of the current point i, and the number of points N is a preset value.

In order to balance the attribute encoding efficiency and parallel processing between different LODs, a switch is introduced in the encoder high-level syntax element to control whether to introduce intra-LOD prediction. If the switch is turned on, intra-LOD layer prediction is started, and points in the same LOD may be used for prediction. It should be noted that in a case where the number of LODs is 1, intra-LOD prediction is always used.

In an example, FIG. 8B shows a visualization result of LOD. The points at the first layer represent outer contours of the point cloud. As the number of LODs increases, the detail description of the point cloud becomes clearer.

In an example, FIG. 8C is a flowchart of G-PCC attribute prediction. That is, for the k-th point in the point cloud, three nearest-neighbor points of the k-th point are first determined, and an attribute prediction value of the k-th point is determined based on the attribute reconstructed information of the three nearest-neighbor points. Next, an attribute prediction residual of the k-th point is obtained based on an original attribute value and the attribute prediction value of the k-th point, and after the attribute prediction residual is quantized, arithmetic encoding is performed to obtain an attribute bitstream.

In some embodiments, after the LOD is constructed, the three nearest-neighbor points of the current point to be encoded are first found from the encoded data points based on the generation order of the LOD. The attribute reconstructed values of the three nearest-neighbor points are used as candidate prediction values of the current point to be encoded; then, the optimal prediction value is selected from the attribute reconstructed values of the three nearest-neighbor points according to the rate-distortion optimization (RDO). For example, in a case of encoding the attribute value of point P2 in FIG. 8A, the predictor variable index of the attribute value of the nearest-neighbor point P4 is set to 1; the attribute predictor variable indexes of the second nearest-neighbor point P5 and the third nearest-neighbor point P0 are set to 2 and 3 respectively; and the predictor variable index of the weighted average of points P0, P5 and P4 is set to 0, as shown in Table 2:

TABLE 2
Samples of candidate prediction items for attribute encoding

| Prediction mode | Prediction value |
|---|---|
| 0 | Weighted average of attributes of three |
| | nearest-neighbors |
| 1 | P4 (an attribute value of a neighbor) |
| 2 | P5 (an attribute value of the second |
| | nearest-neighbor) |
| 3 | P0 (an attribute value of three |
| | nearest-neighbors) |

Finally, the optimal predictor variable is selected using RDO. The formula of weighted average is shown in formula (22):

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) \qquad ( 22 )$$

In Formula (22), \tilde{w}ᵢⱼ represents the spatial geometric weight from the nearest-neighbor point j to the current point i, and the calculation formula is shown in formula (23):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 23 )$$

Here, âᵢ represents the attribute prediction value of the current point i, j represents the indexes of the three nearest-neighbor points, ãᵢ represents the attribute value of the nearest-neighbor points after reconstruction, xᵢ, yᵢ, zᵢ are the geometric position coordinates of the current point i, and xᵢⱼ, yᵢⱼ, zᵢⱼ are the geometric coordinates of the nearest-neighbor points j.

The attribute prediction residual and quantification will be introduced below.

Through the above prediction, the attribute prediction value (âᵢ)_{i∈0 . . . k-1} (where k represents a total number of points in the point cloud) of the current point i is obtained. Let (aᵢ)_{i∈0 . . . k-1} be the original attribute value of the current point, then as shown in formula (24), the attribute residual (rᵢ)_{i∈0 . . . k-1} is denoted as:

$${r}_{i} = {a}_{i} - {\hat{a}}_{i} \qquad ( 24 )$$

Furthermore, the prediction residual is quantified based on the following formula (25):

$${Q}_{i} = \frac{{r}_{i}}{Qs} \qquad ( 25 )$$

In formula (25), Qᵢ represents the quantized attribute residual of the current point i, and Qs represents the quantization step, which may be calculated by the quantization parameter (QP) specified by CTC.

### Reconstruction of the Attribute Value at the Encoding Side

The purpose of reconstruction at the encoding side is to predict subsequent points. Before the reconstruction of the attribute value, the residual needs to undergo inverse quantization, as shown in formula (26), \hat{r}ᵢ is denoted as the residual after inverse quantization:

$${\hat{r}}_{i} = {Q}_{i} \times Qs \qquad ( 26 )$$

Then, based on the following formula (27), the reconstructed value ãᵢ of the point i is obtained by adding \hat{r}ᵢ to the prediction value âᵢ:

$${\tilde{a}}_{i} = {\hat{r}}_{i} + {\tilde{a}}_{i} \qquad ( 27 )$$

In a case of performing attribute nearest-neighbor search based on LOD partition, there are currently two major types of algorithms: intra nearest-neighbor search and inter nearest-neighbor search. The intra nearest-neighbor search is divided into two algorithms: inter-layer nearest-neighbor search and intra-layer nearest-neighbor search.

### Intra Nearest-Neighbor Search:

The intra nearest-neighbor search is divided into two algorithms: inter-layer nearest-neighbor search and intra-layer nearest-neighbor search. After LOD partition, a pyramid structure similar to that shown in FIG. 8D is obtained.

### 1. Inter-Layer Nearest-Neighbor Search

As shown in FIG. 8E and FIG. 8A, different LODs, namely LOD0, LOD1 and LOD2, are obtained based on the geometric information partition, and points in LOD0 are used to predict attributes of points in a next LOD during the process of the inter-layer nearest-neighbor search.

The entire process of the intra nearest-neighbor search will be described in detail below.

In the entire process of LOD partition, there are three sets O(k), L(k) and I(k), where k is the index of the LOD during LOD partition, and I(k) is the input point set during the current LOD partition. After LOD partition, O(k) and L(k) sets are obtained. The O(k) set stores the sampling point set, and L(k) is the point set in the current LOD. That is, the entire process of LOD partition is as follows.
(1) Initialization

$$\begin{matrix}if k = 0 , L ( k ) ← \{ \} . Otherwise ( k ) ← L ( k - 1 ) \\ O ( k ) ← \{ \}\end{matrix}$$

(2) Based on the LOD partition algorithm, the sampling points are stored in O(k), and the remaining points are partitioned into L(k);
(3) In a case of performing the next iteration, I←(k).

It should be noted here that since the entire process of LOD partition is based on the Morton code, O(k), L(k) and I(k) store the Morton code index corresponding to the point.

In a case of performing inter-layer nearest-neighbor search, that is, the points in the L(k) set perform nearest-neighbor search in the O(k) set. The search algorithm is as follows.

Nearest-neighbor search based on spatial relationships

In a case of predicting the current point P, neighbor search is performed by using the parent block (Block B) corresponding to the point P, as shown in FIG. 8F, to search for points in neighbor blocks that are coplanar or co-edge with the current parent block to perform attribute prediction.

For example, the spatial relationship of coplanar, co-edge and copointed is shown in FIG. 8G.

First, the coordinates of the current point are used to obtain a corresponding spatial block. Secondly, the nearest-neighbor search is performed in the previously encoded LOD to find spatial blocks that are coplanar, co-edge, and copointed with the current block to obtain the N nearest-neighbors of the current point.

If the N nearest-neighbors of the current point are still not obtained after performing coplanar, co-edge and co-pointed nearest-neighbor searches, the N nearest-neighbors of the current point will be obtained based on a fast search algorithm, and the algorithm is shown in FIG. 8H. When performing inter-attribute layer prediction, the Morton code corresponding to the current point is first obtained using the geometric coordinates of the current point to be encoded. Secondly, based on the Morton code of the current point, the first reference point (j) whose Morton code is greater than the current point is found in the reference picture. Then, the nearest-neighbor search is performed in the range of [j−searchRange, j+searchRange].

The rest of the algorithms for updating the nearest-neighbor are the same as the inter nearest-neighbor search algorithm, which will not be described here. The algorithms will be mentioned in the inter nearest-neighbor search algorithm.

### 2. Inter-Layer Nearest-Neighbor Search

As shown in FIG. 8I, in a case where the intra-layer prediction algorithm is turned on, a nearest-neighbor search is performed in the same LOD and the set of encoded points in the same layer to obtain the N nearest-neighbors of the current point (inter-layer nearest-neighbor search is also performed).

In a case of performing attribute inter-layer prediction, the nearest-neighbor search is performed based on the fast search algorithm. The algorithm is shown in FIG. 8J. Assuming that the Morton code index of the current point is i, the nearest-neighbor search will be performed in [i+1, i+searchRange]. The nearest-neighbor search algorithm is consistent with the block-based inter fast search algorithm, which will not be described here and will be discussed in detail later.

The above introduces the intra nearest-neighbor search. The inter nearest-neighbor search will be introduced below.

### Inter Nearest-Neighbor Search

As shown in FIG. 8H, when performing attribute inter prediction, the Morton code corresponding to the current point are first obtained using the geometric coordinates of the current point to be encoded. Secondly, based on the Morton code of the current point, the first reference point (j) that is larger than the Morton code of the current point is found in the reference picture. Then, the nearest-neighbor search is performed in the range of [j−searchRange, j+searchRange].

Currently, in a case of performing intra nearest-neighbor search and inter nearest-neighbor search, the neighborhood search is performed based on blocks, as shown in FIG. 8K. When searching for the neighborhood of the current point (Morton code index is i), the points in the reference picture are first partitioned into N (N is equal to 3) layers according to the Morton code. The partition algorithm is as follows.
First layer: assuming that the reference picture contains numPoints points, the points in the reference picture are first partitioned into a block every M (M=2⁵=32) points.
Second layer: on the basis of the first layer, the blocks of the first layer are partitioned into one block every M (M=2⁵=32) blocks according to the order of Morton code.
Third layer: on the basis of the second layer, the blocks of the first layer are partitioned into one block every M (M=2⁵=32) blocks according to the order of Morton code.

Finally, the prediction structure shown in FIG. 8K is obtained.

In a case of performing attribute prediction based on the prediction structure shown in FIG. 8K, assuming that the Morton code index of the current point to be encoded is i, the first point in the reference picture whose Morton code is greater than or equal to the Morton code of the current point is first obtained, with an index of j. Secondly, the block index of the reference point is calculated based on j. The calculation method is as follows.

$$\begin{matrix}\begin{matrix}First layer : BucketSize \_ 0 = {2}^{5} = 32 ; \\ Second layer : BucketSize \_ 1 = {2}^{5} = 32 \times BucketSize \_ 0 = 1024 ;\end{matrix} \\ Third layer : BucketSize \_ 2 = {2}^{5} = 32 \times BucketSize \_ 1 = 32768.\end{matrix}$$

Assuming that the reference range in the prediction picture of the current point is [j−searchRange, j+searchRange], the starting index of the third layer is calculated using j−searchRange, and the ending index of the third layer is calculated using j+searchRange. Next, it is determined whether some blocks of the second layer need to undergo nearest-neighbor search in the blocks of the third layer; then, moving to the second layer, it is determined whether a search is needed for each block of the first layer; if some blocks of the first layer need to undergo nearest-neighbor search, some points of the blocks of the first layer will be determined point by point to update the nearest-neighbors.

The index-based calculation block algorithm will be introduced below. Assuming that the Morton code index corresponding to the current point is “index”, the index of the corresponding third layer block is as shown in formula (28):

$$idx \_ 2 = index / BucketSize \_ 2 \qquad ( 28 )$$

After the index idx_2 of the third layer block is obtained, the starting index and the ending index of the block of the second layer corresponding to the current block may be obtained using idx_2, as shown in formula (29):

$$\begin{matrix}startIdx 1 = idx \_ 2 \times BucketSize \_ 1 \\ endIdx = idx \_ 2 \times BucketSize \_ 1 + BucketSize \_ 1 - 1\end{matrix} \qquad ( 29 )$$

Based on the same algorithm, the index of the first layer block is obtained based on the index of the second layer block.

In a case of performing nearest-neighbor search based on blocks, it is first determined whether the current block needs to undergo nearest-neighbor search, that is, filter the nearest-neighbor search of the block. Each spatial block may be obtained based on two variables minPos and maxPos, where minPos represents the minimum value of the block and maxPos represents the maximum value of the block.

Assuming that the distance of the farthest point among the N nearest-neighbors of the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as shown in formula (30):

$$int dx = int ( \text{} std \text{::} max \text{} ( std \text{::} max ( min Pos [ 0 ] - point [ 0 ] , 0 ) , point [ 0 ] - max Pos [ 0 ] ) ) ; int dy = int ( \text{} std \text{::} max \text{} ( std \text{::} max \text{} ( min Pos [ 1 ] - point [ 1 ] , 0 ) , point [ 1 ] - max Pos [ 1 ] ) ) ; int dz = int ( \text{} std \text{::} max ( std \text{::} max ( min Pos [ 2 ] - point [ 2 ] , 0 ) , point [ 2 ] - max Pos [ 2 ] ) ) ; D = dx + dy + dz \qquad ( 30 )$$

In a case where D is less than or equal to Dist, the points in the current block will be traversed.

The lifting transform encoding of the attribute information of the point cloud will be introduced below.

FIG. 8L shows an encoding process of the lifting transform. The lifting transform also performs predictive encoding on the attributes of the point cloud based on LODs. The difference from the prediction transform is that the lifting transform first partitions the LODs into high and low layers, performs prediction in the reversed order of the LOD generation, and introduces an update operator in the prediction process to update the quantization weights of the points in the lower LODs to improve the accuracy of the prediction. This is because the attribute values of points in the lower LODs are frequently used to predict the attribute values of points in the higher LODs, and points in the lower LODs should have greater influence.

### Step 1: Partition Process

The partition process is to partition the complete LOD into lower LODs L(N) and higher LODs H(N). If a point cloud has three LODs, i.e., (LODₗ)_{l=0, 1, 2}, after partition, LOD₂ is the higher LOD, denoted as H(N), and (LODₗ)_{l=0, 1} is the lower LOD, denoted as L(N).

### Step 2: Prediction Process

The points in the higher LODs select the attribute information of the nearest-neighbor points from the lower LODs as the attribute prediction value P(N) of the current point to be encoded. The prediction residual D(N) is shown in formula (31):

$$D ( N ) = H ( N ) - P ( N ) \qquad ( 31 )$$

### Step 3: Update Process

The attribute prediction residual D(N) in the higher LODs is updated to obtain U(N), and the attribute values of the points in the lower LODs are lifted using U(N), as shown in formula (32):

$${L}^{′} ( N ) = L ( N ) + U ( N ) \qquad ( 32 )$$

The above process will iterate continuously until the lowest LOD level according to the order of LOD from high to low.

Since the LOD-based prediction scheme makes the points in the lower LODs have greater influence, the transform scheme based on lifting wavelet transform introduces quantization weights and updates the prediction residual according to the prediction residual D(N) and the distance between the prediction point and the neighboring points. Finally, adaptive quantization is performed on the prediction residual using the quantization weights in the transform process. It should be noted that the quantization weight value of each point may be determined by geometric reconstruction at the decoding side, so the quantization weight do not need to be encoded.

The region adaptive hierarchical transform will be introduced below.

The region adaptive hierarchical transform (RAHT) is a Haar wavelet transform that may transform the attribute information of the point cloud from the spatial domain to the frequency domain and further reduce the correlation between the attributes of the point cloud. The main idea is to transform the nodes in each layer from the three dimensions of x, y, and z (as shown in FIG. 8N) in a bottom-up manner according to the octree structure, and to perform iteration until reaching the root node of the octree. As shown in FIG. 8M, the basic idea is to perform wavelet transform based on the hierarchical structure of the octree, associate the attribute information with the nodes of the octree, and recursively transform the attributes of the occupied nodes in the same parent node in a bottom-up manner. The nodes in each layer are transformed from the three dimensions of x, y, and z until reaching the root node of the octree. In the process of hierarchical transform, the low-pass (DC) coefficients obtained after transforming the nodes in the same layer are passed to the nodes in the next layer for further transformation, while all high-pass (AC) coefficients are encoded by the arithmetic encoder.

During the transformation process, the DC coefficient (direct current component) of the nodes in the same layer after transformation will be passed to the previous layer for further transformation, and the AC coefficient (alternating current component) after transformation of each layer will be quantized and encoded. The main transformation process will be introduced below.

FIG. 8O shows the corresponding transform and inverse transform process. Assuming that g_{L,2x,y,z}′ and g_{L,2x+1,y,z}′ are two attributes DC coefficients that are neighboring points in the L layer. After the linear transformation, the information of the L−1 layer is the AC coefficient f_{L-1,x,y,z}′ and the DC coefficient g_{L-1,x,y,z}′; then, no more transform will be performed on f_{L-1,x,y,z}′, and quantization encoding will be performed on f_{L-1,x,y,z}′ directly; g_{L-1,x,y,z}′ will continue to search nearest-neighbors for transformation, and it will be passed directly to the L−2 layer if none are found. That is, the RAHT transform is only valid for nodes with neighboring points, and nodes without neighboring points will be passed directly to the previous layer. In the above transformation process, the weights corresponding to g_{L,2x,y,z}′ and g_{L,2x+2,y,z}′ (the number of non-empty child nodes in a node) are w_{L,2x,y,z}′ and w_{L,2x+1,y,z}′ (abbreviated as w₀′ and w₁′), and the weight of g_{L-1,x,y,z}′ is w_{L-1,x,y,z}′, then the general transformation formula (33) is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 33 )$$

For example, T_{w0,w1} in the formula is a transformation matrix determined according to the following formula (34):

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 34 )$$

The transformation matrix will be updated as the weights corresponding to each point change adaptively. The above process will be continuously iterated and updated based on the partition structure of the octree until reaching the root node of the octree.

The above description introduces the encoding and decoding technology of the geometric information of the point cloud and the encoding and decoding technology of the attribute information of the point cloud.

As can be seen from the above, in the environment of lossy geometric coding, in the process of inter coding of point cloud geometric information, the predictive coding is performed on the geometric information of the current point cloud to be coded only by using the geometric information of the reference picture, which makes the coding of the geometric information of the point cloud not accurate enough, thereby reducing the coding performance of the point cloud.

In order to solve the above technical problems, in the embodiments of the present application, an optimization is performed in a case where the encoding/decoding side performs DCM direct encoding on the node, and a predictive coding is performed on the geometric information of the points of the IDCM node to be coded by using the geometric information of the prediction node in the prediction reference picture by considering the time domain correlation between neighboring pictures, thereby further improving the coding efficiency of the geometric information of the point cloud by considering the time domain correlation between neighboring pictures. Furthermore, in the embodiments of the present application, a new encoding and decoding mode, i.e., a skipCode mode, is introduced in the IDCM geometric encoding and decoding process. That is, the geometric information of the current point is not edited, and the geometric information of the current point is determined directly based on the geometric information of the prediction point, thereby saving codewords and further improving the coding efficiency.

The point cloud encoding and decoding methods involved in the embodiments of the present application will be introduced below in conjunction with embodiments.

First, considering the decoding side as an example, the point cloud decoding method provided in the embodiments of the present application will be introduced.

FIG. 9 is a schematic flowchart of the point cloud decoding method provided in the embodiments of the present application. The point cloud decoding method of the embodiments of the present application may be implemented by the point cloud decoding device or the point cloud decoder shown in FIG. 3 or FIG. 4B or FIG. 8B as mentioned above.

As shown in FIG. 9, the point cloud decoding method of the embodiments of the present application includes the following steps.

In S101, a decoding mode of a current point in a current node is determined.

The current node is a node to be decoded in a current picture to be decoded.

As can be seen from the above, a point cloud includes geometric information and attribute information, and decoding of the point cloud includes geometric decoding and attribute decoding. The embodiments of the present application relate to the geometric decoding of the point cloud.

In some embodiments, the geometric information of the point cloud is also referred to as position information of the point cloud. Therefore, the geometric decoding of the point cloud is also referred to as position decoding of the point cloud.

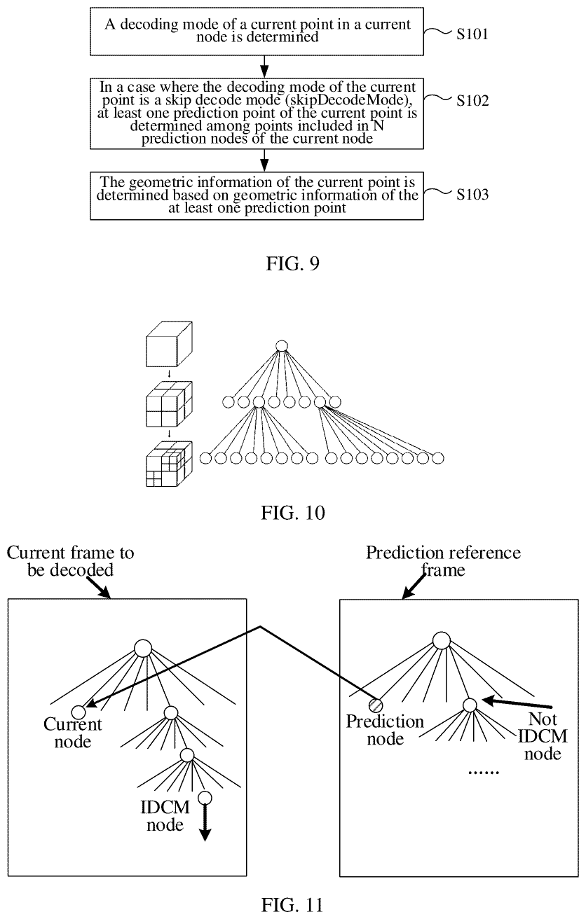

In an octree-based encoding manner, the encoding side constructs an octree structure of the point cloud based on the geometric information of the point cloud. As shown in FIG. 10, the point cloud is enclosed by a smallest rectangular block, and octree partitioning is performed on the bounding box first to obtain 8 nodes. The octree partitioning is continued for occupied nodes in these 8 nodes, i.e., the nodes including points, and so on, until the partitioning reaches a voxel level position, for example, until there exist cubes of 1×1×1. An octree structure of the point cloud obtained by such partitioning manner includes multiple layers of nodes, such as N layers. Occupancy information of each layer is encoded layer by layer in encoding until leaf nodes at the voxel level in the last layer are encoded. That is to say, in the octree encoding, the points in the point cloud are finally partitioned into the leaf nodes at the voxel level in the octree through partitioning the point cloud by the octree, so the encoding of the point cloud may be implemented by encoding the entire octree.

Correspondingly, the decoding side first decodes a geometric bitstream of the point cloud to obtain occupancy information of a root node of the octree of the point cloud, and determines child nodes included in the root node (that is, nodes included in a second layer of the octree) based on the occupancy information of the root node. Next, the decoding side decodes the geometric bitstream to obtain the occupancy information of each node in the second layer, and determines nodes included in a third layer of the octree based on the occupancy information of each node, and so on.

However, the octree-based geometric information encoding mode has an efficient compression rate for correlated points in space, and for points in isolated positions in the geometric space, the use of direct encoding model may greatly reduce the complexity and improve the coding efficiency.

Since the direct encoding model is to directly encode the geometric information of the points included in the node, if the number of points included in the node is large, the compression effect is poor in a case where the direct encoding model is used. Therefore, for a node in the octree, before the direct encoding, it is first determined whether the node can be directly encoded. If it is determined that the node can be encoded using the direct encoding model, the geometric information of the points included in the node is directly encoded using the direct encoding model. If it is determined that the node cannot be encoded using the direct encoding model, the node is further partitioned using the octree method.

In some embodiments, the encoding side first determines whether the node is qualified for direct encoding. If the node is qualified for direct encoding, the encoding side determines whether the number of points of the node is less than or equal to a preset threshold. In response to that the number of points of the node is less than or equal to the preset threshold, the encoding side determines that the node can be encoded using the direct encoding model. Next, the encoding side encodes the number of points included in the node and the geometric information of each point into a bitstream. Correspondingly, after determining that the node is qualified for direct decoding, the decoding side decodes the bitstream to obtain the number of points of the node and the geometric information of each point, thereby implementing the geometric decoding of the node.

Currently, in a case of decoding the geometric information of a current node, a correlation between neighboring pictures is not considered, resulting in poor geometric prediction decoding performance. In the embodiments of the present application, in a case of decoding geometric information of a current node, a prediction node of the current node is determined in a prediction reference picture of a current picture to be decoded, and then predictive decoding is performed on the geometric information of the current node based on geometric information of the prediction node. The inter correlation is taken into account, thereby improving the geometric decoding performance.

In the embodiments of the present application, in order to further improve the decoding efficiency of the geometric information of the point cloud, a skip decode mode (skipDecodeMode) is proposed. The skipDecodeMode is a mode for skipping decoding of geometric information of the current point, and the geometric information of the current point is determined based on the geometric information of the prediction point of the current point (i.e., geometric reconstructed information). For example, the geometric information of the prediction point is directly determined as the geometric information of the current point. In this way, the decoding efficiency of the point cloud may be greatly improved.

It should be noted that the current picture to be decoded is a point cloud picture. In some embodiments, the current picture to be decoded is also referred to as a current picture or a current point cloud picture or a current point cloud picture to be decoded. The current node may be understood as any non-empty node that is not a leaf node in the current picture to be decoded. That is, the current node is not a leaf node in the octree corresponding to the current picture to be decoded. That is, the current node is an arbitrary node of the octree, and the current node is not a non-empty node, that is, the current node includes at least one point.

The skipDecodeMode proposed in the embodiments of the present application is based on the direct decoding mode. That is, before decoding the current point in the current node using the skipDecodeMode, whether the current node is a true IDCM node, i.e., whether the current node is decoded using a direct decoding mode, needs to be first determined. In a case where it is determined that the current node is decoded using the direct decoding mode, it is determined whether the current point in the current node is decoded using the skipDecodeMode.

The method of determining the decoding mode of the current point is not limited in the embodiments of the present application.

In some embodiments, if the current node is an IDCM node, the encoding side uses a skipCodeMode by default to encode the geometric information of the current point in the current node, that is, to perform skip encoding on the geometric information of the current point. Correspondingly, the decoding side uses the skipDecodeMode by default to decode the geometric information of the current point. In this case, the decoding side determines that the decoding mode of the current point is the skipDecodeMode.

In some embodiments, the encoding side selects, by using a rate-distortion optimization algorithm, an encoding method from multiple preset encoding methods to encode the current point. It should be noted that the multiple preset encoding methods include the skipCodeMode. Next, the encoding side encodes the index or indication information of the selected encoding method into the bitstream. Correspondingly, the decoding side decodes the bitstream to obtain the decoding mode of the current point.

In some embodiments, the S101 includes the following steps.

In S101-A, whether the current node meets a start condition of the skipDecodeMode is determined.

In S101-B, the decoding mode of the current point is determined based on whether the current node meets the start condition of the skipDecodeMode.

That is, in this embodiment, the decoding side determines whether the current point in the current node is decoded using the skipDecodeMode by determining whether the current node meets the start condition of the skipDecodeMode.

The process of the decoding side determining whether the current node meets the start condition of the skipDecodeMode will be introduced below.

The specific content of the start condition of the skipDecodeMode is not limited in the embodiments of the present application.

In an example, the start condition of the skipDecodeMode includes: the number of points included in the prediction nodes being greater than or equal to a first numerical value. Optionally, the first numerical value is a positive integer.

In another example, the start condition of the skipDecodeMode includes: the number of points included in the prediction nodes being equal to the number of points included in the current node.

In yet another example, the start condition of the skipDecodeMode includes: the number of points included in the prediction nodes being equal to the number of points included in the current node, and a direct decoding mode of the prediction nodes being the same as a direct decoding mode of the current node.

In the embodiments of the present application, the method in which the decoding side determines whether the current node meets the start condition of the skipDecodeMode includes, but is not limited to, the following manners.

In a first manner, the bitstream is decoded to obtain a second flag, such as skipCodeEligible. The second flag skipCodeEligible is used to indicate whether the current node meets the start condition of the skipDecodeMode. Whether the current node meets the start condition of the skipDecodeMode is determined based on the second flag.

In the first manner, the encoding side determines that the current node meets the start condition of the skipCodeMode based on one of the above three start conditions, and then encodes the second flag skipCodeEligible in the bitstream. The second flag skipCodeEligible is used to indicate whether the current node meets the start condition of the skipCodeMode. In this way, the decoding side obtains the second flag skipCodeEligible by decoding the bitstream, and determines whether the current node meets the start condition of the skipDecodeMode based on the second flag skipCodeEligible.

For example, in response to that a value of the second flag skipCodeEligible is a third value, it is determined that the current node meets the start condition of the skipDecodeMode.

For another example, in response to that the value of the second flag skipCodeEligible is a fourth value, it is determined that the current node does not meet the start condition of the skipDecodeMode.

The specific values of the third value and the fourth value are not limited in the embodiments of the present application.

Optionally, the third value is 1 and the fourth value is 0.

In the first manner, the decoding side may determine whether the current node meets the start condition of the skipDecodeMode by directly decoding the bitstream. This manner is simple and saves computing resources of the decoding side.

In a second manner, the decoding side determines whether the current node meets the start condition of the skipDecodeMode based on the above-mentioned start condition of the skipDecodeMode. For example, if the current node meets the start condition of the skipDecodeMode, skipCodeEligible is set to true; if the current node does not meet the start condition of the skipDecodeMode, skipCodeEligible is set to false. In this case, the above S101-A includes the following steps S101-A1 and S101-A2.

In S101-A1, N prediction nodes of the current node are determined in prediction reference pictures of the current picture to be decoded.

In S101-A2, whether the current node meets the start condition of the skipDecodeMode is determined based on the number of points included in at least one prediction node among the N prediction nodes.

The process of determining the N prediction nodes of the current node in the prediction reference pictures of the current picture to be decoded will be introduced below.

It should be noted that the number of prediction reference pictures of the current picture to be decoded is not limited in the embodiments of the present application. For example, the current picture to be decoded has one prediction reference picture, or the current picture to be decoded has multiple prediction reference pictures. Moreover, the number N of prediction nodes of the current node is not limited in the embodiments of the present application, which is determined according to actual needs.

The specific method of determining the prediction reference picture of the current picture to be decoded is not limited in the embodiments of the present application.

In some embodiments, one or several decoded pictures before the current picture to be decoded are determined as prediction reference pictures of the current picture to be decoded.

For example, if the current picture to be decoded is a P frame (picture), inter reference pictures of the P frame includes a previous picture (i.e., a forward picture) of the P frame. Therefore, the previous picture (i.e., the forward picture) of the current picture to be decoded may be determined as a prediction reference picture of the current picture to be decoded.

For another example, if the current picture to be decoded is a B frame (picture), inter reference pictures of the B frame includes a previous picture (i.e., a forward picture) of the B frame and a next picture (i.e., a backward picture) of the B frame. Therefore, the previous picture (i.e., the forward picture) of the current picture to be decoded may be determined as a prediction reference picture of the current picture to be decoded.

In some embodiments, one or several decoded pictures after the current picture to be decoded are determined as prediction reference pictures of the current picture to be decoded.

For example, if the current picture to be decoded is a B frame, a picture after the current picture to be decoded may be determined as a prediction reference picture of the current picture to be decoded.

In some embodiments, one or several decoded pictures before the current picture to be decoded and one or several decoded pictures after the current picture to be decoded are determined as prediction reference pictures of the current picture to be decoded.

For example, if the current picture to be decoded is a B frame, a previous picture and a next picture of the current picture to be decoded may be determined as prediction reference pictures of the current picture to be decoded. In this case, the current picture to be decoded has two prediction reference pictures.

As shown in FIG. 11, in the embodiments of the present application, the decoding side determines the prediction node of the current node in the prediction reference pictures of the current picture to be decoded, and then compares the number of points and/or IDCM mode included in the prediction node with the number of points and/or IDCM mode included in the current node to determine whether the current node meets the start condition of the skipDecodeMode.

Considering an example in which the current picture to be decoded includes K prediction reference pictures, the process of determining the N prediction nodes of the current node in the prediction reference pictures of the current picture to be decoded in the S101-A1 will be introduced below.

In some embodiments, the decoding side selects at least one prediction reference picture from the K prediction reference pictures based on occupancy information of the nodes in the current picture to be decoded and occupancy information of the nodes in each of the K prediction reference pictures, and then searches for the prediction node of the current node in the at least one prediction reference picture. For example, at least one prediction reference picture whose node occupancy information is closest to the occupancy information of the node of the current picture to be decoded is selected from the K prediction reference pictures, and then the prediction node of the current node is searched in the at least one prediction reference picture.

In some embodiments, the decoding side may determine the N prediction nodes of the current node through the following steps S101-A11 and S101-A12.

In S101-A11, for a k-th prediction reference picture among the K prediction reference pictures, at least one prediction node of the current node in the k-th prediction reference picture is determined, where k is a positive integer less than or equal to K, and K is a positive integer.

In S101-A12, the N prediction nodes of the current node are determined based on the at least one prediction node of the current node in the K prediction reference pictures.

In this embodiment, the decoding side determines at least one prediction node of the current node from each of the K prediction reference pictures, and then summarizes the at least one prediction node in each of the K prediction reference pictures to obtain the N prediction nodes of the current node.

The process of the decoding side determining at least one prediction point of the current node in each of the K prediction reference pictures is the same. For convenience of description, the k-th prediction reference picture among the K prediction reference pictures is taken as an example for explanation.

The process of determining the at least one prediction node of the current node in the k-th prediction reference picture in the S101-A11 will be introduced below.

The specific manner in which the decoding side determines the at least one prediction node of the current node in the k-th prediction reference picture is not limited in the embodiments of the present application.

Manner one: in the k-th prediction reference picture, a prediction node of the current node is determined. For example, a node in the k-th prediction reference picture having the same partition depth as the current node is determined as the prediction node of the current node.

For example, assuming that the current node is located at the third layer of the octree of the current picture to be decoded, the nodes located at the third layer of the octree in the k-th prediction reference picture may be obtained, and then the prediction node of the current node may be determined from these nodes.

In an example, if the number of prediction nodes of the current node in the k-th prediction reference picture is 1, then among the points in the k-th prediction reference picture having the same partition depth as the current node, a node whose occupancy information has the smallest difference from the occupancy information of the current node may be selected, recorded as node 1, and node 1 is determined as a prediction node of the current node in the k-th prediction reference picture.

In another example, if the number of prediction nodes of the current node in the k-th prediction reference picture is greater than 1, the node 1 determined above and at least one neighborhood node of node 1 in the k-th prediction reference picture, such as at least one neighborhood node that is coplanar, co-edge, or copointed with node 1, is determined as the prediction node of the current node in the k-th prediction reference picture.

Manner two: in the S101-A11, determining the at least one prediction node of the current node in the k-th prediction reference picture includes the following steps S101-A11-a1 to S101-A113.

In S101-A11-a1, M neighborhood nodes of the current node are determined in the current picture to be decoded, where the M neighborhood nodes include the current node, and M is a positive integer.

In S101-A11-a2, for an i-th neighborhood node among the M neighborhood nodes, a corresponding node of the i-th neighborhood node in the k-th prediction reference picture is determined, where i is a positive integer less than or equal to M.

In S101-A11-a3, the at least one prediction node of the current node in the k-th prediction reference picture is determined based on corresponding nodes of the M neighborhood nodes in the k-th prediction reference picture.

In this implementation, before determining at least one prediction node of the current node in the k-th prediction reference picture, the decoding side first determines M neighborhood nodes of the current node in the current picture to be decoded, and the M neighborhood nodes include the current node.

It should be noted that the specific method of determining the M neighborhood nodes of the current node is not limited in the embodiments of the present application.

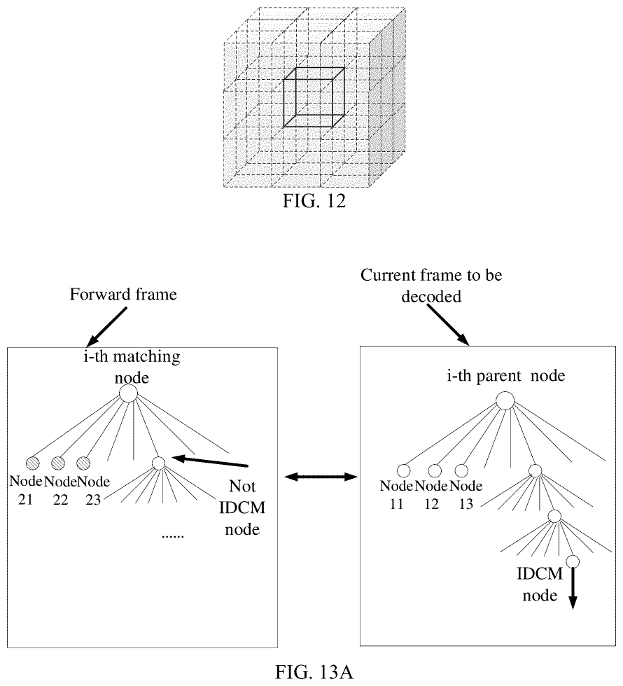

In an example, the M neighborhood nodes of the current node include at least one neighborhood node among the neighborhood nodes that are coplanar, co-edge, and copointed with the current node in the current picture to be decoded. As shown in FIG. 12, the current nodes include 6 coplanar nodes, 12 co-edge nodes, and 8 copointed nodes.

In another example, in addition to the at least one neighborhood node in the current picture to be decoded that is coplanar, co-edge, and copointed with the current node, the M neighborhood nodes of the current node may further include other nodes within a range of reference neighborhood, which is not limited in the embodiments of the present application.

Based on the above steps, the decoding side determines the M neighborhood nodes of the current node in the current picture to be decoded, and then determines the corresponding node of each of the M neighborhood nodes in the k-th prediction reference picture, and then determines at least one prediction node of the current node in the k-th prediction reference picture based on the corresponding nodes of the M neighborhood nodes in the k-th prediction reference picture.

The implementation of S101-A11-a3 is not limited in the embodiments of the present application.

In a possible implementation, at least one corresponding node is selected from the corresponding nodes of the M neighborhood nodes in the k-th prediction reference picture as at least one prediction node of the current node in the k-th prediction reference picture. For example, from the corresponding nodes of the M neighborhood nodes in the k-th prediction reference picture, at least one corresponding node whose occupancy information has the smallest difference from the occupancy information of the current node is selected as at least one prediction node of the current node in the k-th prediction reference picture. As for the method of determining the difference between the occupancy information of the corresponding node and the occupancy information of the current node, reference can be made to the above process of determining the difference of the occupancy information. For example, an XOR operation is performed on the occupancy information of the corresponding node and the occupancy information of the current node, and the XOR operation result is used as the difference between the occupancy information of the corresponding node and the occupancy information of the current node.

In another possible implementation, the decoding side determines the corresponding nodes of the M neighborhood nodes in the k-th prediction reference picture as at least one prediction node of the current node in the k-th prediction reference picture. For example, the M neighborhood nodes each have a corresponding node in the k-th prediction reference picture, so that M corresponding nodes are obtained; and the M corresponding nodes are determined as the prediction nodes of the current node in the k-th prediction reference picture, and there are M prediction nodes in total.

The process of determining the at least one prediction node of the current node in the k-th prediction reference picture is introduced above. In this way, the decoding side may use the same method as above to determine at least one prediction node of the current node in each of the K prediction reference pictures.

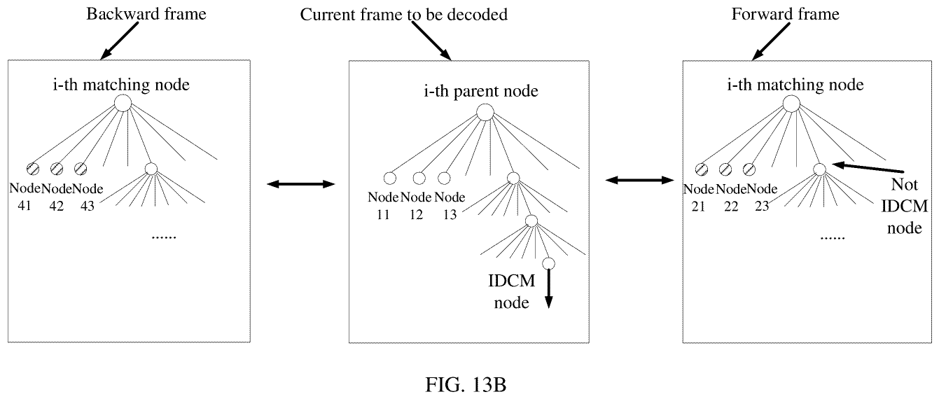

For example, if the current picture to be decoded is a P frame, the K prediction reference pictures include a forward picture of the current picture to be decoded. In this case, based on the above steps, the decoding side may determine at least one prediction node of the current node in the forward picture. For example, as shown in FIG. 13A, it is assumed that the current node includes three neighborhood nodes, which are respectively denoted as node 11, node 12 (the current node) and node 13. The three neighborhood nodes respectively correspond to nodes in the forward picture, which are denoted as node 21, node 22 and node 23. Then, node 21, node 22 and node 23 are determined as the three prediction nodes of the current node in the forward picture; or one or two nodes are selected from node 21, node 22 and node 23 to be determined as one or two prediction nodes of the current node in the forward picture.

For another example, if the current picture to be decoded is a B frame, the K prediction reference pictures include a forward picture and a backward picture of the current picture to be decoded. In this case, based on the above steps, the decoding side may determine at least one prediction node of the current node in the forward picture and at least one prediction node of the current node in the backward picture. For example, as shown in FIG. 13B, it is assumed that the current node includes three neighborhood nodes, which are respectively denoted as node 11, node 12 and node 13. The three neighborhood nodes respectively correspond to nodes in the forward picture, which are denoted as node 21, node 22 and node 23. These three neighborhood nodes respectively correspond to nodes in the backward picture, which are denoted as node 41, node 42 and node 43. In this way, the decoding side may determine node 21, node 22 and node 23 as three prediction nodes of the current node in the forward picture, or may select one or two nodes from node 21, node 22 and node 23 to determine as one or two prediction nodes of the current node in the forward picture. Similarly, the decoding side may determine node 41, node 42 and node 43 as three prediction nodes of the current node in the backward picture, or may select one or two nodes from node 41, node 42 and node 43 as one or two prediction nodes of the current node in the backward picture.

After the decoding side determines the at least one prediction node of the current node in each of the K prediction reference pictures, the S101-A12 is performed, that is, N prediction nodes of the current node are determined based on at least one prediction node of the current node in the K prediction reference pictures.

In an example, the at least one prediction node of the current node in the K prediction reference pictures is determined as the N prediction nodes of the current node.

For example, K is equal to 2 (K=2), that is, the K prediction reference pictures include a first prediction reference picture and a second prediction reference picture. Assuming that the current node has 2 prediction nodes in the first prediction reference picture and the current node has 3 prediction nodes in the second prediction reference picture, it may be determined that the current node has 5 prediction nodes, and in this case N=5.

In another example, the N prediction nodes of the current node are selected from the at least one prediction node of the current node in the K prediction reference pictures.

With continued reference to the above example, it is assumed that K=2, that is, the K prediction reference pictures include a first prediction reference picture and a second prediction reference picture. Assuming that the current node has 2 prediction nodes in the first prediction reference picture and the current node has 3 prediction nodes in the second prediction reference picture, an IDCM node is selected from the 5 prediction nodes and is determined as a final prediction node of the current node.

In the Manner two, after determining the M neighborhood nodes of the current node in the current picture to be decoded, the decoding side determines a corresponding node of each of the M neighborhood nodes in the k-th prediction reference picture, and then determines at least one prediction point of the current node in the k-th prediction reference picture based on the corresponding node of each of the M neighborhood nodes.

Manner three: determining the at least one prediction node of the current node in the k-th prediction reference picture in the S101-A11 includes the following steps S101-A11-b1 to S101-A11-b3.

In S101-A11-b1, a corresponding node of the current node in the k-th prediction reference picture is determined.

In S101-A11-b2, at least one neighborhood node of the corresponding node is determined.

In S101-A11-b3, the at least one neighborhood node is determined as the at least one prediction node of the current node in the k-th prediction reference picture.

In the Manner three, for each of the K prediction reference pictures, the decoding side first determines the corresponding node of the current node in each prediction reference picture. For example, the decoding side determines a corresponding node 1 of the current node in a prediction reference picture 1, and determines a corresponding node 2 of the current node in a prediction reference picture 2. Next, the decoding side determines at least one neighborhood node of each corresponding node. For example, the decoding side determines at least one neighborhood node of the corresponding node 1 in the prediction reference picture 1, and determines at least one neighborhood node of the corresponding node 2 in the prediction reference picture 2. In this way, at least one neighborhood node of the corresponding node 1 in the prediction reference picture 1 may be determined as at least one prediction node of the current node in the prediction reference picture 1, and at least one neighborhood node of the corresponding node 2 in the prediction reference picture 2 may be determined as at least one prediction node of the current node in the prediction reference picture 2.

The process of determining the corresponding node of the i-th neighborhood node in the k-th prediction reference picture in S101-A11-b1 of the Manner three is basically the same as the process of determining the corresponding node of the current node in the k-th prediction reference picture in S101-A11-a1 of the Manner three. For convenience of description, the above i-th neighborhood node and the current node are denoted as i-th nodes. The process of determining the corresponding node of the i-th node in the k-th prediction reference picture will be introduced below.

The decoding side determines the corresponding node of the i-th node in the k-th prediction reference picture by using at least the following manners.

Manner 1: a node in the k-th prediction reference picture that has the same partition depth as the i-th node is determined as the corresponding node of the i-th node.

For example, assuming that the i-th node is located at the third layer of the octree of the current picture to be decoded, all nodes located at the third layer of the octree in the k-th prediction reference picture may be obtained, and then the corresponding node of the i-th node may be determined from these nodes. For example, among the nodes in the k-th prediction reference picture that have the same partition depth as the i-th node, a node whose occupancy information has the smallest difference from the occupancy information of the i-th node is selected and determined as the corresponding node of the i-th node in the k-th prediction reference picture.

Manner 2: the S101-A11-a1 and S101-A11-b1 include the following steps.

In step 11, a parent node of the i-th node is determined as an i-th parent node in the current picture to be decoded.

In step 12, a matching node of the i-th parent node in the k-th prediction reference picture is determined as an i-th matching node.

In step 13, one of child nodes of the i-th matching node is determined as a corresponding node of the i-th node in the k-th prediction reference picture.

In the Manner 2, for the i-th node, the decoding side determines the parent node of the i-th node in the current picture to be decoded, and then determines the matching node of the parent node of the i-th prediction neighborhood node in the k-th prediction reference picture. For convenience of description, the parent node of the i-th node is denoted as the i-th parent node, and the matching node of the parent node of the i-th node in the k-th prediction reference picture is determined as the i-th matching node. Next, a child node of the child nodes of the i-th matching node is determined as the corresponding node of the i-th node in the k-th prediction reference picture. Thereby, the corresponding node of the i-th node in the k-th prediction reference picture is accurately determined.

The process of determining the matching node of the i-th parent node in the k-th prediction reference picture in the step 12 will be introduced below.

The specific manner in which the decoding side determines the matching node of the i-th parent node in the k-th prediction reference picture is not limited in the embodiments of the present application.

In some embodiments, the partition depth of the i-th parent node in the current picture to be decoded is determined, for example, the i-th parent node is at the second layer of the octree of the current picture to be decoded. In this way, the decoding side may determine one node among the nodes in the k-th prediction reference picture that have the same partition depth as the i-th parent node as the matching node of the i-th parent node in the k-th prediction reference picture. For example, one of the nodes at the second layer in the k-th prediction reference picture is determined as the matching node of the i-th parent node in the k-th prediction reference picture.

In some embodiments, the decoding side determines a matching node of the i-th parent node in the k-th prediction reference picture based on the occupancy information of the i-th parent node. For example, the occupancy information of the i-th parent node in the current picture to be decoded has been decoded, and the occupancy information of each node in the k-th prediction reference picture has also been decoded. In this way, the decoding side may search for the matching node of the i-th parent node in the k-th prediction reference picture based on the occupancy information of the i-th parent node.

For example, a node whose occupancy information in the k-th prediction reference picture has the smallest difference from the occupancy information of the i-th parent node is determined as a matching node of the i-th parent node in the k-th prediction reference picture.

For example, assuming that the occupancy information of the i-th parent node is 11001101, the node whose occupancy information has the smallest difference from the occupancy information 11001101 is searched in the k-th prediction reference picture. For example, the decoding side performs an XOR operation on the occupancy information of the i-th parent node and the occupancy information of each node in the k-th prediction reference picture, and determines the node having the smallest XOR operation result in the k-th prediction reference picture as the matching node of the i-th parent node in the k-th prediction reference picture.

For example, assuming that the occupancy information of node 1 in the k-th prediction reference picture is 10001101, XOR operation is performed on 11001101 and 10001101. The first bit of 11001101 and the first bit of 10001101 are both 1, so the XOR result of the first bit of the two is 0; the second bit of 11001101 is different from the second bit of 10001111, so the XOR result of the second bit of the two is 1; and so on, the XOR result of 11001101 and 10001111 is 0+1+0+0+0+0+1+0=2. In this way, the decoding side may determine the XOR operation result of the occupancy information of the i-th parent node and the occupancy information of each node in the k-th prediction reference picture, and then determine the node in the k-th prediction reference picture having the smallest XOR operation result of the occupancy information of the i-th parent node as the matching node of the i-th parent node in the k-th prediction reference picture.

Based on the above steps, the decoding side may determine the matching node of the i-th parent node in the k-th prediction reference picture. For the convenience of description, the matching node is denoted as the i-th matching node.

Next, the decoding side determines one of the child nodes of the i-th matching node as the corresponding node of the i-th neighborhood node in the k-th prediction reference picture.

For example, the decoding side determines a default child node among the child nodes included in the i-th matching node as the corresponding node of the i-th node in the k-th prediction reference picture. It is assumed that a first child node of the i-th matching node is determined as the corresponding node of the i-th node in the k-th prediction reference picture.

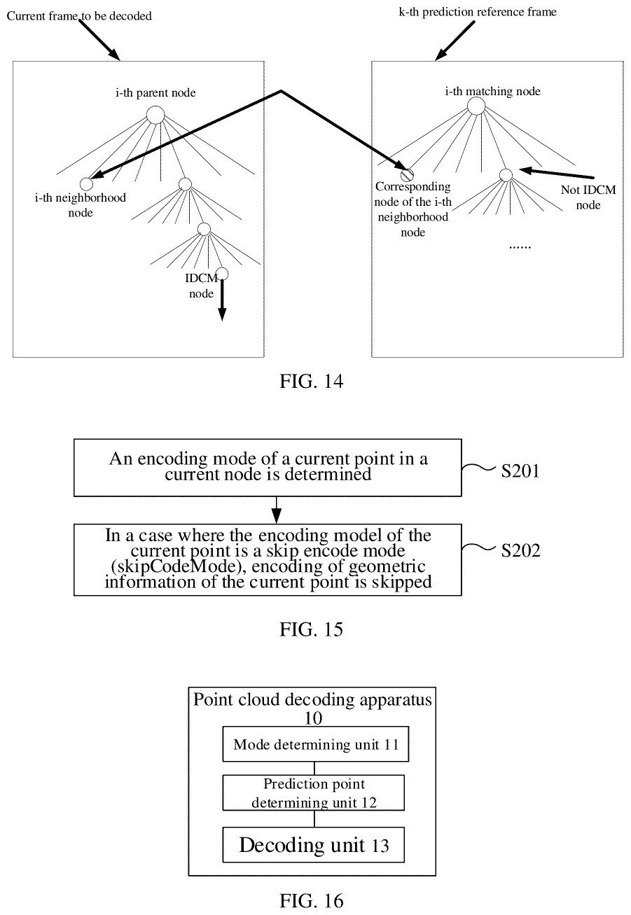

For another example, the decoding side determines a first sequence number of the i-th node among the child nodes included in the parent node; and determines a child node with the first sequence number among the child nodes of the i-th matching node as the corresponding node of the i-th node in the k-th prediction reference picture. For example, as shown in FIG. 14, the i-th node is the second child node of the i-th parent node, and the first sequence number is 2. In this case, the second child node of the i-th matching node may be determined as the corresponding node of the i-th node.

The process of determining the corresponding node of the i-th neighborhood node among the M neighborhood nodes in the k-th prediction reference picture and determining the corresponding node of the current node in the k-th prediction reference picture are introduced above. In this way, the decoding side may determine the N prediction nodes of the current node in the prediction reference picture by using the Manner two or Manner three.

After the decoding side determines, based on the above steps, the N prediction nodes of the current node in the prediction reference picture of the current picture to be decoded, the decoding side performs S101-A2.

In the embodiments of the present application, the method of determining whether the current node meets the start condition of the skipDecodeMode based on the number of points included in at least one prediction node among the N prediction nodes in the above S101-A2 includes at least the following Examples.

In Example 1, in a case where the start condition includes that the number of points included in the prediction node is greater than or equal to the first numerical value, S101-A2 includes the following steps.

In S101-A2-11, the number of points included in the N prediction nodes is obtained.

In S101-A2-12, in response to that the number of points included in at least one prediction node among the N prediction nodes is greater than or equal to the first numerical value, it is determined that the current node meets the start condition of the skipDecodeMode.

In the Example 1, since the prediction node is a decoded node, the number of points included in the prediction node may be obtained. In this way, the number of points included in each of the N prediction nodes is compared with the first numerical value, and at least one prediction node that includes points with a number greater than or equal to the first numerical value is selected. For example, the current node includes three prediction nodes, the first prediction node includes one point and no duplicate points exist, the second prediction node includes two points and both are duplicate points, and the third prediction node includes two non-duplicate points. Assuming that the first numerical value is 1, it may be determined that the number of points included in each of the three prediction nodes is greater than or equal to the first numerical value, and then it is determined that the current node meets the start condition of the skipDecodeMode. If the first numerical value is 2, it is determined that the number of points included in the second prediction node among the three prediction nodes and the number of points included in the third prediction node among the three prediction nodes are greater than or equal to the first numerical value, and then it is determined that the current node meets the start condition of the skipDecodeMode. If the first numerical value is 3, it is determined that the number of points included in each of the three prediction nodes is smaller than the first numerical value, and then it is determined that the current node does not meet the start condition of the skipDecodeMode.

In Example 2, in a case where the start condition includes that the number of points included in the prediction node is equal to the number of points included in the current node, S101-A2 includes the following steps.

In S101-A2-21, the number of points included in the current node and the number of points included in the N prediction nodes are obtained.

In S101-A2-22, in response to that the number of points included in the current node is equal to the number of points included in at least one prediction node among the N prediction nodes, it is determined that the current node meets the start condition of the skipDecodeMode.

In the Example 2, since the prediction node is a decoded node, the number of points included in the prediction node may be obtained. In addition, before decoding the geometric information of the current node, the number of points included in the current node has been decoded. In this way, the decoding side may compare the number of points included in each of the N prediction nodes with the number of points included in the current node. As long as the number of points included in one of the N prediction nodes is equal to the number of points included in the current node, it may be determined that the current node meets the start condition of the skipDecodeMode. Otherwise, it is determined that the current node does not meet the start condition of the skipDecodeMode.

In Example 3, in a case where the start condition includes that the number of points included in the prediction node is equal to the number of points included in the current node and the direct decoding mode of the prediction node is the same as the direct decoding mode of the current node, S101-A2 includes the following steps.

In S101-A2-31, the number of points included in the current node and the direct decoding mode of the current node, and the number of points included in the N prediction nodes and the direct decoding mode of the prediction nodes are obtained.

In S101-A2-32, in response to that the number of points included in the current node is equal to the number of points included in the at least one prediction node among the N prediction nodes and the direct decoding mode of the current node is the same as a direct decoding mode of the at least one prediction node, it is determined that the current node meets the start condition of the skipDecodeMode.

In the Example 3, since the prediction node is a decoded node, the number of points included in the prediction node and the direct decoding mode of the prediction node may be obtained. In addition, before decoding the geometric information of the current node, the number of points included in the current node and the direct decoding mode of the current node have been decoded. In this way, the decoding side may compare the number of points included in each of the N prediction nodes with the number of points included in the current node, and compare the direct decoding mode of each of the N prediction nodes with the direct decoding mode of the current node. As long as the number of points included in one prediction node of the N prediction nodes is equal to the number of points included in the current node and the direct decoding mode of that prediction node is also the same as the direct decoding mode of the current node, it may be determined that the current node meets the start condition of the skipDecodeMode. Otherwise, it is determined that the current node does not meet the start condition of the skipDecodeMode.

Based on the above steps, the decoding side may determine whether the current node meets the start condition of the skipDecodeMode. Next, the above S101-B is performed.

The manner of determining the decoding mode of the current point based on whether the current node meets the start condition of the skipDecodeMode in the above S101-B includes at least the following manners.

Manner one: in a case where the current node meets the start condition of the skipDecodeMode, it is determined that a decoding mode of geometric information for at least one component of the current point is the skipDecodeMode.

As can be seen from the above, for the non-lidar point cloud, the encoding side separately encodes geometric information for an X-coordinate component of the current point, geometric information for a Y-coordinate component of the current point and geometric information for a Z-coordinate component of the current point. For the laser radar point cloud, the encoding side encodes the geometric information for the X-coordinate component of the current point and the geometric information for the Y-coordinate component of the current point, and encodes a laser ray index (Laserlex) corresponding to the current point and a geometric residual of the Z-coordinate of the current point.

It can be seen that if the current point is a point in the non-lidar point cloud, the at least one component of the current point includes at least one of: the X-coordinate component, the Y-coordinate component, or the Z-coordinate component.

If the current point is a point in the laser radar point cloud, the at least one component of the current point includes at least one of: the X-coordinate component, the Y-coordinate component, the laser ray index, or the geometric residual of the Z-coordinate.

As can be seen from the above, in the embodiments of the present application, in a case where the current node meets the start condition of the skipDecodeMode, the prediction node of the current node includes at least one point. Therefore, for the current point in the current node, at least one prediction point may be found in the prediction node. Furthermore, the geometric information for the at least one component of the current point may be determined based on the prediction point, and then it may be determined that the decoding mode of the geometric information for the at least one component of the current point may be the skipDecodeMode.

For example, in a case where the current node meets the start condition of the skipDecodeMode, it is determined that the decoding modes of all components of the current point are the skipDecodeMode. For example, if the current point is a point in the non-lidar point cloud, it is determined that the geometric information for the X-coordinate component of the current point, the geometric information for the Y-coordinate component of the current point, and the geometric information for the Z-coordinate component of the current point all use the skipDecodeMode. For another example, if the current point is a point in the laser radar point cloud, it is determined that the X-coordinate component, the Y-coordinate component, the laser ray index, and the geometric residual of the Z-coordinate of the current point all use the skipDecodeMode.

For example, in a case where the current node meets the start condition of the skipDecodeMode, it is determined that a decoding mode of geometric information of some components of the current point is the skipDecodeMode. For example, if the current point is a point in the non-lidar point cloud, it is determined that the decoding mode of the geometric information for the Z-coordinate component of the current point is the skipDecodeMode, or the decoding mode of the geometric information for the X-coordinate component of the current point is the skipDecodeMode, or the decoding mode of the geometric information for the Y-coordinate component of the current point is the skipDecodeMode. For another example, if the current point is a point in the lidar point cloud, it is determined that the decoding mode of the geometric information for the X-coordinate component of the current point is the skipDecodeMode, or the decoding mode of the geometric information for the Y-coordinate component of the current point is the skipDecodeMode, or the decoding mode of the laser ray index of the current point is the skipDecodeMode, or the decoding mode of the geometric residual of the Z-coordinate of the current point is the skipDecodeMode.

Manner two: in a case where the current node meets the start condition of the skipDecodeMode, the above S101-B includes the following steps.

In S101-B1, a bitstream is decoded to obtain a first flag. The first flag is used to indicate whether the current point uses the skipDecodeMode, and the first flag is determined based on an error between the geometric information of the current point and the geometric information of the at least one prediction point.

In S101-B2, the decoding mode of the current point is determined based on the first flag.

In the Manner two, the encoding side determines the decoding mode of the current point in the current node, and indicates the decoding mode to the decoding side via the first flag. Correspondingly, in a case where the decoding side determines that the current node meets the start condition of the skipDecodeMode based on the above manner, the decoding side decodes the bitstream to obtain the first flag and then determines the decoding mode of the current point based on the first flag.

For example, in response to that a value of the first flag is a first value, it is determined that the decoding mode of the current point is the skipDecodeMode.

For another example, in response to that the value of the first flag is a second value, it is determined that the decoding mode of the current point is not the skipDecodeMode.

The specific values of the first value and the second value are not limited in the embodiments of the present application.

Optionally, the first value is 1, and the second value is 0.

In some embodiments, the encoding side determines whether the current point uses the skipCodeMode in such a way that: the encoding side first determines a second numerical value, determines the error between the geometric information of the current point and the geometric information of the prediction point, compares the error with the second numerical value, and determines that the current point is encoded using the skipCodeMode in response to that the error is less than or equal to the second numerical value, then sets the first flag to the first value (e.g., 1), and then encodes the first flag into the bitstream.

The specific manner of determining the second numerical value is not limited in the embodiments of the present application.

In some embodiments, the second numerical value is a preset value, such as 0.

In some embodiments, the second numerical value is a number of bits required by the encoding side to encode the geometric information of the current point.

The process of the decoding side determining the decoding mode of the current point is described above.

After the decoding side determines the decoding mode of the current point based on the above method, the decoding side performs the following step S102.

In S102, in a case where the decoding mode of the current point is the skipDecodeMode, at least one prediction point of the current point is determined among points included in the N prediction nodes of the current node.

As can be seen from the above, one manner to determine the decoding mode of the current point is that the decoding side directly decodes the bitstream to obtain the decoding mode of the current point without determining whether the current node meets the start condition of the skipDecodeMode. In this case, before the decoding side determines the at least one prediction point of the current point among the points included in the N prediction nodes of the current node, the decoding side needs to first determine the N prediction nodes of the current node in the prediction reference picture of the current picture to be decoded. As for the process of determining the N prediction nodes of the current node in the prediction reference picture of the current picture to be decoded, reference is made to the relevant description of the above S101-A1, which will not be repeated here.

Next, the decoding side determines the at least one prediction point of the current point among the points included in the N prediction nodes of the current node.

The specific manner in which the decoding side determines the at least one prediction point of the current point among the points included in the N prediction nodes of the current node is not limited in the embodiments of the present application.

In some embodiments, the decoding side selects a prediction point corresponding to the current point from points included in each prediction node of the N prediction nodes.

In some embodiments, the above S102 includes the following steps.

In S102-A, the at least one prediction node is selected from the N prediction nodes based on the start condition of the skipDecodeMode, where M is a positive integer less than or equal to N.

In S102-B, the at least one prediction point of the current point is determined based on the points included in the at least one prediction node.

In this embodiment, in order to further improve the decoding accuracy of the skipDecodeMode, points included in the prediction node that is most relevant to characteristics of the current node are selected to determine the prediction point of the current point, so as to improve the selection accuracy of the prediction point and further improve the geometric decoding effect of the current point.

In this embodiment, the N prediction nodes of the current node may be screened to select a prediction node with a strong correlation with the current node based on the start condition of the skipDecodeMode.

In some embodiments, the screening manner of the N prediction nodes varies based on different start conditions of the skipDecodeMode.

In an example, the start condition of the skipDecodeMode is that the number of points included in the prediction nodes is greater than or equal to the first numerical value. In this case, the decoding side selects, from the N prediction nodes, at least one prediction node that includes points with a number greater than or equal to the first numerical value.

In another example, the start condition of the skipDecodeMode is that the number of points included in the prediction nodes is equal to the number of points included in the current node. In this case, the decoding side selects, from the N prediction nodes, at least one prediction node that includes points with a number equal to the number of points included in the current node.

In another example, the start condition of the skipDecodeMode is that the number of points included in the prediction nodes is equal to the number of points included in the current node, and the direct decoding mode of the prediction nodes is the same as the direct decoding mode of the current node. In this case, the decoding side selects, from the N prediction nodes, at least one prediction node that includes points with a number equal to the number of points included in the current node and has a direct decoding mode same as the direct decoding mode of the current node.

Based on the above method, after the decoding side selects the at least one prediction node from the N prediction nodes, the above S102-B is performed to determine at least one prediction point of the current point based on the points included in the at least one prediction node.

In the embodiments of the present application, the manner of determining the prediction point of the current point from the at least one prediction node is the same. For convenience of description, determining the prediction point of the current point from one prediction node is taken as an example for explanation.

In some embodiments, for each prediction node of the at least one prediction node, if the current node includes one point and the prediction node includes two non-duplicate points, all non-duplicate points in the prediction node are used as prediction points of the current point. For example, in a case where the prediction node includes two non-duplicate points, the two non-duplicate points are determined as two prediction points of the current point.

In some embodiments, for each prediction node of the at least one prediction node, if the prediction node includes one point, the point included in the prediction node is determined as one prediction point of the current point.

In some embodiments, for each prediction node of the at least one prediction node, in response to that the prediction node includes multiple non-duplicate points, a point in the prediction node that has a same ranking as the current point in the current node is determined as a prediction point of the current point. For example, the prediction node includes point 1 and point 2, and point 1 and point 2 are non-duplicate points. It is assumed that the current node also includes two non-duplicate points. In this case, if the current point is the first point in the current node, point 1 in the prediction node is determined as the prediction point of the current point. If the current point is the second point in the current node, point 2 in the prediction node is determined as the prediction point of the current point.

Based on the above steps, the decoding side may determine at least one prediction point of the current point from the points included in the above at least one prediction node. Then, the following step S103 is performed.

In S103, the geometric information of the current point is determined based on geometric information of the at least one prediction point.

In the embodiments of the present application, if it is determined that the current point is decoded using the skipDecodeMode, at least one prediction point of the current point is determined from the N prediction nodes of the current node, and then the geometric information of the current point is directly determined based on the geometric information of the at least one prediction point, without the need to decode the geometric information of the current point from the bitstream, thereby improving the efficiency of the geometric decoding of the point cloud.

In some embodiments, if the at least one prediction point includes one prediction point, the decoding side may directly determine the geometric information of the prediction point as the geometric information of the current point.

In some embodiments, if the at least one prediction point includes multiple prediction points, the above S103 includes the following steps.

In S103-A, first geometric information is obtained based on the geometric information of the at least one prediction point.

In S103-B, geometric information for at least one component of the current point is determined based on the first geometric information.

In the embodiments of the present application, if the current point includes multiple prediction points, a piece of geometric information may be first determined based on the geometric information of these prediction points, denoted as the first geometric information; then, the geometric information for at least one component of the current point may be determined based on the first geometric information.

The specific manner of obtaining the first geometric information based on the geometric information of the at least one prediction point is not limited in the embodiments of the present application.

In a possible implementation, an average of the geometric information of the at least one prediction point is used as the first geometric information. For example, an average of the geometric information of the at least one prediction point on the X axis is used as geometric information for the X axis in the first geometric information, an average of the geometric information of the at least one prediction point on the Y axis is used as geometric information for the Y axis in the first geometric information, and an average of the geometric information of the at least one prediction point on the Z axis is used as geometric information for the Z axis in the first geometric information.

In another possible implementation, a weighted average of the geometric information of the at least one prediction point is used as the first geometric information. For example, a weighted average of the geometric information of the at least one prediction point on the X axis is used as geometric information for the X axis in the first geometric information, a weighted average of the geometric information of the at least one prediction point on the Y axis is used as geometric information for the Y axis in the first geometric information, and a weighted average of the geometric information of the at least one prediction point on the Z axis is used as geometric information for the Z axis in the first geometric information.

The weights in a case of weighting the above prediction points are not limited in the embodiments of the present application.

In some embodiments, the weight of the prediction node where the prediction point is located may be determined, and the weight of the prediction node may be determined as the weight of the prediction point.

The manner of determining the weight of the prediction node will be introduced below.

In some embodiments, the weight corresponding to the above prediction node is a preset value. As can be seen from the above, in some embodiments, the above N prediction nodes are determined based on M neighborhood nodes of the current node. Assuming that prediction node 1 is a prediction node corresponding to neighborhood node 1, if neighborhood node 1 is a coplanar node of the current node, a weight of prediction node 1 is a preset weight 1; if neighborhood node 1 is a co-edge node of the current node, a weight of prediction node 1 is a preset weight 2; and if neighborhood node 1 is a copointed node of the current node, a weight of prediction node 1 is a preset weight 3.

In some embodiments, the weight corresponding to the prediction node is determined based on a distance between the neighborhood node corresponding to the prediction node and the current node. For example, the smaller the distance between the neighborhood node and the current node, the stronger the inter correlation between the prediction node corresponding to the neighborhood node and the current node, and thus the greater the weight of the prediction node.

For example, considering prediction node 1 as an example, assuming that prediction node 1 is the corresponding point of neighborhood node 1 in the prediction reference picture among the M neighborhood nodes of the current node, the weight of prediction node 1 may be determined based on the distance between neighborhood node 1 and the current node. For example, a reciprocal of the distance between neighborhood node 1 and the current node is determined as the weight of prediction node 1.

In an example, if neighborhood node 1 is a coplanar node of the current node, the weight of prediction node 1 is 1; if neighborhood node 1 is a co-edge node of the current node, the weight of prediction node 1 is a preset weight 1/\sqrt{2}; if neighborhood node 1 is a copointed node of the current node, the weight of prediction node 1 is a preset weight 1/\sqrt{3}.

In an example, if neighborhood node 1 is a coplanar node of the current node, the weight of prediction node 1 is \sqrt{6}; if neighborhood node 1 is a co-edge node of the current node, the weight of prediction node 1 is \sqrt{3}; and if neighborhood node 1 is a copointed node of the current node, the weight of prediction node 1 is \sqrt{2}.

Based on the above steps, after the weight of the prediction node where the prediction point is located is determined, the weight of the prediction node is determined as the weight of the prediction point; then, based on the weight of the at least one prediction point, a weighted average operation is performed on the geometric information of the at least one prediction point to obtain the first geometric information.

After the first geometric information is obtained based on the above steps, the geometric information for the at least one component of the current point is determined based on the first geometric information.

In some embodiments, if the current point is in a non-lidar point cloud, and the geometric information for the X-coordinate component of the current point, the geometric information for the Y-coordinate component of the current point and the geometric information for the Z-coordinate component of the current point all use the skipDecodeMode, or if the current point is in a lidar point cloud, and the geometric information for the X-coordinate component of the current point and the geometric information for the Y-coordinate component of the current point, the laser ray index of the current point and the geometric residual of the Z-coordinate of the current point all use the skipDecodeMode, then the first geometric information is directly determined as the geometric information of the current point. For example, the geometric information for the X axis in the first geometric information is determined as X axis geometric information of the current point, the geometric information for the Y axis in the first geometric information is determined as Y axis geometric information of the current point, and the geometric information for the Z axis in the first geometric information is determined as Z axis geometric information of the current point.

In some embodiments, geometric information for some components of the current point is decoded using the skipDecodeMode, and geometric information for some components of the current point is not decoded using the skipDecodeMode. In this case, the above S103-B includes the following steps.

In S103-B1, geometric information of the first geometric information for an i-th component is determined as geometric information of the current point for the i-th component.

In S103-B2, a decoding mode used for geometric information of the current point for a j-th component is determined, and the geometric information of the current point for the j-th component is decoded based on the decoding mode.

In a case where the point cloud is the non-lidar point cloud, the i-th component is the X-coordinate component, the Y-coordinate component or the Z-coordinate component, and the j-th component is the X-coordinate component, the Y-coordinate component or the Z-coordinate component; and in a case where the point cloud is the lidar point cloud, the i-th component is the X-coordinate component, the Y-coordinate component, the laser ray index or the geometric residual of the Z-coordinate, and the j-th component is the X-coordinate component, the Y-coordinate component, the laser ray index or the geometric residual of the Z-coordinate, where the i-th component is different from the j-th component.

In this embodiment, the geometric information for the i-th component of the current point is decoded using the skipDecodeMode, and therefore, the geometric information for the i-th component in the first geometric information determined above is determined as the geometric information of the current point for the i-th component.

For example, in response to that the point cloud is the non-lidar point cloud, the geometric information for the X-coordinate component, Y-coordinate component or Z-coordinate component of the first geometric information is determined as the geometric information for the X-coordinate component, Y-coordinate component or Z-coordinate component of the current point.

For another example, in response to that the point cloud is the laser radar point cloud, the X-coordinate component, Y-coordinate component, laser ray index or geometric residual of the Z-coordinate of the first geometric information is determined as the X-coordinate component, Y-coordinate component, laser ray index or geometric residual of the Z-coordinate of the current point.

If the geometric information for the j-th component of the current point is not decoded using the skipDecodeMode, the decoding side further needs to determine the decoding mode used for the geometric information of the current point for the j-th component. For example, the default decoding mode is determined as the decoding mode used for the geometric information of the current point for the j-th component (e.g., a direct decoding mode), or the bitstream is decoded to obtain the decoding mode used for the geometric information of the current point for the j-th component. Next, the geometric information of the current point for the j-th component is decoded using the decoding mode to obtain the geometric information of the current point for the j-th component.

Through the above decoding process, the decoding side can obtain the geometric information of each point in the current node, so that the decoding of the geometric information of the point cloud is implemented.

Furthermore, the skipDecodeMode provided in the embodiments of the present application is applied to different point cloud pictures, and the obtained effects are shown in Table 3.

TABLE 3

| Point cloud | | Solutions in the present | | |
|---|---|---|---|---|
| picture_Index | TMC13-v20.0 | application | Inter/Intra | BPP |
| 1 | 118522B | 109659B | Inter | −7.48% |
| 2 | 115232B | 105038B | Intra | −8.85% |
| 3 | 116823B | 107454B | Intra | −8.02% |
| 4 | 118248B | 109652B | Inter | −7.27% |
| 5 | 116443B | 107657B | Inter | −7.55% |
| 6 | 113335B | 103450B | Intra | −8.72% |
| 7 | 118381B | 109824B | Intra | −7.23% |

In Table 3, TMC13-v20.0 is the point cloud compression software. It can be seen from Table 3 that the skipDecodeMode proposed in the embodiments of the present application may significantly improve the geometric decoding performance of the point cloud.

The process in which the decoding side decodes the geometric information of the current point in the current node by using the skipDecodeMode is introduced in above embodiments.

It should be noted that the skipDecodeMode proposed in the embodiments of the present application can be applied not only to the decoding process of geometric information, but also to the decoding process of other information.

For example, in some embodiments, the skipDecodeMode proposed in the embodiments of the present application is applied to the decoding of occupancy information of geometric information. For example, in a case of decoding a current node, a prediction node of the current node is determined in a prediction reference picture of a current picture to be decoded, and then occupancy information of the current node is determined based on occupancy information of the prediction node.

For another example, in some embodiments, the skipDecodeMode proposed in the embodiments of the present application is applied to the decoding of node flags and node position information of trisoup. For example, in a case of decoding a current sub-block, a prediction sub-block of the current sub-block is determined in a prediction reference picture of a current picture to be decoded, and then occupancy information of the current sub-block is determined based on occupancy information of the prediction sub-block.

For yet another example, in some embodiments, the skipDecodeMode proposed in the embodiments of the present application is applied to decoding of residual in a prediction tree. For example, in a case of decoding a current node, a prediction node of the current node is determined in a prediction reference picture of a current picture to be decoded, and then residual information of the current node is determined based on residual information of the prediction node.

For yet another example, in some embodiments, the skipDecodeMode proposed in the embodiments of the present application is applied to decoding of attribute residual of the point cloud. For example, in a case of decoding a current node, a prediction node of the current node is determined in a prediction reference picture of a current picture to be decoded, and then attribute residual information of the current node is determined based on attribute residual information of the prediction node.

In the point cloud decoding method provided in the embodiments of the present application, in a case of decoding the geometric information of the current node, the decoding mode of the current point in the current node is first determined; if the decoding mode of the current point is the skipDecodeMode, then the at least one prediction point of the current point is determined among the points included in the N prediction nodes of the current node, where the prediction node is the node corresponding to the current node in the prediction reference picture of the current picture to be decoded, and the skipDecodeMode is a mode for skipping decoding of the geometric information of the current point; then, the geometric information of the current point is determined based on the geometric information of the at least one prediction point. It can be seen that in the embodiments of the present application, in a case of performing geometric decoding on the current node, the time domain correlation between neighboring pictures is considered, thereby improving the decoding efficiency of the geometric information of the point cloud. Furthermore, a new decoding mode, i.e., the skipDecodeMode, is introduced in the IDCM geometric decoding process in the embodiments of the present application, that is, the geometric information of the current point is directly determined based on the geometric information of the prediction point, thereby further improving the decoding efficiency.

The above description introduces the point cloud decoding method provided in the embodiments of the present application in detail by taking the decoding side as an example. The following description will introduce the point cloud encoding method provided in the embodiments of the present application by taking the encoding side as an example.

FIG. 15 is a schematic flowchart of the point cloud encoding method provided in the embodiments of the present application. The point cloud encoding method of the embodiments of the present application may be implemented by the point cloud encoding device shown in FIG. 3 or FIG. 4A or FIG. 8A as mentioned above.

As shown in FIG. 15, the point cloud encoding method of the embodiments of the present application includes the following steps.

In S201, an encoding mode of a current point in a current node is determined.

The current node is a node to be encoded in a current picture to be encoded.

As can be seen from the above, a point cloud includes geometric information and attribute information, and encoding of the point cloud includes geometric encoding and attribute encoding. The embodiments of the present application relate to the geometric encoding of the point cloud.

In some embodiments, the geometric information of the point cloud is also referred to as position information of the point cloud. Therefore, the geometric encoding of the point cloud is also referred to as position encoding of the point cloud.

In an octree-based encoding manner, the encoding side constructs an octree structure of the point cloud based on the geometric information of the point cloud. As shown in FIG. 11, the point cloud is enclosed by a smallest rectangular block, and octree partitioning is performed on the bounding box first to obtain 8 nodes. The octree partitioning is continued for occupied nodes in these 8 nodes, i.e., the nodes including points, and so on, until the partitioning reaches a voxel level position, for example, until there exist cubes of 1×1×1. An octree structure of the point cloud obtained by such partitioning manner includes multiple layers of nodes, such as N layers. Occupancy information of each layer is encoded layer by layer in encoding until leaf nodes at the voxel level in the last layer are encoded. That is to say, in the octree encoding, the points in the point cloud are finally partitioned into the leaf nodes at the voxel level in the octree through partitioning the point cloud by the octree, so the encoding of the point cloud may be implemented by encoding the entire octree.

However, the octree-based geometric information encoding mode has an efficient compression rate for correlated points in space, and for points in isolated positions in the geometric space, the use of direct encoding model may greatly reduce the complexity and improve the coding efficiency.

Since the direct encoding model is to directly encode the geometric information of the points included in the node, if the number of points included in the node is large, the compression effect is poor in a case where the direct encoding model is used. Therefore, for a node in the octree, before the direct encoding, it is first determined whether the node can be directly encoded. If it is determined that the node can be encoded using the direct encoding model, the geometric information of the points included in the node is directly encoded using the direct encoding model. If it is determined that the node cannot be encoded using the direct encoding model, the node is further partitioned using the octree method.

In some embodiments, the encoding side first determines whether the node is qualified for direct encoding. If the node is qualified for direct encoding, the encoding side determines whether the number of points of the node is less than or equal to a preset threshold. In response to that the number of points of the node is less than or equal to the preset threshold, the encoding side determines that the node can be encoded using the direct encoding model. Next, the encoding side encodes the number of points included in the node and the geometric information of each point into a bitstream.

Currently, in a case of encoding the geometric information of a current node, a correlation between neighboring pictures is not considered, resulting in poor geometric prediction encoding performance. In the embodiments of the present application, in a case of encoding geometric information of a current node, a prediction node of the current node is determined in a prediction reference picture of a current picture to be encoded, and then predictive encoding is performed on the geometric information of the current node based on geometric information of the prediction node. The inter correlation is taken into account, thereby improving the geometric encoding performance.

In the embodiments of the present application, in order to further improve the encoding efficiency of the geometric information of the point cloud, a skip encode mode (skipCodeMode) is proposed. In the skipCodeMode, the skipCodeMode is a mode for skipping encoding of geometric information of the current point, and the geometric information of the current point is determined based on the geometric information of the prediction point of the current point (i.e., geometric reconstructed information). For example, the geometric information of the prediction point is directly determined as the geometric information of the current point. In this way, the encoding efficiency of the point cloud may be greatly improved.

It should be noted that the current picture to be encoded is a point cloud picture. In some embodiments, the current picture to be encoded is also referred to as a current picture or a current point cloud picture or a current point cloud picture to be encoded. The current node may be understood as any non-empty node that is not a leaf node in the current picture to be encoded. That is, the current node is not a leaf node in the octree corresponding to the current picture to be encoded. That is, the current node is an arbitrary node of the octree, and the current node is not a non-empty node, that is, the current node includes at least one point.

The skipCodeMode proposed in the embodiments of the present application is based on the direct encoding model. That is, before encoding the current point in the current node using the skipCodeMode, whether the current node is a true IDCM node, i.e., whether the current node is encoded using a direct encoding model, needs to be first determined. In a case where it is determined that the current node is encoded using the direct encoding model, it is determined whether the current point in the current node is encoded using the skipCodeMode.

The specific method of determining the encoding mode of the current point is not limited in the embodiments of the present application.

In some embodiments, if the current node is an IDCM node, the encoding side uses the skipCodeMode by default to encode the geometric information of the current point in the current node, that is, to perform skip encoding on the geometric information of the current point.

In some embodiments, the encoding side selects, by using a rate-distortion optimization algorithm, an encoding method from multiple preset encoding methods to encode the current point. It should be noted that the multiple preset encoding methods include the skipCodeMode. Next, the encoding side encodes the index or indication information of the selected encoding method into the bitstream. Correspondingly, the encoding side encodes the bitstream to obtain the encoding mode of the current point.

In some embodiments, the above S201 includes the following steps S201-A and S201-B.

In S201-A, whether the current node meets a start condition of the skipCodeMode is determined.

In S201-B, the encoding mode of the current point is determined based on whether the current node meets the start condition of the skipCodeMode.

That is, in this embodiment, the encoding side determines whether the current point in the current node is encoded using the skipCodeMode by determining whether the current node meets the start condition of the skipCodeMode.

The process of the encoding side determining whether the current node meets the start condition of the skipCodeMode will be introduced below.

The specific manner in which the the encoding side determines whether the current node meets the start condition of the skipCodeMode is not limited in the embodiments of the present application.

In some embodiments, if the current node is a true IDCM node, it is determined that the current node meets the start condition of the skipCodeMode. If the current node is not a true IDCM node, it is determined that the current node does not meet the start condition of the skipCodeMode.

In some embodiments, the encoding side determines whether the current node meets the start condition of the skipCodeMode based on a preset start condition of the skipCodeMode. For example, if the current node meets the start condition of the skipCodeMode, skipCodeEligible is set to true; if the current node does not meet the start condition of the skipCodeMode, skipCodeEligible is set to false. In this case, the above S201-A includes the following steps S201-A1 and S201-A2.

In S201-A1, N prediction nodes of the current node are determined in prediction reference pictures of the current picture to be encoded.

In S201-A2, whether the current node meets the start condition of the skipCodeMode is determined based on the number of points included in at least one prediction node among the N prediction nodes.

The specific content of the start condition of the skipCodeMode is not limited in the embodiments of the present application.

In an example, the start condition of the skipCodeMode includes: the number of points included in the prediction nodes being greater than or equal to a first numerical value. Optionally, the first numerical value is a positive integer.

In another example, the start condition of the skipCodeMode includes: the number of points included in the prediction nodes being equal to the number of points included in the current node.

In yet another example, the start condition of the skipCodeMode includes: the number of points included in the prediction nodes being equal to the number of points included in the current node, and a direct encoding model of the prediction nodes being the same as a direct encoding model of the current node.

The process of determining the N prediction nodes of the current node in the prediction reference pictures of the current picture to be encoded will be introduced below.

It should be noted that the number of prediction reference pictures of the current picture to be encoded is not limited in the embodiments of the present application. For example, the current picture to be encoded has one prediction reference picture, or the current picture to be encoded has multiple prediction reference pictures. Moreover, the number N of prediction nodes of the current node is not limited in the embodiments of the present application, which is determined according to actual needs.

The specific method of determining the prediction reference picture of the current picture to be encoded is not limited in the embodiments of the present application.

In some embodiments, one or several encoded pictures before the current picture to be encoded are determined as prediction reference pictures of the current picture to be encoded.

For example, if the current picture to be encoded is a P frame, inter reference pictures of the P frame includes a previous picture (i.e., a forward picture) of the P frame. Therefore, the previous picture (i.e., the forward picture) of the current picture to be encoded may be determined as a prediction reference picture of the current picture to be encoded.

For another example, if the current picture to be encoded is a B frame, inter reference pictures of the B frame includes a previous picture (i.e., a forward picture) of the B frame and a next picture (i.e., a backward picture) of the B frame. Therefore, the previous picture (i.e., the forward picture) of the current picture to be encoded may be determined as a prediction reference picture of the current picture to be encoded.

In some embodiments, one or several encoded pictures after the current picture to be encoded are determined as prediction reference pictures of the current picture to be encoded.

For example, if the current picture to be encoded is a B frame, a picture after the current picture to be encoded may be determined as a prediction reference picture of the current picture to be encoded.

In some embodiments, one or several encoded pictures before the current picture to be encoded and one or several encoded pictures after the current picture to be encoded are determined as prediction reference pictures of the current picture to be encoded.

For example, if the current picture to be encoded is a B frame, a previous picture and a next picture of the current picture to be encoded may be determined as prediction reference pictures of the current picture to be encoded. In this case, the current picture to be encoded has two prediction reference pictures.

As shown in FIG. 11, in the embodiments of the present application, the encoding side determines the prediction node of the current node in the prediction reference pictures of the current picture to be encoded, and then compares the number of points and/or IDCM mode included in the prediction node with the number of points and/or IDCM mode included in the current node to determine whether the current node meets the start condition of the skipCodeMode.

Considering an example in which the current picture to be encoded includes K prediction reference pictures, the process of determining the N prediction nodes of the current node in the prediction reference pictures of the current picture to be encoded in the S201-A1 will be introduced below.

In some embodiments, the encoding side selects at least one prediction reference picture from the K prediction reference pictures based on occupancy information of the nodes in the current picture to be encoded and occupancy information of the nodes in each of the K prediction reference pictures, and then searches for the prediction node of the current node in the at least one prediction reference picture. For example, at least one prediction reference picture whose node occupancy information is closest to the occupancy information of the node of the current picture to be encoded is selected from the K prediction reference pictures, and then the prediction node of the current node is searched in the at least one prediction reference picture.

In some embodiments, the encoding side may determine the N prediction nodes of the current node through the following steps S201-A11 and S201-A12.

In S201-A11, for a k-th prediction reference picture among the K prediction reference pictures, at least one prediction node of the current node in the k-th prediction reference picture is determined, where k is a positive integer less than or equal to K, and K is a positive integer.

In S201-A12, the N prediction nodes of the current node are determined based on the at least one prediction node of the current node in the K prediction reference pictures.

In this embodiment, the encoding side determines at least one prediction node of the current node from each of the K prediction reference pictures, and then summarizes the at least one prediction node in each of the K prediction reference pictures to obtain the N prediction nodes of the current node.

The process of the encoding side determining at least one prediction point of the current node in each of the K prediction reference pictures is the same. For convenience of description, the k-th prediction reference picture among the K prediction reference pictures is taken as an example for explanation.

The process of determining the at least one prediction node of the current node in the k-th prediction reference picture in the S201-A11 will be introduced below.

The specific manner in which the encoding side determines the at least one prediction node of the current node in the k-th prediction reference picture is not limited in the embodiments of the present application.

Manner one: in the k-th prediction reference picture, a prediction node of the current node is determined. For example, a node in the k-th prediction reference picture having the same partition depth as the current node is determined as the prediction node of the current node.

For example, assuming that the current node is located at the third layer of the octree of the current picture to be encoded, the nodes located at the third layer of the octree in the k-th prediction reference picture may be obtained, and then the prediction node of the current node may be determined from these nodes.

In an example, if the number of prediction nodes of the current node in the k-th prediction reference picture is 1, then among the points in the k-th prediction reference picture having the same partition depth as the current node, a node whose occupancy information has the smallest difference from the occupancy information of the current node may be selected, recorded as node 1, and node 1 is determined as a prediction node of the current node in the k-th prediction reference picture.

In another example, if the number of prediction nodes of the current node in the k-th prediction reference picture is greater than 1, the node 1 determined above and at least one neighborhood node of node 1 in the k-th prediction reference picture, such as at least one neighborhood node that is coplanar, co-edge, or copointed with node 1, is determined as the prediction node of the current node in the k-th prediction reference picture.

Manner two: in the S201-A11, determining the at least one prediction node of the current node in the k-th prediction reference picture includes the following steps S201-A11-a1 to S201-A113.

In S201-A11-a1, M neighborhood nodes of the current node are determined in the current picture to be encoded, where the M neighborhood nodes include the current node, and M is a positive integer.

In S201-A11-a2, for an i-th neighborhood node among the M neighborhood nodes, a corresponding node of the i-th neighborhood node in the k-th prediction reference picture is determined, where i is a positive integer less than or equal to M.

In S201-A11-a3, the at least one prediction node of the current node in the k-th prediction reference picture is determined based on corresponding nodes of the M neighborhood nodes in the k-th prediction reference picture.

In this implementation, before determining at least one prediction node of the current node in the k-th prediction reference picture, the encoding side first determines M neighborhood nodes of the current node in the current picture to be encoded, and the M neighborhood nodes include the current node.

It should be noted that the specific method of determining the M neighborhood nodes of the current node is not limited in the embodiments of the present application.

In an example, the M neighborhood nodes of the current node include at least one neighborhood node among the neighborhood nodes that are coplanar, co-edge, and copointed with the current node in the current picture to be encoded. As shown in FIG. 12, the current nodes include 6 coplanar nodes, 12 co-edge nodes, and 8 copointed nodes.

In another example, in addition to the at least one neighborhood node in the current picture to be encoded that is coplanar, co-edge, and copointed with the current node, the M neighborhood nodes of the current node may further include other nodes within a range of reference neighborhood, which is not limited in the embodiments of the present application.

Based on the above steps, the encoding side determines the M neighborhood nodes of the current node in the current picture to be encoded, and then determines the corresponding node of each of the M neighborhood nodes in the k-th prediction reference picture, and then determines at least one prediction node of the current node in the k-th prediction reference picture based on the corresponding nodes of the M neighborhood nodes in the k-th prediction reference picture.

The implementation of S201-A11-a3 is not limited in the embodiments of the present application.

In a possible implementation, at least one corresponding node is selected from the corresponding nodes of the M neighborhood nodes in the k-th prediction reference picture as at least one prediction node of the current node in the k-th prediction reference picture. For example, from the corresponding nodes of the M neighborhood nodes in the k-th prediction reference picture, at least one corresponding node whose occupancy information has the smallest difference from the occupancy information of the current node is selected as at least one prediction node of the current node in the k-th prediction reference picture. As for the method of determining the difference between the occupancy information of the corresponding node and the occupancy information of the current node, reference can be made to the above process of determining the difference of the occupancy information. For example, an XOR operation is performed on the occupancy information of the corresponding node and the occupancy information of the current node, and the XOR operation result is used as the difference between the occupancy information of the corresponding node and the occupancy information of the current node.

In another possible implementation, the encoding side determines the corresponding nodes of the M neighborhood nodes in the k-th prediction reference picture as at least one prediction node of the current node in the k-th prediction reference picture. For example, the M neighborhood nodes each have a corresponding node in the k-th prediction reference picture, so that M corresponding nodes are obtained; and the M corresponding nodes are determined as the prediction nodes of the current node in the k-th prediction reference picture, and there are M prediction nodes in total.

The process of determining the at least one prediction node of the current node in the k-th prediction reference picture is introduced above. In this way, the encoding side may use the same method as above to determine at least one prediction node of the current node in each of the K prediction reference pictures.

For example, if the current picture to be encoded is a P frame, the K prediction reference pictures include a forward picture of the current picture to be encoded. In this case, based on the above steps, the encoding side may determine at least one prediction node of the current node in the forward picture. For example, as shown in FIG. 13A, it is assumed that the current node includes three neighborhood nodes, which are respectively denoted as node 11, node 12 (the current node) and node 13. The three neighborhood nodes respectively correspond to nodes in the forward picture, which are denoted as node 21, node 22 and node 23. Then, node 21, node 22 and node 23 are determined as the three prediction nodes of the current node in the forward picture; or one or two nodes are selected from node 21, node 22 and node 23 to be determined as one or two prediction nodes of the current node in the forward picture.

For another example, if the current picture to be encoded is a B frame, the K prediction reference pictures include a forward picture and a backward picture of the current picture to be encoded. In this case, based on the above steps, the encoding side may determine at least one prediction node of the current node in the forward picture and at least one prediction node of the current node in the backward picture. For example, as shown in FIG. 13B, it is assumed that the current node includes three neighborhood nodes, which are respectively denoted as node 11, node 12 and node 13. The three neighborhood nodes respectively correspond to nodes in the forward picture, which are denoted as node 21, node 22 and node 23. These three neighborhood nodes respectively correspond to nodes in the backward picture, which are denoted as node 41, node 42 and node 43. In this way, the encoding side may determine node 21, node 22 and node 23 as three prediction nodes of the current node in the forward picture, or may select one or two nodes from node 21, node 22 and node 23 to determine as one or two prediction nodes of the current node in the forward picture. Similarly, the encoding side may determine node 41, node 42 and node 43 as three prediction nodes of the current node in the backward picture, or may select one or two nodes from node 41, node 42 and node 43 as one or two prediction nodes of the current node in the backward picture.

After the encoding side determines the at least one prediction node of the current node in each of the K prediction reference pictures, the S201-A12 is performed, that is, N prediction nodes of the current node are determined based on at least one prediction node of the current node in the K prediction reference pictures.

In an example, the at least one prediction node of the current node in the K prediction reference pictures is determined as the N prediction nodes of the current node.

For example, K is equal to 2 (K=2), that is, the K prediction reference pictures include a first prediction reference picture and a second prediction reference picture. Assuming that the current node has 2 prediction nodes in the first prediction reference picture and the current node has 3 prediction nodes in the second prediction reference picture, it may be determined that the current node has 5 prediction nodes, and in this case N=5.

In another example, the N prediction nodes of the current node are selected from the at least one prediction node of the current node in the K prediction reference pictures.

With continued reference to the above example, it is assumed that K=2, that is, the K prediction reference pictures include a first prediction reference picture and a second prediction reference picture. Assuming that the current node has 2 prediction nodes in the first prediction reference picture and the current node has 3 prediction nodes in the second prediction reference picture, an IDCM node is selected from the 5 prediction nodes and is determined as a final prediction node of the current node.

In the Manner two, after determining the M neighborhood nodes of the current node in the current picture to be encoded, the encoding side determines a corresponding node of each of the M neighborhood nodes in the k-th prediction reference picture, and then determines at least one prediction point of the current node in the k-th prediction reference picture based on the corresponding node of each of the M neighborhood nodes.

Manner three: determining the at least one prediction node of the current node in the k-th prediction reference picture in the S201-A11 includes the following steps S201-A11-b1 to S201-A11-b3.

In S201-A11-b1, a corresponding node of the current node in the k-th prediction reference picture is determined.

In S201-A11-b2, at least one neighborhood node of the corresponding node is determined.

In S201-A11-b3, the at least one neighborhood node is determined as the at least one prediction node of the current node in the k-th prediction reference picture.

In the Manner three, for each of the K prediction reference pictures, the encoding side first determines the corresponding node of the current node in each prediction reference picture. For example, the encoding side determines a corresponding node 1 of the current node in a prediction reference picture 1, and determines a corresponding node 2 of the current node in a prediction reference picture 2. Next, the encoding side determines at least one neighborhood node of each corresponding node. For example, the encoding side determines at least one neighborhood node of the corresponding node 1 in the prediction reference picture 1, and determines at least one neighborhood node of the corresponding node 2 in the prediction reference picture 2. In this way, at least one neighborhood node of the corresponding node 1 in the prediction reference picture 1 may be determined as at least one prediction node of the current node in the prediction reference picture 1, and at least one neighborhood node of the corresponding node 2 in the prediction reference picture 2 may be determined as at least one prediction node of the current node in the prediction reference picture 2.

The process of determining the corresponding node of the i-th neighborhood node in the k-th prediction reference picture in S201-A11-b1 of the Manner three is basically the same as the process of determining the corresponding node of the current node in the k-th prediction reference picture in S201-A11-a1 of the Manner three. For convenience of description, the above i-th neighborhood node and the current node are denoted as i-th nodes. The process of determining the corresponding node of the i-th node in the k-th prediction reference picture will be introduced below.

The encoding side determines the corresponding node of the i-th node in the k-th prediction reference picture by using at least the following manners.

Manner 1: a node in the k-th prediction reference picture that has the same partition depth as the i-th node is determined as the corresponding node of the i-th node.

For example, assuming that the i-th node is located at the third layer of the octree of the current picture to be encoded, all nodes located at the third layer of the octree in the k-th prediction reference picture may be obtained, and then the corresponding node of the i-th node may be determined from these nodes. For example, among the nodes in the k-th prediction reference picture that have the same partition depth as the i-th node, a node whose occupancy information has the smallest difference from the occupancy information of the i-th node is selected and determined as the corresponding node of the i-th node in the k-th prediction reference picture.

Manner 2: the S201-A11-a1 and S201-A11-b1 include the following steps.

In step 11, a parent node of the i-th node is determined as an i-th parent node in the current picture to be encoded.

In step 12, a matching node of the i-th parent node in the k-th prediction reference picture is determined as an i-th matching node.

In step 13, one of child nodes of the i-th matching node is determined as a corresponding node of the i-th node in the k-th prediction reference picture.

In the Manner 2, for the i-th node, the encoding side determines the parent node of the i-th node in the current picture to be encoded, and then determines the matching node of the parent node of the i-th prediction neighborhood node in the k-th prediction reference picture. For convenience of description, the parent node of the i-th node is denoted as the i-th parent node, and the matching node of the parent node of the i-th node in the k-th prediction reference picture is determined as the i-th matching node. Next, a child node of the child nodes of the i-th matching node is determined as the corresponding node of the i-th node in the k-th prediction reference picture. Thereby, the corresponding node of the i-th node in the k-th prediction reference picture is accurately determined.

The process of determining the matching node of the i-th parent node in the k-th prediction reference picture in the step 12 will be introduced below.

The specific manner in which the encoding side determines the matching node of the i-th parent node in the k-th prediction reference picture is not limited in the embodiments of the present application.

In some embodiments, the partition depth of the i-th parent node in the current picture to be encoded is determined, for example, the i-th parent node is at the second layer of the octree of the current picture to be encoded. In this way, the encoding side may determine one node among the nodes in the k-th prediction reference picture that have the same partition depth as the i-th parent node as the matching node of the i-th parent node in the k-th prediction reference picture. For example, one of the nodes at the second layer in the k-th prediction reference picture is determined as the matching node of the i-th parent node in the k-th prediction reference picture.

In some embodiments, the encoding side determines a matching node of the i-th parent node in the k-th prediction reference picture based on the occupancy information of the i-th parent node. In some embodiments, the occupancy information of the i-th parent node in the current picture to be encoded has been encoded, and the occupancy information of each node in the k-th prediction reference picture has also been encoded. In this way, the encoding side may search for the matching node of the i-th parent node in the k-th prediction reference picture based on the occupancy information of the i-th parent node.

For example, a node whose occupancy information in the k-th prediction reference picture has the smallest difference from the occupancy information of the i-th parent node is determined as a matching node of the i-th parent node in the k-th prediction reference picture.

For example, assuming that the occupancy information of the i-th parent node is 11001101, the node whose occupancy information has the smallest difference from the occupancy information 11001101 is searched in the k-th prediction reference picture. In some embodiments, the encoding side performs an XOR operation on the occupancy information of the i-th parent node and the occupancy information of each node in the k-th prediction reference picture, and determines the node having the smallest XOR operation result in the k-th prediction reference picture as the matching node of the i-th parent node in the k-th prediction reference picture.

For example, assuming that the occupancy information of node 1 in the k-th prediction reference picture is 10001101, XOR operation is performed on 11001101 and 10001101. The first bit of 11001101 and the first bit of 10001101 are both 1, so the XOR result of the first bit of the two is 0; the second bit of 11001101 is different from the second bit of 10001111, so the XOR result of the second bit of the two is 1; and so on, the XOR result of 11001101 and 10001111 is 0+1+0+0+0+0+1+0=2. In this way, the encoding side may determine the XOR operation result of the occupancy information of the i-th parent node and the occupancy information of each node in the k-th prediction reference picture, and then determine the node in the k-th prediction reference picture having the smallest XOR operation result of the occupancy information of the i-th parent node as the matching node of the i-th parent node in the k-th prediction reference picture.

Based on the above steps, the encoding side may determine the matching node of the i-th parent node in the k-th prediction reference picture. For the convenience of description, the matching node is denoted as the i-th matching node.

Next, the encoding side determines one of the child nodes of the i-th matching node as the corresponding node of the i-th neighborhood node in the k-th prediction reference picture.

For example, the encoding side determines a default child node among the child nodes included in the i-th matching node as the corresponding node of the i-th node in the k-th prediction reference picture. It is assumed that a first child node of the i-th matching node is determined as the corresponding node of the i-th node in the k-th prediction reference picture.

For another example, the encoding side determines a first sequence number of the i-th node among the child nodes included in the parent node; and determines a child node with the first sequence number among the child nodes of the i-th matching node as the corresponding node of the i-th node in the k-th prediction reference picture. For example, as shown in FIG. 14, the i-th node is the second child node of the i-th parent node, and the first sequence number is 2. In this case, the second child node of the i-th matching node may be determined as the corresponding node of the i-th node.

The process of determining the corresponding node of the i-th neighborhood node among the M neighborhood nodes in the k-th prediction reference picture and determining the corresponding node of the current node in the k-th prediction reference picture are introduced above. In this way, the encoding side may determine the N prediction nodes of the current node in the prediction reference picture by using the Manner two or Manner three.

After the encoding side determines, based on the above steps, the N prediction nodes of the current node in the prediction reference picture of the current picture to be encoded, the encoding side performs S201-A2.

In the embodiments of the present application, the method of determining whether the current node meets the start condition of the skipCodeMode based on the number of points included in at least one prediction node among the N prediction nodes in the above S201-A2 includes at least the following Examples.

In Example 1, in a case where the start condition includes that the number of points included in the prediction node is greater than or equal to the first numerical value, S201-A2 includes the following steps.

In S201-A2-11, the number of points included in the N prediction nodes is obtained.

In S201-A2-12, in response to that the number of points included in the at least one prediction node among the N prediction nodes is greater than or equal to the first numerical value, it is determined that the current node meets the start condition of the skipCodeMode.

In the Example 1, since the prediction node is an encoded node, the number of points included in the prediction node may be obtained. In this way, the number of points included in each of the N prediction nodes is compared with the first numerical value, and at least one prediction node that includes points with a number greater than or equal to the first numerical value is selected. For example, the current node includes three prediction nodes, the first prediction node includes one point and no duplicate points exist, the second prediction node includes two points and both are duplicate points, and the third prediction node includes two non-duplicate points. Assuming that the first numerical value is 1, it may be determined that the number of points included in each of the three prediction nodes is greater than or equal to the first numerical value, and then it is determined that the current node meets the start condition of the skipCodeMode. If the first numerical value is 2, it is determined that the number of points included in the second prediction node among the three prediction nodes and the number of points included in the third prediction node among the three prediction nodes are greater than or equal to the first numerical value, and then it is determined that the current node meets the start condition of the skipCodeMode. If the first numerical value is 3, it is determined that the number of points included in each of the three prediction nodes is smaller than the first numerical value, and then it is determined that the current node does not meet the start condition of the skipCodeMode.

In Example 2, in a case where the start condition includes that the number of points included in the prediction node is equal to the number of points included in the current node, S201-A2 includes the following steps.

In S201-A2-21, the number of points included in the current node and the number of points included in the N prediction nodes are obtained.

In S201-A2-22, in response to that the number of points included in the current node is equal to the number of points included in at least one prediction node among the N prediction nodes, it is determined that the current node meets the start condition of the skipCodeMode.

In the Example 2, since the prediction node is an encoded node, the number of points included in the prediction node may be obtained. In addition, before encoding the geometric information of the current node, the number of points included in the current node has been encoded. In this way, the encoding side may compare the number of points included in each of the N prediction nodes with the number of points included in the current node. As long as the number of points included in one of the N prediction nodes is equal to the number of points included in the current node, it may be determined that the current node meets the start condition of the skipCodeMode. Otherwise, it is determined that the current node does not meet the start condition of the skipCodeMode.

In Example 3, in a case where the start condition includes that the number of points included in the prediction node is equal to the number of points included in the current node, and the direct encoding model of the prediction node is the same as the direct encoding model of the current node, S201-A2 includes the following steps.

In S201-A2-31, the number of points included in the current node and the direct encoding model of the current node, and the number of points included in the N prediction nodes and the direct encoding model of the prediction nodes are obtained.

In S201-A2-32, in response to that the number of points included in the current node is equal to the number of points included in the at least one prediction node among the N prediction nodes and the direct encoding model of the current node is the same as the direct encoding model of the at least one prediction node, it is determined that the current node meets the start condition of the skipCodeMode.

In the Example 3, since the prediction node is an encoded node, the number of points included in the prediction node and the direct encoding model of the prediction node may be obtained. In addition, before encoding the geometric information of the current node, the number of points included in the current node and the direct encoding model of the current node has been encoded. In this way, the encoding side may compare the number of points included in each of the N prediction nodes with the number of points included in the current node, and compare the direct encoding model of each of the N prediction nodes with the direct encoding model of the current node. As long as the number of points included in one prediction node of the N prediction nodes is equal to the number of points included in the current node and the direct encoding model of that prediction node is also the same as the direct encoding model of the current node, it may be determined that the current node meets the start condition of the skipCodeMode. Otherwise, it is determined that the current node does not meet the start condition of the skipCodeMode.

In some embodiments, after the encoding side determines whether the current node meets the start condition of the skipCodeMode based on the above steps, the encoding side also indicates to the decoding side whether the current node meets the start condition of the encoding mode via a second flag such as skipCodeEligible.

For example, the second flag skipCodeEligible is encoded into the bitstream, and the second flag skipCodeEligible is used to indicate whether the current node meets the start condition of the skipCodeMode.

For example, in response to that the current node meets the start condition of the skipCodeMode, a value of the second flag skipCodeEligible is determined to be a third value.

For another example, in response to that the current node does not meet the start condition of the skipCodeMode, a value of the second flag skipCodeEligible is determined to be a fourth value.

The specific values of the third value and the fourth value are not limited in the embodiments of the present application.

Optionally, the third value is 1, and the fourth value is 0.

Based on the above steps, the encoding side may determine whether the current node meets the start condition of the skipCodeMode. Next, the above step S201-B is performed.

The manner of determining the encoding mode of the current point based on whether the current node meets the start condition of the skipCodeMode in the above S201-B includes at least the following manners.

Manner one: in a case where the current node meets the start condition of the skipCodeMode, it is determined that an encoding mode of geometric information for at least one component of the current point is the skipCodeMode.

As can be seen from the above, for the non-lidar point cloud, the encoding side separately encodes geometric information for an X-coordinate component of the current point, geometric information for a Y-coordinate component of the current point and geometric information for a Z-coordinate component of the current point. For the laser radar point cloud, the encoding side encodes the geometric information for the X-coordinate component of the current point and the geometric information for the Y-coordinate component of the current point, and encodes a laser ray index (Laserlex) corresponding to the current point and a geometric residual of the Z-coordinate of the current point.

It can be seen that if the current point is a point in the non-lidar point cloud, the at least one component of the current point includes at least one of: the X-coordinate component, the Y-coordinate component, or the Z-coordinate component.

If the current point is a point in the laser radar point cloud, the at least one component of the current point includes at least one of: the X-coordinate component, the Y-coordinate component, the laser ray index, or the geometric residual of the Z-coordinate.

As can be seen from the above, in the embodiments of the present application, in a case where the current node meets the start condition of the skipCodeMode, the prediction node of the current node includes at least one point. Therefore, for the current point in the current node, at least one prediction point may be found in the prediction node. Furthermore, the geometric information for at least one component of the current point may be determined based on the prediction point, and then it may be determined that the encoding mode of the geometric information for the at least one component of the current point may be the skipCodeMode.

For example, in a case where the current node meets the start condition of the skipCodeMode, it is determined that the encoding modes of all components of the current point are the skipCodeMode. For example, if the current point is a point in the non-lidar point cloud, it is determined that the geometric information for the X-coordinate component of the current point, the geometric information for the Y-coordinate component of the current point, and the geometric information for the Z-coordinate component of the current point all use the skipCodeMode. For another example, if the current point is a point in the laser radar point cloud, it is determined that the X-coordinate component, the Y-coordinate component, the laser ray index, and the geometric residual of the Z-coordinate of the current point all use the skipCodeMode.

For example, in a case where the current node meets the start condition of the skipCodeMode, it is determined that an encoding mode of geometric information of some components of the current point is the skipCodeMode. For example, if the current point is a point in the non-lidar point cloud, it is determined that the encoding mode of the geometric information for the Z-coordinate component of the current point is the skipCodeMode, or the encoding mode of the geometric information for the X-coordinate component of the current point is the skipCodeMode, or the encoding mode of the geometric information for the Y-coordinate component of the current point is the skipCodeMode. For another example, if the current point is a point in the lidar point cloud, it is determined that the encoding mode of the geometric information for the X-coordinate component of the current point is the skipCodeMode, or the encoding mode of the geometric information for the Y-coordinate component of the current point is the skipCodeMode, or the encoding mode of the laser ray index of the current point is the skipCodeMode, or the encoding mode of the geometric residual of the Z-coordinate of the current point is the skipCodeMode.

Manner two: in a case where the current node meets the start condition of the skipCodeMode, the above S201-B includes the following steps.

In S201-B1, at least one prediction point of the current point is determined among points included in the N prediction nodes of the current node.

In S201-B2, an error between the geometric information of the current point and the geometric information of the at least one prediction point is determined.

In S201-B3, the encoding mode of the current point is determined based on the error.

The specific manner in which the encoding side determines the at least one prediction point of the current point among the points included in the N prediction nodes of the current node is not limited in the embodiments of the present application.

In some embodiments, the encoding side selects a prediction point corresponding to the current point from points included in each prediction node of the N prediction nodes.

In some embodiments, the above S201-B1 includes the following steps.

In S201-B11, the at least one prediction node is selected from the N prediction nodes based on the start condition of the skipCodeMode, where M is a positive integer less than or equal to N.

In S201-B12, the at least one prediction point of the current point is determined based on the points included in the at least one prediction node.

In this embodiment, in order to further improve the encoding accuracy of the skipCodeMode, points included in the prediction node that is most relevant to characteristics of the current node are selected to determine the prediction point of the current point, so as to improve the selection accuracy of the prediction point and further improve the geometric encoding effect of the current point.

In this embodiment, the N prediction nodes of the current node may be screened to select a prediction node with a strong correlation with the current node based on the start condition of the skipCodeMode.

In some embodiments, the screening manner of the N prediction nodes varies based on different start conditions of the skipCodeMode.

In an example, the start condition of the skipCodeMode is that the number of points included in the prediction nodes is greater than or equal to the first numerical value. In this case, the encoding side selects, from the N prediction nodes, at least one prediction node that includes points with a number greater than or equal to the first numerical value.

In another example, the start condition of the skipCodeMode is that the number of points included in the prediction nodes is equal to the number of points included in the current node. In this case, the encoding side selects, from the N prediction nodes, at least one prediction node that includes points with a number of equal to the number of points included in the current node.

In another example, the start condition of the skipCodeMode is that the number of points included in the prediction nodes is equal to the number of points included in the current node, and the direct encoding model of the prediction nodes is the same as the direct encoding model of the current node. In this case, the encoding side selects, from the N prediction nodes, at least one prediction node that includes points with a number equal to the number of points included in the current node and has a direct encoding model same as the direct encoding model of the current node.

Based on the above method, after the encoding side selects the at least one prediction node from the N prediction nodes, the above S201-B12 is performed to determine at least one prediction point of the current point based on the points included in the at least one prediction node.

In the embodiments of the present application, the manner of determining the prediction point of the current point from the at least one prediction node is the same. For convenience of description, determining the prediction point of the current point from one prediction node is taken as an example for explanation.

In some embodiments, for each prediction node of the at least one prediction node, if the current node includes one point and the prediction node includes two non-duplicate points, all non-duplicate points in the prediction node are used as prediction points of the current point. For example, in a case where the prediction node includes two non-duplicate points, the two non-duplicate points are determined as two prediction points of the current point.

In some embodiments, for each prediction node of the at least one prediction node, if the prediction node includes one point, the point included in the prediction node is determined as one prediction point of the current point.

In some embodiments, for each prediction node of the at least one prediction node, in response to that the prediction node includes multiple non-duplicate points, a point in the prediction node that has a same ranking as the current point in the current node is determined as a prediction point of the current point. For example, the prediction node includes point 1 and point 2, and point 1 and point 2 are non-duplicate points. It is assumed that the current node also includes two non-duplicate points. In this case, if the current point is the first point in the current node, point 1 in the prediction node is determined as the prediction point of the current point. If the current point is the second point in the current node, point 2 in the prediction node is determined as the prediction point of the current point.

After the encoding side determines at least one prediction point of the current point among the points included in the N prediction nodes of the current node, the S201-B2 is performed, that is, the error between the geometric information of the current point and the geometric information of the at least one prediction point is determined.

The error between the geometric information of the current point and the geometric information of the at least one prediction point will be introduced below.

In an example, for any one of the at least one prediction point, an error between the geometric information of the current point and geometric information of the prediction point is determined to obtain the error corresponding to the prediction point; and an average of errors corresponding to all of the at least one prediction point is determined as the error between the geometric information of the current point and the geometric information of the at least one prediction point.

For example, for each prediction point of the at least one prediction point, an error between the geometric information of the current point and geometric information of the prediction point is determined based on formula (35):

$$Dist = abs ( predPoint [ 0 ] ) - curPoint [ 0 ] ) + abs ( predPoint [ 1 ] - curPoint [ 1 ] ) + abs ( predPoint [ 2 ] - curPoint [ 2 ] ) \qquad ( 35 )$$

Here, predPoint[0], predPoint[1] and predPoint[2] are the geometric information of the current point, and curPoint[0], curPoint[1] and curPoint[2] are the geometric information of the prediction point.

In an example, first geometric information is obtained based on the geometric information of the at least one prediction point; and an error between the geometric information of the current point and the first geometric information is determined as the error between the geometric information of the current point and the geometric information of the at least one prediction point.

The specific manner of obtaining the first geometric information based on the geometric information of the at least one prediction point is not limited in the embodiments of the present application.

In a possible implementation, an average of the geometric information of the at least one prediction point is used as the first geometric information. For example, an average of the geometric information of the at least one prediction point on the X axis is used as geometric information for the X axis in the first geometric information, an average of the geometric information of the at least one prediction point on the Y axis is used as geometric information for the Y axis in the first geometric information, and an average of the geometric information of the at least one prediction point on the Z axis is used as geometric information for the Z axis in the first geometric information.

In another possible implementation, a weighted average of the geometric information of the at least one prediction point is used as the first geometric information. For example, a weighted average of the geometric information of the at least one prediction point on the X axis is used as geometric information for the X axis in the first geometric information, a weighted average of the geometric information of the at least one prediction point on the Y axis is used as geometric information for the Y axis in the first geometric information, and a weighted average of the geometric information of the at least one prediction point on the Z axis is used as geometric information for the Z axis in the first geometric information.

The weights in a case of weighting the above prediction points are not limited in the embodiments of the present application.

In some embodiments, the weight of the prediction node where the prediction point is located may be determined, and the weight of the prediction node may be determined as the weight of the prediction point.

The manner of determining the weight of the prediction node will be introduced below.

In some embodiments, the weight corresponding to the above prediction node is a preset value. As can be seen from the above, in some embodiments, the above N prediction nodes are determined based on M neighborhood nodes of the current node. Assuming that prediction node 1 is a prediction node corresponding to neighborhood node 1, if neighborhood node 1 is a coplanar node of the current node, a weight of prediction node 1 is a preset weight 1; if neighborhood node 1 is a co-edge node of the current node, a weight of prediction node 1 is a preset weight 2; and if neighborhood node 1 is a copointed node of the current node, a weight of prediction node 1 is a preset weight 3.

In some embodiments, the weight corresponding to the prediction node is determined based on a distance between the neighborhood node corresponding to the prediction node and the current node. For example, the smaller the distance between the neighborhood node and the current node, the stronger the inter correlation between the prediction node corresponding to the neighborhood node and the current node, and thus the greater the weight of the prediction node.

For example, considering prediction node 1 as an example, assuming that prediction node 1 is the corresponding point of neighborhood node 1 in the prediction reference picture among the M neighborhood nodes of the current node, the weight of prediction node 1 may be determined based on the distance between neighborhood node 1 and the current node. For example, a reciprocal of the distance between neighborhood node 1 and the current node is determined as the weight of prediction node 1.

In an example, if neighborhood node 1 is a coplanar node of the current node, the weight of prediction node 1 is 1; if neighborhood node 1 is a co-edge node of the current node, the weight of prediction node 1 is a preset weight 1/\sqrt{2}; if neighborhood node 1 is a copointed node of the current node, the weight of prediction node 1 is a preset weight 1\sqrt{3}.

In an example, if neighborhood node 1 is a coplanar node of the current node, the weight of prediction node 1 is \sqrt{6}; if neighborhood node 1 is a co-edge node of the current node, the weight of prediction node 1 is \sqrt{3}; and if neighborhood node 1 is a copointed node of the current node, the weight of prediction node 1 is \sqrt{2}.

Based on the above steps, after the weight of the prediction node where the prediction point is located is determined, the weight of the prediction node is determined as the weight of the prediction point; then, based on the weight of the at least one prediction point, a weighted average operation is performed on the geometric information of the at least one prediction point to obtain the first geometric information.

Next, the error between the geometric information of the current point and the first geometric information is determined, and the error between the geometric information of the current point and the first geometric information is determined as the error between the geometric information of the current point and the geometric information of the at least one prediction point.

After determining the error between the geometric information of the current point and the geometric information of the at least one prediction point based on the above method, the S201-B3 is performed to determine the encoding mode of the current point based on the error.

In some embodiments, the error between the geometric information of the current point and the geometric information of the at least one prediction point is compared with a second numerical value to determine the encoding mode of the current point.

For example, in response to that the error is less than or equal to the second numerical value, it is determined that the encoding mode of the current point is the skipCodeMode.

For another example, in response to that the error is greater than the second numerical value, it is determined that the encoding mode of the current point is not the skipCodeMode.

The specific value of the second numerical value is not limited in the embodiments of the present application.

In an example, the second numerical value is 0. In this case, the skipCodeMode may be used to implement a lossless encoding.

In another example, the second numerical value is a number of bits required to encode the geometric information of the current point.

For example, encoding the X-coordinate component of the current node requires nodeSizeLog 2[0] bits, encoding the Y-coordinate component of the current node requires nodeSizeLog 2[1] bits, and encoding the Z-coordinate component of the current node requires nodeSizeLog 2[2] bits. In an example, the maximum value among nodeSizeLog 2[0], nodeSizeLog 2[1], and nodeSizeLog 2[2] may be determined as the second numerical value. In an example, an average of nodeSizeLog 2[0], nodeSizeLog 2[1], and nodeSizeLog 2[2] may be determined as the second numerical value.

In some embodiments, after determining the encoding mode of the current point based on the above steps, the encoding side encodes a first flag in the bitstream, where the first flag is used to indicate whether the current point uses the skipCodeMode.

For example, if the current encoding mode is the skipCodeMode, the value of the first flag is set to a first value, and then the first flag is encoded into the bitstream.

For another example, if the current coding mode is not the skipCodeMode, the value of the first flag is set to a second value, and then the first flag is encoded into the bitstream.

The specific values of the first value and the second value are not limited in the embodiments of the present application.

Optionally, the first value is 1, and the second value is 0.

After the encoding side determines the encoding mode of the current point based on the above method, the following step S202 is performed.

In S202, in a case where the encoding mode of the current point is the skip encode mode (skipCodeMode), encoding of the geometric information of the current point is skipped.

In the embodiments of the present application, if it is determined that the current point is encoded using the skipCodeMode, the encoding of the geometric information of the current point is directly skipped. Correspondingly, the encoding side does not need to encode the geometric information of the current point from the bitstream, but determines the at least one prediction point of the current point from the N prediction nodes of the current node and then directly determines the geometric information of the current point based on the geometric information of the at least one prediction point. Thereby, the geometric encoding efficiency of the point cloud is improved.

The specific manner of skipping the encoding of the geometric information of the current point is not limited in the embodiments of the present application.

In some embodiments, if the encoding mode of the current point is the skipCodeMode, the encoding side skips encoding of geometric information for at least one component of the current point.

In some embodiments, if the encoding modes of all components of the current node are each the skipCodeMode, the encoding of the geometric information for all components of the current point is skipped. For example, if the current point is in the non-lidar point cloud, encoding of geometric information for the X-coordinate component, the Y-coordinate component, and the Z-coordinate component of the current point is skipped. For another example, if the current point is in the lidar point cloud, encoding of geometric information for the X-coordinate component and the Y-coordinate component of the current point, the laser ray index of the current point, and the geometric residual of the Z-coordinate of the current point is skipped.

In some embodiments, geometric information for some components of the current point is encoded using the skipCodeMode, and geometric information for some components of the current point is not encoded using the skipCodeMode. In this case, the above S202 includes the following steps.

In S202-A1, encoding of geometric information of the current node for an i-th component is skipped.

In S202-A2, an encoding mode used for geometric information of the current point for a j-th component is determined, and the geometric information of the current point for the j-th component is encoded based on the encoding mode.

In a case where the point cloud is the non-lidar point cloud, the i-th component is the X-coordinate component, the Y-coordinate component or the Z-coordinate component, and the j-th component is the X-coordinate component, the Y-coordinate component or the Z-coordinate component; and in a case where the point cloud is the lidar point cloud, the i-th component is the X-coordinate component, the Y-coordinate component, the laser ray index or the geometric residual of Z-coordinate, and the j-th component is the X-coordinate component, the Y-coordinate component, the laser ray index or the geometric residual of the Z-coordinate, where the i-th component is different from the j-th component.

For example, in a case where the point cloud is the non-lidar point cloud, the encoding of the geometric information for the X-coordinate component, the Y-coordinate component, or the Z-coordinate component of the current point is skipped.

For another example, in a case where the point cloud is the laser radar point cloud, the encoding of the geometric information for the X-coordinate component of the current point, the geometric information for the Y-coordinate component, the laser ray index, or the geometric residual of the Z-coordinate is skipped.

In some embodiments, the geometric information for the j-th component of the current point is not encoded using the skipCodeMode. In this case, the encoding side further needs to determine the encoding mode used for the geometric information of the current point for the j-th component. For example, the default encoding mode is determined as the encoding mode used for the geometric information of the current point for the j-th component (e.g., a direct encoding model), or the encoding mode used for the geometric information of the current point for the j-th component is determined from several preset encoding modes based on the rate-distortion optimization cost. Next, the geometric information of the current point for the j-th component is encoded using the encoding mode.

Through the above encoding process, the encoding side can encode the geometric information of each point in the current node, so that the encoding of the geometric information of the point cloud is implemented.

The process in which the encoding side encodes the geometric information of the current point in the current node by using the skipCodeMode is introduced in above embodiments.

It should be noted that the skipCodeMode proposed in the embodiments of the present application can be applied not only to the encoding process of geometric information, but also to the encoding process of other information.

For example, in some embodiments, the skipCodeMode proposed in the embodiments of the present application is applied to the encoding of occupancy information of geometric information. For example, in a case of encoding a current node, a prediction node of the current node is determined in a prediction reference picture of a current picture to be encoded, and then occupancy information of the current node is determined based on occupancy information of the prediction node, thereby skipping the encoding of the occupancy information of the geometric information.

For another example, in some embodiments, the skipCodeMode proposed in the embodiments of the present application is applied to the encoding of node flags and node position information of trisoup. For example, in a case of encoding a current sub-block, a prediction sub-block of the current sub-block is determined in a prediction reference picture of a current picture to be encoded, and then occupancy information of the current sub-block is determined based on occupancy information of the prediction sub-block, thereby skipping the encoding of the node flags and node position information of the trisoup.

For yet another example, in some embodiments, the skipCodeMode proposed in the embodiments of the present application is applied to encoding of residual in a prediction tree. For example, in a case of encoding a current node, a prediction node of the current node is determined in a prediction reference picture of a current picture to be encoded, and then residual information of the current node is determined based on residual information of the prediction node, thereby skipping the encoding of the residual in the prediction tree.

For yet another example, in some embodiments, the skipCodeMode proposed in the embodiments of the present application is applied to encoding of attribute residual of the point cloud. For example, in a case of encoding a current node, a prediction node of the current node is determined in a prediction reference picture of a current picture to be encoded, and then attribute residual information of the current node is determined based on attribute residual information of the prediction node, thereby skipping the encoding of the attribute residual information.

In the point cloud encoding method provided in the embodiments of the present application, in a case of encoding the geometric information of the current node, the encoding mode of the current point in the current node is first determined, and if the encoding mode of the current point is the skipCodeMode, then the encoding of the geometric information of the current point is skipped. A new encoding mode, i.e., the skipCodeMode, is introduced in the IDCM geometric encoding process in the embodiments of the present application, that is, the geometric information of the current point is directly determined based on the geometric information of the prediction point, thereby further improving the encoding efficiency.

It should be understood that FIGS. 9 to 15 are merely examples of the present application and should not be construed as limitations to the present application.

The preferred embodiments of the present application are described in detail above in conjunction with the accompanying drawings; however, the present application is not limited to the details in the above embodiments. Within the technical concept of the present application, a variety of simple variations may be made to the technical solution of the present application, and these simple variations all fall within the protection scope of the present application. For example, the various technical features described in the above embodiments may be combined in any suitable manner without contradiction. In order to avoid unnecessary repetition, the various possible combinations are not described additionally in the present application. As another example, any combination between different implementations of the present application is also possible, and as long as it does not violate the concept of the present application, which should also be regarded as the contents disclosed in the present application.

It should also be understood that in various method embodiments of the present application, the magnitude of a serial number of each of the above processes does not imply a sequential order of execution, and that the order of execution of the processes should be determined by their function and inherent logic without constituting any limitation of the process of implementing the embodiments of the present application. In addition, in the embodiments of the present application, the term “and/or” is only a description of an association relationship of associated objects, which indicates that there may be three kinds of relationships. “A and/or B” may represent three situations: A exists alone, both A and B exist, and B exists alone. In addition, the character “/” herein generally indicates that the associated objects before and after this character are in an “or” relationship.

In conjunction with FIGS. 9 to 15, the method embodiments of the present application are described in detail above, and the apparatus embodiments of the present application will be described in detail below in conjunction with FIGS. 16 and 19.

FIG. 16 is a schematic block diagram of a point cloud decoding apparatus provided in the embodiments of the present application.

As shown in FIG. 16, the point cloud decoding apparatus 10 may include:
a mode determining unit 11, configured to determine a decoding mode of a current point in a current node, where the current node is a node to be decoded in a current picture to be decoded;
a prediction point determining unit 12, configured to determine, in a case where the decoding mode of the current point is a skip decode mode (skipDecodeMode), at least one prediction point of the current point among points included in N prediction nodes of the current node, where the prediction nodes are nodes corresponding to the current node in prediction reference pictures of the current picture to be decoded, the skipDecodeMode is a mode for skipping decoding of geometric information of the current point, and N is a positive integer; and
a decoding unit 13, configured to determine the geometric information of the current point based on geometric information of the at least one prediction point.

In some embodiments, the mode determining unit 11 is configured to: determine whether the current node meets a start condition of the skipDecodeMode; and determine the decoding mode of the current point based on whether the current node meets the start condition of the skipDecodeMode.

In some embodiments, the mode determining unit 11 is configured to, in a case where the current node meets the start condition of the skipDecodeMode, determine that a decoding mode of geometric information for at least one component of the current point is the skipDecodeMode.

In some embodiments, the mode determining unit 11 is configured to: in a case where the current node meets the start condition of the skipDecodeMode, decode a bitstream to obtain a first flag, where the first flag is used to indicate whether the current point uses the skipDecodeMode, and the first flag is determined based on an error between the geometric information of the current point and the geometric information of the at least one prediction point; and determine the decoding mode of the current point based on the first flag.

In some embodiments, the mode determining unit 11 is configured to: in response to that a value of the first flag is a first value, determine that the decoding mode of the current point is the skipDecodeMode; and in response to that the value of the first flag is a second value, determine that the decoding mode of the current point is not the skipDecodeMode.

In some embodiments, in a case where the error between the geometric information of the current point and the geometric information of the prediction point is less than or equal to a second numerical value, the value of the first flag is the first value.

In some embodiments, the second numerical value is 0.

In some embodiments, the second numerical value is a number of bits required to encode the geometric information of the current point.

In some embodiments, the start condition of the skipDecodeMode includes any one of: the number of points included in the prediction nodes being greater than or equal to a first numerical value; the number of points included in the prediction nodes being equal to the number of points included in the current node; or the number of points included in the prediction nodes being equal to the number of points included in the current node, and a direct decoding mode of the prediction nodes being the same as a direct decoding mode of the current node.

In some embodiments, the mode determining unit 11 is configured to: decode the bitstream to obtain a second flag, where the second flag is used to indicate whether the current node meets the start condition of the skipDecodeMode; and determine whether the current node meets the start condition of the skipDecodeMode based on the second flag.

In some embodiments, the mode determining unit 11 is configured to: in response to that a value of the second flag is a third value, determine that the current node meets the start condition of the skipDecodeMode; and in response to that the value of the second flag is a fourth value, determine that the current node does not meet the start condition of the skipDecodeMode.

In some embodiments, the mode determining unit 11 is configured to: determine the N prediction nodes of the current node in the prediction reference pictures of the current picture to be decoded; and determine whether the current node meets the start condition of the skipDecodeMode based on the number of points included in at least one prediction node among the N prediction nodes.

In some embodiments, in a case where the start condition includes the number of points included in the prediction nodes being greater than or equal to the first numerical value, the mode determining unit 11 is configured to: obtain the number of points included in the N prediction nodes; and in response to that the number of points included in the at least one prediction node among the N prediction nodes is greater than or equal to the first numerical value, determine that the current node meets the start condition of the skipDecodeMode.

In some embodiments, the first numerical value is a positive integer.

In some embodiments, in a case where the start condition includes the number of points included in the prediction nodes being equal to the number of points included in the current node, the mode determining unit 11 is configured to: obtain the number of points included in the current node and the number of points included in the N prediction nodes; and in response to that the number of points included in the current node is equal to the number of points included in the at least one prediction node among the N prediction nodes, determine that the current node meets the start condition of the skipDecodeMode.

In some embodiments, in a case where the start condition includes the number of points included in the prediction nodes being equal to the number of points included in the current node and the direct decoding mode of the prediction nodes being the same as the direct decoding mode of the current node, then the mode determining unit 11 is configured to: obtain the number of points included in the current node and the direct decoding mode of the current node, and the number of points included in the N prediction nodes and the direct decoding mode of the prediction nodes; and in response to that the number of points included in the current node is equal to the number of points included in the at least one prediction node among the N prediction nodes and the direct decoding mode of the current node is the same as a direct decoding mode of the at least one prediction node, determine that the current node meets the start condition of the skipDecodeMode.

In some embodiments, the prediction point determining unit 12 is further configured to, before determining the at least one prediction point of the current point among the points included in the N prediction nodes of the current node, determine the N prediction nodes of the current node in the prediction reference pictures of the current picture to be decoded; select the at least one prediction node from the N prediction nodes based on the start condition of the skipDecodeMode; and determine the at least one prediction point of the current point based on points included in the at least one prediction node.

In some embodiments, the current picture to be decoded includes K prediction reference pictures, and the prediction point determining unit 12 is configured to: for a k-th prediction reference picture among the K prediction reference pictures, determine at least one prediction node of the current node in the k-th prediction reference picture, where k is a positive integer less than or equal to K, and K is a positive integer; and determine the N prediction nodes of the current node based on at least one prediction node of the current node in the K prediction reference pictures.

In some embodiments, the prediction point determining unit 12 is configured to determine M neighborhood nodes of the current node in the current picture to be decoded, where the M neighborhood nodes include the current node, and M is a positive integer; for an i-th neighborhood node among the M neighborhood nodes, determine a corresponding node of the i-th neighborhood node in the k-th prediction reference picture, where i is a positive integer less than or equal to M; and determine the at least one prediction node of the current node in the k-th prediction reference picture based on corresponding nodes of the M neighborhood nodes in the k-th prediction reference picture.

In some embodiments, the prediction point determining unit 12 is configured to determine a corresponding node of the current node in the k-th prediction reference picture; determine at least one neighborhood node of the corresponding node; and determine the at least one neighborhood node as the at least one prediction node of the current node in the k-th prediction reference picture.

In some embodiments, the prediction point determining unit 12 is further configured to determine a parent node of an i-th node as an i-th parent node in the current picture to be decoded, where the i-th node is the i-th neighborhood node or the current node; determine a matching node of an i-th parent node in the k-th prediction reference picture as an i-th matching node; and determine one of child nodes of the i-th matching node as a corresponding node of the i-th node in the k-th prediction reference picture.

In some embodiments, the prediction point determining unit 12 is specifically configured to determine a node, whose occupancy information has the smallest difference from occupancy information of the i-th parent node, in the k-th prediction reference picture as the matching node of the i-th parent node in the k-th prediction reference picture.

In some embodiments, the prediction point determining unit 12 is specifically configured to determine a first sequence number of the i-th node among child nodes included in the parent node; and determine a child node with the first sequence number among the child nodes of the i-th matching node as the corresponding node of the i-th node in the k-th prediction reference picture.

In some embodiments, in a case where the current picture to be decoded is a P frame, the K prediction reference pictures include a forward picture of the current picture to be decoded.

In some embodiments, in a case where the current picture to be decoded is a B frame, the K prediction reference pictures include at least one of: a forward picture of the current picture to be decoded or a backward picture of the current picture to be decoded.

In some embodiments, the prediction single determination unit 12 is specifically configured to: for any one prediction node of the at least one prediction node, in response to that the prediction node includes a point, determine the point included in the prediction node as a prediction point of the current point; and in response to that the prediction node includes multiple non-duplicate points, determine a point in the prediction node that has a same ranking as the current point in the current node as the prediction point of the current point.

In some embodiments, the decoding unit 13 is specifically configured to obtain first geometric information based on the geometric information of the at least one prediction point; and determine geometric information for at least one component of the current point based on the first geometric information.

In some embodiments, the decoding unit 13 is specifically configured to determine an average of the geometric information of the at least one prediction point as the first geometric information.

In some embodiments, the decoding unit 13 is specifically configured to determine the first geometric information as the geometric information of the current point.

In some embodiments, the decoding unit 13 is specifically configured to determine geometric information of the first geometric information for an i-th component as geometric information of the current point for the i-th component; and determine a decoding mode used for geometric information of the current point for a j-th component, and decode the geometric information of the current point for the j-th component based on the decoding mode. In a case where the point cloud is a non-lidar point cloud, the i-th component is an X-coordinate component, a Y-coordinate component or a Z-coordinate component, and the j-th component is an X-coordinate component, a Y-coordinate component or a Z-coordinate component; in a case where the point cloud is a lidar point cloud, the i-th component is an X-coordinate component, a Y-coordinate component, a laser ray index or a geometric residual of a Z-coordinate, and the j-th component is an X-coordinate component, a Y-coordinate component, a laser ray index or a geometric residual of a Z-coordinate; and the i-th component is different from the j-th component.

It should be understood that the apparatus embodiments and the method embodiments may correspond to each other, and similar descriptions may be referred to that of the method embodiments, which will not be repeated here to avoid repetition. Specifically, the point cloud decoding apparatus 10 shown in FIG. 16 may correspond to a corresponding subject performing the point cloud decoding method in the embodiments of the present application, and the above and other operations and/or functions of each unit in the point cloud decoding apparatus 10 are respectively for implementing corresponding processes in the point cloud decoding method, which will not be repeated here for the sake of brevity.

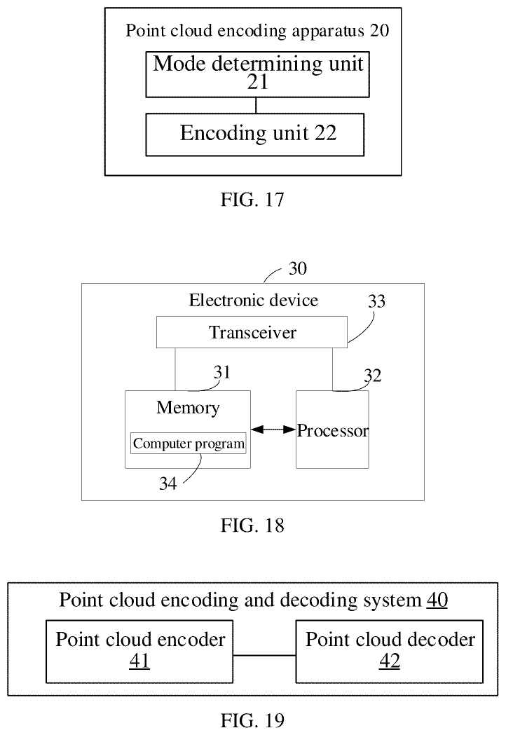

FIG. 17 is a schematic block diagram of a point cloud encoding apparatus provided in the embodiments of the present application.

As shown in FIG. 17, the point cloud encoding apparatus 20 may include:
a mode determining unit 21, configured to determine an encoding mode of a current point in a current node, where the current node is a node to be encoded in a current picture to be encoded; and
an encoding unit 22, configured to, in a case where the encoding mode of the current point is a skip encode mode (skipCodeMode), skip encoding of geometric information of the current point.

In some embodiments, the mode determining unit 21 is specifically configured to: determine whether the current node meets a start condition of the skipCodeMode; and determine the encoding mode of the current point based on whether the current node meets the start condition of the skipCodeMode.

In some embodiments, the mode determining unit 21 is specifically configured to: determine N prediction nodes of the current node in prediction reference pictures of the current picture to be encoded, where the prediction nodes are nodes corresponding to the current node in the prediction reference pictures of the current picture to be encoded, and N is a positive integer; and determine whether the current node meets the start condition of the skipCodeMode based on the number of points included in at least one prediction node among the N prediction nodes.

In some embodiments, the current picture to be encoded includes K prediction reference pictures, and the mode determining unit 21 is specifically configured to: for a k-th prediction reference picture among the K prediction reference pictures, determine at least one prediction node of the current node in the k-th prediction reference picture, where k is a positive integer less than or equal to K, and K is a positive integer; and determine the N prediction nodes of the current node based on at least one prediction node of the current node in the K prediction reference pictures.

In some embodiments, the mode determining unit 21 is specifically configured to determine M neighborhood nodes of the current node in the current picture to be encoded, where the M neighborhood nodes include the current node, and M is a positive integer; for an i-th neighborhood node among the M neighborhood nodes, determine a corresponding node of the i-th neighborhood node in the k-th prediction reference picture, where i is a positive integer less than or equal to M; and determine the at least one prediction node of the current node in the k-th prediction reference picture based on corresponding nodes of the M neighborhood nodes in the k-th prediction reference picture.

In some embodiments, the mode determining unit 21 is specifically configured to determine a corresponding node of the current node in the k-th prediction reference picture; determine at least one neighborhood node of the corresponding node; and determine the at least one neighborhood node as the at least one prediction node of the current node in the k-th prediction reference picture.

In some embodiments, the mode determining unit 21 is specifically configured to determine a parent node of an i-th node as an i-th parent node in the current picture to be encoded, where the i-th node is the i-th neighborhood node or the current node; determine a matching node of an i-th parent node in the k-th prediction reference picture as an i-th matching node; and determine one of child nodes of the i-th matching node as a corresponding node of the i-th node in the k-th prediction reference picture.

In some embodiments, the mode determining unit 21 is specifically configured to determine a node, whose occupancy information has the smallest difference from occupancy information of the i-th parent node, in the k-th prediction reference picture as the matching node of the i-th parent node in the k-th prediction reference picture.

In some embodiments, the mode determining unit 21 is specifically configured to: determine a first sequence number of the i-th node among the child nodes included in the parent node; and determine a child node with the first sequence number among the child nodes of the i-th matching node as the corresponding node of the i-th node in the k-th prediction reference picture.

In some embodiments, in a case where the current picture to be encoded is a P frame, the K prediction reference pictures include a forward picture of the current picture to be encoded.

In some embodiments, in a case where the current picture to be encoded is a B frame, the K prediction reference pictures include at least one of: a forward picture of the current picture to be encoded or a backward picture of the current picture to be encoded.

In some embodiments, the start condition of the skipCodeMode includes any one of: the number of points included in the prediction nodes being greater than or equal to a first numerical value; the number of points included in the prediction nodes being equal to the number of points included in the current node; or the number of points included in the prediction nodes being equal to the number of points included in the current node, and a direct encoding model of the prediction nodes being the same as a direct encoding model of the current node.

In some embodiments, in a case where the start condition includes the number of points included in the prediction nodes being greater than or equal to the first numerical value, the mode determining unit 21 is specifically configured to: obtain the number of points included in the N prediction nodes; and in response to that the number of points included in the at least one prediction node among the N prediction nodes is greater than or equal to the first numerical value, determine that the current node meets the start condition of the skipCodeMode.

In some embodiments, the first numerical value is a positive integer greater than 0.

In some embodiments, in a case where the start condition includes the number of points included in the prediction nodes being equal to the number of points included in the current node, the mode determining unit 21 is specifically configured to: obtain the number of points included in the current node and the number of points included in the N prediction nodes; and in response to that the number of points included in the current node is equal to the number of points included in the at least one prediction node among the N prediction nodes, determine that the current node meets the start condition of the skipCodeMode.

In some embodiments, in a case where the start condition includes the number of points included in the prediction nodes being equal to the number of points included in the current node and the direct encoding model of the prediction nodes being the same as the direct encoding model of the current node, the mode determining unit 21 is specifically configured to: obtain the number of points included in the current node and the direct encoding model of the current node, and the number of points included in the N prediction nodes and the direct encoding model of the prediction nodes; and in response to that the number of points included in the current node is equal to the number of points included in the at least one prediction node among the N prediction nodes and the direct encoding model of the current node is the same as a direct encoding model of the at least one prediction node, determine that the current node meets the start condition of the skipCodeMode.

In some embodiments, the encoding unit 22 is further configured to encode a second flag into a bitstream, where the second flag is used to indicate whether the current node meets the start condition of the skipCodeMode.

In some embodiments, the encoding unit 22 is further configured to: in a case where the current node meets the start condition of the skipCodeMode, determine that a value of the second flag is a third value; and in a case where the current node does not meet the start condition of the skipCodeMode, determine that the value of the second flag is a fourth value.

In some embodiments, the mode determining unit 21 is specifically configured to, in a case where the current node meets the start condition of the skipDecodeMode, determine that an encoding mode of geometric information for at least one component of the current point is the skipCodeMode.

In some embodiments, the mode determining unit 21 is specifically configured to: in a case where the current node meets the start condition of the skipDecodeMode, determine at least one prediction point of the current point among points included in the N prediction nodes of the current node, determine an error between the geometric information of the current point and geometric information of the at least one prediction point; and determine the encoding mode of the current point based on the error.

In some embodiments, the mode determining unit 21 is specifically configured to: select the at least one prediction node from the N prediction nodes based on the start condition of the skipCodeMode; and determine the at least one prediction point of the current point based on the points included in the at least one prediction node.

In some embodiments, the mode determining unit 21 is specifically configured to: for any one prediction point of the at least one prediction point, determine an error between the geometric information of the current point and geometric information of the prediction point, to obtain an error corresponding to the prediction point; and determine an average of errors corresponding to all of the at least one prediction point as the error between the geometric information of the current point and the geometric information of the at least one prediction point.

In some embodiments, the mode determining unit 21 is specifically configured to: determine an average of the geometric information of the at least one prediction point to obtain first geometric information; and determine an error between the geometric information of the current point and the first geometric information as the error between the geometric information of the current point and the geometric information of the at least one prediction point.

In some embodiments, the mode determining unit 21 is specifically configured to: in response to that the error is less than or equal to a second numerical value, determine that the encoding mode of the current point is the skipCodeMode; and in response to that the error is greater than the second numerical value, determine that the encoding mode of the current point is not the skipCodeMode.

In some embodiments, the second numerical value is 0.

In some embodiments, the second numerical value is a number of bits required to encode the geometric information of the current point.

In some embodiments, the encoding unit 22 is further configured to encode a first flag into a bitstream, where the first flag is used to indicate whether the current point uses the skipCodeMode.

In some embodiments, the encoding unit 22 is specifically configured to skip encoding of geometric information for at least one component of the current node.

In some embodiments, the encoding unit 22 is specifically configured to skip encoding of the geometric information for all components of the current node.

In some embodiments, the encoding unit 22 is specifically configured to: skip encoding of geometric information of the current node for an i-th component, determine an encoding mode used for geometric information of the current point for a j-th component, and encode the geometric information of the current point for the j-th component based on the encoding mode. In a case where the point cloud is a non-lidar point cloud, the i-th component is an X-coordinate component, a Y-coordinate component or a Z-coordinate component, and the j-th component is an X-coordinate component, a Y-coordinate component or a Z-coordinate component; in a case where the point cloud is a lidar point cloud, the i-th component is an X-coordinate component, a Y-coordinate component, a laser ray index or a geometric residual of a Z-coordinate, and the j-th component is an X-coordinate component, a Y-coordinate component, a laser ray index or a geometric residual of a Z-coordinate; and the i-th component is different from the j-th component.

It should be understood that the apparatus embodiments and the method embodiments may correspond to each other, and similar descriptions may be referred to that of the method embodiments, which will not be repeated here to avoid repetition. Specifically, the point cloud encoding apparatus 20 shown in FIG. 17 may correspond to a corresponding subject performing the point cloud encoding method in the embodiments of the present application, and the above and other operations and/or functions of each unit in the point cloud encoding apparatus 20 are respectively for implementing corresponding processes in the point cloud encoding method, which will not be repeated here for the sake of brevity.

The above describes the apparatuses and the system of the embodiments of the present application from the perspective of functional units in conjunction with the accompanying drawings. It should be understood that the functional units may be implemented in the form of hardware, or may be implemented by instructions in the form of software, or may be implemented by a combination of hardware units and software units. Specifically, each step of the method embodiments in the embodiments of the present application may be completed by the hardware integrated logic circuit and/or software instructions in the processor. The steps of the method disclosed in the embodiments of the present application may be directly reflected as being performed by a hardware decoding processor, or being performed by a combination of hardware units and software units in the decoding processor. Optionally, the software unit may be located in a mature storage medium in the art, such as a random access memory, a flash memory, a read-only memory, a programmable read-only memory, an electrically erasable programmable memory, and a register. The storage medium is located in the memory, and the processor reads the information in the memory and completes the steps in the above method embodiments in conjunction with its hardware.

FIG. 18 is a schematic block diagram of an electronic device provided in the embodiments of the present application.

As shown in FIG. 18, the electronic device 30 may be the point cloud decoding apparatus or the point cloud encoding apparatus as described in the embodiments of the present application, and the electronic device 30 may include:
a memory 31 and a processor 32, where the memory 31 is used to store a computer program 34 and transmit the computer program 34 to the processor 32, in other words, the processor 32 may call the computer program 34 from the memory 31 and run the computer program 34, to implement the method in the embodiments of the present application.

For example, the processor 32 may be used to perform the steps in the method according to the instructions in the computer program 34.

In some embodiments of the present application, the processor 32 may include but is not limited to:
a general purpose processor, a digital signal processor (DSP), an application specific integrated circuits (ASIC), a field programmable gate array (FPGA) or other programmable logic device, a discrete gate. a transistor logic device, a discrete hardware component, or the like.

In some embodiments of the present application, the memory 31 includes but is not limited to:
a volatile (transitory) memory and/or a non-volatile (non-transitory) memory, where the non-volatile memory may be a read-only memory (ROM), a programmable read-only memory (programmable ROM, PROM), an erasable programmable read-only memory (Erasable PROM, EPROM), an electrically erasable programmable read-only memory (Electrically, EEPROM), or a flash memory; and the volatile memory may be a random access memory (RAM), serving as an external cache. As an example and not limitation, a variety of forms of RAMs are available, such as a static random access memory (Static RAM, SRAM), a dynamic random access memory (Dynamic RAM, DRAM), a synchronous dynamic random access memory (Synchronous, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM), and a direct memory bus random access memory (Direct Rambus RAM, DR RAM).

In some embodiments of the present application, the computer program 34 may be partitioned into one or more units. The one or more units are stored in the memory 31 and performed by the processor 32, to complete the method provided in the present application. The one or more units may be a series of computer program instruction segments capable of completing specific functions, and the instruction segments are used to describe the performing process of the computer program 34 in the electronic device 30.

As shown in FIG. 20, the electronic device 30 may further include:
a transceiver 33, where the transceiver 33 is connectable to the processor 32 or the memory 31.

The processor 32 may control the transceiver 33 to communicate with other devices, and specifically, may control the transceiver 33 to transmit information or data to other devices, or control the transceiver 33 to receive information or data transmitted by other devices. The transceiver 33 may include a transmitter and a receiver. The transceiver 33 may further include an antenna, and there may be one or more antennas.

It should be understood that various components in the electronic device 30 are connected via a bus system, where the bus system includes not only a data bus but also a power bus, a control bus and a status signal bus.

FIG. 19 is a schematic block diagram of a point cloud encoding and decoding system provided in the embodiments of the present application.

As shown in FIG. 19, the point cloud encoding and decoding system 40 may include: a point cloud encoder 41 and a point cloud decoder 42, where the point cloud encoder 41 is used to perform the point cloud encoding method involved in the embodiments of the present application, and the point cloud decoder 42 is used to perform the point cloud decoding method involved in the embodiments of the present application.

The present application further provides a bitstream, which is generated according to the above encoding method.

The present application further provides a non-transitory computer-readable storage medium with a computer program stored thereon. The computer program, when performed on a computer, enables the computer to perform the method of the above method embodiments. In other words, the embodiments of the present application further provide a computer program product including instructions, where the instructions, when performed on a computer, enable the computer to perform the method of the above method embodiments.

When implemented using software, all or part of the above embodiments may be implemented in a form of a computer program product. The computer program product includes one or more computer instructions. When loaded and executed on a computer, the computer program instructions produce, in all or in part, a process or function in accordance with the embodiments of the present application. The computer may be a general purpose computer, a special purpose computer, a computer network, or any of other programmable apparatuses. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server, or a data center to another website, computer, server, or data center through wired manner (e.g., coaxial cable, optical fiber, or digital subscriber line (DSL)) or wireless (e.g., infrared, radio, or microwave) manner. The non-transitory computer-readable storage medium may be any available medium to which a computer can access or may be a data storage device, such as a server or a data center that includes one or more available media. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present application.

In several embodiments provided by the present application, it should be understood that the disclosed system, apparatuses and methods may be implemented in other manners. For example, the apparatus embodiments described above are only schematic. For example, the partition of the units is only partition of logical functions, and there may be other partition manners in the actual implementation, such as a plurality of units or components may be combined or integrated into another system, or some features may be ignored or not implemented. In addition, the mutual coupling or direct coupling or communication connection illustrated or discussed may be indirect coupling or communication connection through some interfaces, apparatuses or units, which may be in electrical, mechanical or other forms.

The units described as discrete components may or may not be physically separated, and the components shown as units may or may not be physical units, that is, they may be located at one place, or may be distributed onto a plurality of network units. Some or all of these units may be selected depending on actual requirements to fulfill the purpose of the solution of the embodiments. For example, various functional units in various embodiments of the present application may be integrated into one processing unit, or various units may exist physically alone, or two or more units may be integrated into one unit.

The foregoing descriptions are merely specific implementations of the present application, but the protection scope of the present application is not limited thereto. Any skilled person in the art could readily conceive of variations or replacements within the technical scope of the present application, which shall be all included in the protection scope of the present application. Therefore, the protection scope of the present application shall be subject to the protection scope of claims.

In a first clause, a point cloud decoding method is provided, which includes:
determining a decoding mode of a current point in a current node, where the current node is a node to be decoded in a current picture to be decoded;
in a case where the decoding mode of the current point is a skip decode mode (skipDecodeMode), determining at least one prediction point of the current point among points included in N prediction nodes of the current node, where the prediction nodes are nodes corresponding to the current node in prediction reference pictures of the current picture to be decoded, the skipDecodeMode is a mode for skipping decoding of geometric information of the current point, and N is a positive integer; and
determining the geometric information of the current point based on geometric information of the at least one prediction point.

In a second clause, the method according to the first clause, where determining the decoding mode of the current point in the current node includes:
determining whether the current node meets a start condition of the skipDecodeMode; and
determining the decoding mode of the current point based on whether the current node meets the start condition of the skipDecodeMode.

In a third clause, the method according to the second clause, where determining the decoding mode of the current point according to whether the current node meets the start condition of the skipDecodeMode includes:

in a case where the current node meets the start condition of the skipDecodeMode, determining that a decoding mode of geometric information for at least one component of the current point is the skipDecodeMode.

In a fourth clause, the method according to the second clause, where determining the decoding mode of the current point according to whether the current node meets the start condition of the skipDecodeMode includes:
in a case where the current node meets the start condition of the skipDecodeMode, decoding a bitstream to obtain a first flag, where the first flag is used to indicate whether the current point uses the skipDecodeMode, and the first flag is determined based on an error between the geometric information of the current point and the geometric information of the at least one prediction point; and
determining the decoding mode of the current point based on the first flag.

In a fifth clause, the method according to the fourth clause, where determining the decoding mode of the current point based on the first flag includes:
in response to that a value of the first flag is a first value, determining that the decoding mode of the current point is the skipDecodeMode; and
in response to that the value of the first flag is a second value, determining that the decoding mode of the current point is not the skipDecodeMode.

In a sixth clause, the method according to the fifth clause, where in a case where the error between the geometric information of the current point and the geometric information of the prediction point is less than or equal to a second numerical value, the value of the first flag is the first value.

In a seventh clause, the method according to the sixth clause, where the second numerical value is 0.

In an eighth clause, the method according to the sixth clause, where the second numerical value is a number of bits required to encode the geometric information of the current point.

In a ninth clause, the method according to any one of the second clause to the eighth clause, where the start condition of the skipDecodeMode includes any one of: a number of points included in the prediction nodes being greater than or equal to a first numerical value; the number of points included in the prediction nodes being equal to a number of points included in the current node; or the number of points included in the prediction nodes being equal to the number of points included in the current node, and a direct decoding mode of the prediction nodes being the same as a direct decoding mode of the current node.

In a tenth clause, the method according to the ninth clause, where determining whether the current node meets the start condition of the skipDecodeMode includes:
decoding a bitstream to obtain a second flag, where the second flag is used to indicate whether the current node meets the start condition of the skipDecodeMode; and
determining whether the current node meets the start condition of the skipDecodeMode based on the second flag.

In a eleventh clause, the method according to the tenth clause, where determining whether the current node meets the start condition of the skipDecodeMode based on the second flag includes:
in response to that a value of the second flag is a third value, determining that the current node meets the start condition of the skipDecodeMode; and
in response to that the value of the second flag is a fourth value, determining that the current node does not meet the start condition of the skipDecodeMode.

In a twelfth clause, the method according to the ninth clause, where determining whether the current node meets the start condition of the skipDecodeMode includes:
determining the N prediction nodes of the current node in the prediction reference pictures of the current picture to be decoded; and
determining whether the current node meets the start condition of the skipDecodeMode based on a number of points included in at least one prediction node among the N prediction nodes.

In a thirteenth clause, the method according to the twelfth clause, where in a case where the start condition includes the number of points included in the prediction nodes being greater than or equal to the first numerical value, determining whether the current node meets the start condition of the skipDecodeMode based on the number of points included in the at least one prediction node among the N prediction nodes includes:
obtaining a number of points included in the N prediction nodes; and
in response to that the number of points included in the at least one prediction node among the N prediction nodes is greater than or equal to the first numerical value, determining that the current node meets the start condition of the skipDecodeMode.

In a fourteenth clause, the method according to the thirteenth clause, where the first numerical value is a positive integer.

In a fifteenth clause, the method according to the twelfth clause, where in a case where the start condition includes the number of points included in the prediction nodes being equal to the number of points included in the current node, determining whether the current node meets the start condition of the skipDecodeMode based on the number of points included in the at least one prediction node among the N prediction nodes includes:
obtaining the number of points included in the current node and a number of points included in the N prediction nodes; and
in response to that the number of points included in the current node is equal to the number of points included in the at least one prediction node among the N prediction nodes, determining that the current node meets the start condition of the skipDecodeMode.

In a sixteenth clause, the method according to the twelfth clause, where in a case where the start condition includes the number of points included in the prediction nodes being equal to the number of points included in the current node and the direct decoding mode of the prediction nodes being the same as the direct decoding mode of the current node, determining whether the current node meets the start condition of the skipDecodeMode based on the number of points included in the at least one prediction node among the N prediction nodes includes:
obtaining the number of points included in the current node and the direct decoding mode of the current node, and the number of points included in the N prediction nodes and the direct decoding mode of the prediction nodes; and
in response to that the number of points included in the current node is equal to the number of points included in the at least one prediction node among the N prediction nodes and the direct decoding mode of the current node is the same as a direct decoding mode of the at least one prediction node, determining that the current node meets the start condition of the skipDecodeMode.

In a seventeenth clause, the method according to the ninth clause, where before determining the at least one prediction point of the current point among the points included in the N prediction nodes of the current node, the method further includes:
determining the N prediction nodes of the current node in the prediction reference pictures of the current picture to be decoded;
where determining the at least one prediction point of the current point among the points included in the N prediction nodes of the current node includes:
selecting the at least one prediction node from the N prediction nodes based on the start condition of the skipDecodeMode; and
determining the at least one prediction point of the current point based on points included in the at least one prediction node.

In a eighteenth clause, the method according to the twelfth clause or the seventeenth clause, where the current picture to be decoded includes K prediction reference pictures, and determining the N prediction nodes of the current node in the prediction reference pictures of the current picture to be decoded includes:
for a k-th prediction reference picture among the K prediction reference pictures, determining at least one prediction node of the current node in the k-th prediction reference picture, where k is a positive integer less than or equal to K, and K is a positive integer; and
determining the N prediction nodes of the current node based on at least one prediction node of the current node in the K prediction reference pictures.

In a nineteenth clause, the method according to the eighteenth clause, where determining the at least one prediction node of the current node in the k-th prediction reference picture includes:
determining M neighborhood nodes of the current node in the current picture to be decoded, where the M neighborhood nodes include the current node, and M is a positive integer;
for an i-th neighborhood node among the M neighborhood nodes, determining a corresponding node of the i-th neighborhood node in the k-th prediction reference picture, where i is a positive integer less than or equal to M; and
determining the at least one prediction node of the current node in the k-th prediction reference picture based on corresponding nodes of the M neighborhood nodes in the k-th prediction reference picture.

In a twentieth clause, the method according to the eighteenth clause, where determining the at least one prediction node of the current node in the k-th prediction reference picture includes:
determining a corresponding node of the current node in the k-th prediction reference picture;
determining at least one neighborhood node of the corresponding node; and
determining the at least one neighborhood node as the at least one prediction node of the current node in the k-th prediction reference picture.

In a twenty-first clause, the method according to the nineteenth clause or the twentieth clause, where the method further includes:
determining a parent node of an i-th node as an i-th parent node in the current picture to be decoded, where the i-th node is the i-th neighborhood node or the current node;
determining a matching node of an i-th parent node in the k-th prediction reference picture as an i-th matching node; and
determining one of child nodes of the i-th matching node as a corresponding node of the i-th node in the k-th prediction reference picture.

In a twenty-second clause, the method according to the twenty-first clause, where determining the matching node of the i-th parent node in the k-th prediction reference picture includes:
determining a node, whose occupancy information has a smallest difference from occupancy information of the i-th parent node, in the k-th prediction reference picture as the matching node of the i-th parent node in the k-th prediction reference picture.

In a twenty-third clause, the method according to the twenty-first clause, where determining the one of the child nodes of the i-th matching node as the corresponding node of the i-th node in the k-th prediction reference picture includes:
determining a first sequence number of the i-th node among child nodes included in the parent node; and
determining a child node with the first sequence number among the child nodes of the i-th matching node as the corresponding node of the i-th node in the k-th prediction reference picture.

In a twenty-fourth clause, the method according to the eighteenth clause, where in a case where the current picture to be decoded is a P frame, the K prediction reference pictures include a forward picture of the current picture to be decoded.

In a twenty-fifth clause, the method according to the eighteenth clause, where in a case where the current picture to be decoded is a B frame, the K prediction reference pictures include at least one of: a forward picture of the current picture to be decoded or a backward picture of the current picture to be decoded.

In a twenty-sixth clause, the method according to the eighteenth clause, where determining the at least one prediction point of the current point based on the points included in the at least one prediction node includes:
for any one prediction node of the at least one prediction node, in response to that the prediction node includes a point, determining the point included in the prediction node as a prediction point of the current point; and
in response to that the prediction node includes multiple non-duplicate points, determining a point in the prediction node that has a same ranking as the current point in the current node as the prediction point of the current point.

In a twenty-seventh clause, the method according to the first clause, where determining the geometric information of the current point based on the geometric information of the at least one prediction point includes:
obtaining first geometric information based on the geometric information of the at least one prediction point; and
determining geometric information for at least one component of the current point based on the first geometric information.

In a twenty-eighth clause, the method according to the twenty-seventh clause, where obtaining the first geometric information based on the geometric information of the at least one prediction point includes:
determining an average of the geometric information of the at least one prediction point as the first geometric information.

In a twenty-ninth clause, the method according to the twenty-seventh clause, where determining the geometric information for the at least one component of the current point based on the first geometric information includes:
determining the first geometric information as the geometric information of the current point.

In a thirtieth clause, the method according to the twenty-seventh clause, where determining the geometric information for the at least one component of the current point based on the first geometric information includes:
determining geometric information of the first geometric information for an i-th component as geometric information of the current point for the i-th component; and
determining a decoding mode used for geometric information of the current point for a j-th component, and decoding the geometric information of the current point for the j-th component based on the decoding mode;
where in a case where the point cloud is a non-lidar point cloud, the i-th component is an X-coordinate component, a Y-coordinate component or a Z-coordinate component, and the j-th component is an X-coordinate component, a Y-coordinate component or a Z-coordinate component; in a case where the point cloud is a lidar point cloud, the i-th component is an X-coordinate component, a Y-coordinate component, a laser ray index or a geometric residual of a Z-coordinate, and the j-th component is an X-coordinate component, a Y-coordinate component, a laser ray index or a geometric residual of a Z-coordinate; and the i-th component is different from the j-th component.

In a thirty-first clause, a point cloud encoding method is provided, which includes:
determining an encoding mode of a current point in a current node, where the current node is a node to be encoded in a current picture to be encoded; and
in a case where the encoding mode of the current point is a skip encode mode (skipCodeMode), skipping encoding of geometric information of the current point.

In a thirty-second clause, the method according to the thirty-first clause, where determining the encoding mode of the current point in the current node includes:
determining whether the current node meets a start condition of the skipCodeMode; and
determining the encoding mode of the current point based on whether the current node meets the start condition of the skipCodeMode.

In a thirty-third clause, the method according to thirty-second clause, where determining whether the current node meets the start condition of the skipCodeMode includes:
determining N prediction nodes of the current node in prediction reference pictures of the current picture to be encoded, where the prediction nodes are nodes corresponding to the current node in the prediction reference pictures of the current picture to be encoded, and N is a positive integer; and
determining whether the current node meets the start condition of the skipCodeMode based on a number of points included in at least one prediction node among the N prediction nodes.

In a thirty-fourth clause, the method according to the thirty-third clause, where the current picture to be encoded includes K prediction reference pictures; and determining the N prediction nodes of the current node in the prediction reference pictures of the current picture to be encoded includes:
for a k-th prediction reference picture among the K prediction reference pictures, determining at least one prediction node of the current node in the k-th prediction reference picture, where k is a positive integer less than or equal to K, and K is a positive integer; and
determining the N prediction nodes of the current node based on at least one prediction node of the current node in the K prediction reference pictures.

In a thirty-fifth clause, the method according to the thirty-fourth clause, where determining the at least one prediction node of the current node in the k-th prediction reference picture includes:
determining M neighborhood nodes of the current node in the current picture to be encoded, where the M neighborhood nodes include the current node, and M is a positive integer;
for an i-th neighborhood node among the M neighborhood nodes, determining a corresponding node of the i-th neighborhood node in the k-th prediction reference picture, where i is a positive integer less than or equal to M; and
determining the at least one prediction node of the current node in the k-th prediction reference picture based on corresponding nodes of the M neighborhood nodes in the k-th prediction reference picture.

In a thirty-sixth clause, the method according to the thirty-fourth clause, where determining the at least one prediction node of the current node in the k-th prediction reference picture includes:
determining a corresponding node of the current node in the k-th prediction reference picture;
determining at least one neighborhood node of the corresponding node; and
determining the at least one neighborhood node as the at least one prediction node of the current node in the k-th prediction reference picture.

In a thirty-seventh clause, the method according to the thirty-fifth clause or the thirty-sixth clause, where the method further includes:
determining a parent node of an i-th node as an i-th parent node in the current picture to be encoded, where the i-th node is the i-th neighborhood node or the current node;
determining a matching node of an i-th parent node in the k-th prediction reference picture as an i-th matching node; and
determining one of child nodes of the i-th matching node as a corresponding node of the i-th node in the k-th prediction reference picture.

In a thirty-eighth clause, the method according to the thirty-seventh clause, where determining the matching node of the i-th parent node in the k-th prediction reference picture includes:
determining a node, whose occupancy information has a smallest difference from occupancy information of the i-th parent node, in the k-th prediction reference picture as the matching node of the i-th parent node in the k-th prediction reference picture.

In a thirty-ninth clause, the method according to the thirty-seventh clause, where determining the one of the child nodes of the i-th matching node as the corresponding node of the i-th node in the k-th prediction reference picture includes:
determining a first sequence number of the i-th node among the child nodes included in the parent node; and
determining a child node with the first sequence number among the child nodes of the i-th matching node as the corresponding node of the i-th node in the k-th prediction reference picture.

In a fortieth clause, the method according to the thirty-fourth clause, where in a case where the current picture to be encoded is a P frame, the K prediction reference pictures include a forward picture of the current picture to be encoded.

In a forty-first clause, the method according to the thirty-fourth clause, where in a case where the current picture to be encoded is a B frame, the K prediction reference pictures include at least one of: a forward picture of the current picture to be encoded or a backward picture of the current picture to be encoded.

In a forty-second clause, the method according to the thirty-third clause, where the start condition of the skipCodeMode includes any one of: a number of points included in the prediction nodes being greater than or equal to a first numerical value; the number of points included in the prediction nodes being equal to a number of points included in the current node; or the number of points included in the prediction nodes being equal to the number of points included in the current node, and a direct encoding model of the prediction nodes being the same as a direct encoding model of the current node.

In a forty-third clause, the method according to the forty-second clause, where in a case where the start condition includes the number of points included in the prediction nodes being greater than or equal to the first numerical value, determining whether the current node meets the start condition of the skipCodeMode based on the number of points included in the at least one prediction node among the N prediction nodes includes:
obtaining a number of points included in the N prediction nodes; and
in response to that the number of points included in the at least one prediction node among the N prediction nodes is greater than or equal to the first numerical value, determining that the current node meets the start condition of the skipCodeMode.

In a forty-fourth clause, the method according to the forty-third clause, where the first numerical value is a positive integer greater than 0.

In a forty-fifth clause, the method according to the forty-second clause, where in a case where the start condition includes the number of points included in the prediction nodes being equal to the number of points included in the current node, determining whether the current node meets the start condition of the skipCodeMode based on the number of points included in the at least one prediction node among the N prediction nodes includes:
obtaining the number of points included in the current node and a number of points included in the N prediction nodes; and
in response to that the number of points included in the current node is equal to the number of points included in the at least one prediction node among the N prediction nodes, determining that the current node meets the start condition of the skipCodeMode.

In a forty-sixth clause, the method according to the forty-second clause, where in a case where the start condition includes that the number of points included in the prediction nodes being equal to the number of points included in the current node and the direct encoding model of the prediction nodes being the same as the direct encoding model of the current node, determining whether the current node meets the start condition of the skipCodeMode based on the number of points included in the at least one prediction node among the N prediction nodes includes:
obtaining the number of points included in the current node and the direct encoding model of the current node, and the number of points included in the N prediction nodes and the direct encoding model of the prediction nodes; and
in response to that the number of points included in the current node is equal to the number of points included in the at least one prediction node among the N prediction nodes and the direct encoding model of the current node is the same as a direct encoding model of the at least one prediction node, determining that the current node meets the start condition of the skipCodeMode.

In a forty-seventh clause, the method according to the thirty-third clause, where the method further includes:
encoding a second flag into a bitstream, where the second flag is used to indicate whether the current node meets the start condition of the skipCodeMode.

In a forty-eighth clause, The method according to the forty-seventh clause, where the method further includes:
in a case where the current node meets the start condition of the skipCodeMode, determining that a value of the second flag is a third value; and
in a case where the current node does not meet the start condition of the skipCodeMode, determining that the value of the second flag is a fourth value.

In a forty-ninth clause, the method according to the thirty-second clause, where determining the encoding mode of the current point based on whether the current node meets the start condition of the skipCodeMode includes:
in a case where the current node meets the start condition of the skipDecodeMode, determining that an encoding mode of geometric information for at least one component of the current point is the skipCodeMode.

In a fiftieth clause, The method according to the forty-second clause, where determining the encoding mode of the current point based on whether the current node meets the start condition of the skipCodeMode includes:
in a case where the current node meets the start condition of the skipDecodeMode, determining at least one prediction point of the current point among points included in the N prediction nodes of the current node;
determining an error between the geometric information of the current point and geometric information of the at least one prediction point; and
determining the encoding mode of the current point based on the error.

In a fifty-first clause, the method according to the fiftieth clause, where determining the at least one prediction point of the current point among the points included in the N prediction nodes of the current node includes:
selecting the at least one prediction node from the N prediction nodes based on the start condition of the skipCodeMode; and
determining the at least one prediction point of the current point based on points included in the at least one prediction node.

In a fifty-second clause, the method according to the fiftieth clause, where determining the error between the geometric information of the current point and the geometric information of the at least one prediction point includes:
for any one prediction point of the at least one prediction point, determining an error between the geometric information of the current point and geometric information of the prediction point, to obtain an error corresponding to the prediction point; and
determining an average of errors corresponding to all of the at least one prediction point as the error between the geometric information of the current point and the geometric information of the at least one prediction point.

In a fifty-third clause, the method according to the fiftieth clause, where the error between the geometric information of the current point and the geometric information of the at least one prediction point includes:
determining an average of the geometric information of the at least one prediction point to obtain first geometric information; and
determining an error between the geometric information of the current point and the first geometric information as the error between the geometric information of the current point and the geometric information of the at least one prediction point.

In a fifty-fourth clause, the method according to the fiftieth clause, where determining the encoding mode of the current point based on the error includes:
in response to that the error is less than or equal to a second numerical value, determining that the encoding mode of the current point is the skipCodeMode; and
in response to that the error is greater than the second numerical value, determining that the encoding mode of the current point is not the skipCodeMode.

In a fifty-fifth clause, the method according to the fifty-fourth clause, where the second numerical value is 0.

In a fifty-sixth clause, the method according to the fifty-fourth clause, where the second numerical value is a number of bits required to encode the geometric information of the current point.

In a fifty-seventh clause, the method according to the thirty-third clause, where the method further includes:
encoding a first flag into a bitstream, where the first flag is used to indicate whether the current point uses the skipCodeMode.

In a fifty-eighth clause, the method according to the thirty-first clause, where skipping the encoding of the geometric information of the current point includes:
skipping encoding of geometric information for at least one component of the current node.

In a fifty-ninth clause, the method according to the fifty-eighth clause, where skipping the encoding of the geometric information for the at least one component of the current node includes:
skipping encoding of geometric information for all components of the current node.

In a sixtieth clause, the method according to the fifty-eighth clause, where skipping the encoding of the geometric information for the at least one component of the current node includes:
skipping encoding of geometric information of the current node for an i-th component; and
determining an encoding mode used for geometric information of the current point for a j-th component, and encoding the geometric information of the current point for the j-th component based on the encoding mode;
where in a case where the point cloud is a non-lidar point cloud, the i-th component is an X-coordinate component, a Y-coordinate component or a Z-coordinate component, and the j-th component is an X-coordinate component, a Y-coordinate component or a Z-coordinate component; in a case where the point cloud is a lidar point cloud, the i-th component is an X-coordinate component, a Y-coordinate component, a laser ray index or a geometric residual of a Z-coordinate, and the j-th component is an X-coordinate component, a Y-coordinate component, a laser ray index or a geometric residual of a Z-coordinate; and the i-th component is different from the j-th component.

What is claimed is:

1. A point cloud decoding method, comprising:
determining a decoding mode of a current point in a current node, wherein the current node is a node to be decoded in a current picture to be decoded;
in a case where the decoding mode of the current point is a skip decode mode (skipDecodeMode), determining at least one prediction point of the current point among points comprised in N prediction nodes of the current node, wherein the prediction nodes are nodes corresponding to the current node in prediction reference pictures of the current picture to be decoded, the skipDecodeMode is a mode for skipping decoding of geometric information of the current point, and N is a positive integer; and
determining the geometric information of the current point based on geometric information of the at least one prediction point.

2. The method according to claim 1, wherein determining the decoding mode of the current point in the current node comprises:
determining whether the current node meets a start condition of the skipDecodeMode; and
determining the decoding mode of the current point based on whether the current node meets the start condition of the skipDecodeMode.

3. The method according to claim 2, wherein determining the decoding mode of the current point according to whether the current node meets the start condition of the skipDecodeMode comprises:
in a case where the current node meets the start condition of the skipDecodeMode, determining that a decoding mode of geometric information for at least one component of the current point is the skipDecodeMode;
or
determining the decoding mode of the current point according to whether the current node meets the start condition of the skipDecodeMode comprises:
in a case where the current node meets the start condition of the skipDecodeMode, decoding a bitstream to obtain a first flag, wherein the first flag is used to indicate whether the current point uses the skipDecodeMode, and the first flag is determined based on an error between the geometric information of the current point and the geometric information of the at least one prediction point; and
determining the decoding mode of the current point based on the first flag.

4. The method according to claim 3, wherein determining the decoding mode of the current point based on the first flag comprises:
in response to that a value of the first flag is a first value, determining that the decoding mode of the current point is the skipDecodeMode; and
in response to that the value of the first flag is a second value, determining that the decoding mode of the current point is not the skipDecodeMode;
wherein in a case where the error between the geometric information of the current point and the geometric information of the prediction point is less than or equal to a second numerical value, the value of the first flag is the first value.

5. The method according to claim 2, wherein the start condition of the skipDecodeMode comprises any one of: a number of points comprised in the prediction nodes being greater than or equal to a first numerical value; the number of points comprised in the prediction nodes being equal to a number of points comprised in the current node; or the number of points comprised in the prediction nodes being equal to the number of points comprised in the current node, and a direct decoding mode of the prediction nodes being the same as a direct decoding mode of the current node.

6. The method according to claim 5, wherein determining whether the current node meets the start condition of the skipDecodeMode comprises:
decoding a bitstream to obtain a second flag, wherein the second flag is used to indicate whether the current node meets the start condition of the skipDecodeMode; and
determining whether the current node meets the start condition of the skipDecodeMode based on the second flag;
wherein determining whether the current node meets the start condition of the skipDecodeMode based on the second flag comprises:
in response to that a value of the second flag is a third value, determining that the current node meets the start condition of the skipDecodeMode; and
in response to that the value of the second flag is a fourth value, determining that the current node does not meet the start condition of the skipDecodeMode.

7. The method according to claim 5, wherein determining whether the current node meets the start condition of the skipDecodeMode comprises:
determining the N prediction nodes of the current node in the prediction reference pictures of the current picture to be decoded; and
determining whether the current node meets the start condition of the skipDecodeMode based on a number of points comprised in at least one prediction node among the N prediction nodes.

8. The method according to claim 7, wherein in a case where the start condition comprises the number of points comprised in the prediction nodes being greater than or equal to the first numerical value, determining whether the current node meets the start condition of the skipDecodeMode based on the number of points comprised in the at least one prediction node among the N prediction nodes comprises:
obtaining a number of points comprised in the N prediction nodes; and
in response to that the number of points comprised in the at least one prediction node among the N prediction nodes is greater than or equal to the first numerical value, determining that the current node meets the start condition of the skipDecodeMode;
or
in a case where the start condition comprises the number of points comprised in the prediction nodes being equal to the number of points comprised in the current node, determining whether the current node meets the start condition of the skipDecodeMode based on the number of points comprised in the at least one prediction node among the N prediction nodes comprises:
obtaining the number of points comprised in the current node and a number of points comprised in the N prediction nodes; and
in response to that the number of points comprised in the current node is equal to the number of points comprised in the at least one prediction node among the N prediction nodes, determining that the current node meets the start condition of the skipDecodeMode;
or
in a case where the start condition comprises the number of points comprised in the prediction nodes being equal to the number of points comprised in the current node and the direct decoding mode of the prediction nodes being the same as the direct decoding mode of the current node, determining whether the current node meets the start condition of the skipDecodeMode based on the number of points comprised in the at least one prediction node among the N prediction nodes comprises:
obtaining the number of points comprised in the current node and the direct decoding mode of the current node, and the number of points comprised in the N prediction nodes and the direct decoding mode of the prediction nodes; and
in response to that the number of points comprised in the current node is equal to the number of points comprised in the at least one prediction node among the N prediction nodes and the direct decoding mode of the current node is the same as a direct decoding mode of the at least one prediction node, determining that the current node meets the start condition of the skipDecodeMode.

9. The method according to claim 5, wherein before determining the at least one prediction point of the current point among the points comprised in the N prediction nodes of the current node, the method further comprises:
determining the N prediction nodes of the current node in the prediction reference pictures of the current picture to be decoded;
wherein determining the at least one prediction point of the current point among the points comprised in the N prediction nodes of the current node comprises:
selecting the at least one prediction node from the N prediction nodes based on the start condition of the skipDecodeMode; and
determining the at least one prediction point of the current point based on points comprised in the at least one prediction node.

10. The method according to claim 7, wherein the current picture to be decoded comprises K prediction reference pictures, and determining the N prediction nodes of the current node in the prediction reference pictures of the current picture to be decoded comprises:
for a k-th prediction reference picture among the K prediction reference pictures, determining at least one prediction node of the current node in the k-th prediction reference picture, wherein k is a positive integer less than or equal to K, and K is a positive integer; and
determining the N prediction nodes of the current node based on at least one prediction node of the current node in the K prediction reference pictures.

11. The method according to claim 10, wherein determining the at least one prediction node of the current node in the k-th prediction reference picture comprises:
determining M neighborhood nodes of the current node in the current picture to be decoded, wherein the M neighborhood nodes comprise the current node, and M is a positive integer;
for an i-th neighborhood node among the M neighborhood nodes, determining a corresponding node of the i-th neighborhood node in the k-th prediction reference picture, wherein i is a positive integer less than or equal to M; and
determining the at least one prediction node of the current node in the k-th prediction reference picture based on corresponding nodes of the M neighborhood nodes in the k-th prediction reference picture;
or
determining the at least one prediction node of the current node in the k-th prediction reference picture comprises:
determining a corresponding node of the current node in the k-th prediction reference picture;
determining at least one neighborhood node of the corresponding node; and
determining the at least one neighborhood node as the at least one prediction node of the current node in the k-th prediction reference picture.

12. The method according to claim 11, wherein the method further comprises:
determining a parent node of an i-th node as an i-th parent node in the current picture to be decoded, wherein the i-th node is the i-th neighborhood node or the current node;
determining a matching node of an i-th parent node in the k-th prediction reference picture as an i-th matching node; and
determining one of child nodes of the i-th matching node as a corresponding node of the i-th node in the k-th prediction reference picture.

13. The method according to claim 10, wherein in a case where the current picture to be decoded is a P frame, the K prediction reference pictures comprise a forward picture of the current picture to be decoded;
or
in a case where the current picture to be decoded is a B frame, the K prediction reference pictures comprise at least one of: a forward picture of the current picture to be decoded or a backward picture of the current picture to be decoded.

14. The method according to claim 10, wherein determining the at least one prediction point of the current point based on the points comprised in the at least one prediction node comprises:
for any one prediction node of the at least one prediction node, in response to that the prediction node comprises a point, determining the point comprised in the prediction node as a prediction point of the current point; and
in response to that the prediction node comprises multiple non-duplicate points, determining a point in the prediction node that has a same ranking as the current point in the current node as the prediction point of the current point.

15. The method according to claim 1, wherein determining the geometric information of the current point based on the geometric information of the at least one prediction point comprises:
obtaining first geometric information based on the geometric information of the at least one prediction point; and
determining geometric information for at least one component of the current point based on the first geometric information.

16. The method according to claim 15, wherein obtaining the first geometric information based on the geometric information of the at least one prediction point comprises:
determining an average of the geometric information of the at least one prediction point as the first geometric information.

17. The method according to claim 15, wherein determining the geometric information for the at least one component of the current point based on the first geometric information comprises:
determining the first geometric information as the geometric information of the current point;
or
determining the geometric information for the at least one component of the current point based on the first geometric information comprises:
determining geometric information of the first geometric information for an i-th component as geometric information of the current point for the i-th component; and
determining a decoding mode used for geometric information of the current point for a j-th component, and decoding the geometric information of the current point for the j-th component based on the decoding mode;
wherein in a case where the point cloud is a non-lidar point cloud, the i-th component is an X-coordinate component, a Y-coordinate component or a Z-coordinate component, and the j-th component is an X-coordinate component, a Y-coordinate component or a Z-coordinate component; in a case where the point cloud is a lidar point cloud, the i-th component is an X-coordinate component, a Y-coordinate component, a laser ray index or a geometric residual of a Z-coordinate, and the j-th component is an X-coordinate component, a Y-coordinate component, a laser ray index or a geometric residual of a Z-coordinate; and the i-th component is different from the j-th component.

18. A point cloud encoding method, comprising:
determining an encoding mode of a current point in a current node, wherein the current node is a node to be encoded in a current picture to be encoded; and
in a case where the encoding mode of the current point is a skip encode mode (skipCodeMode), skipping encoding of geometric information of the current point.

19. The method according to claim 18, wherein determining the encoding mode of the current point in the current node comprises:
determining whether the current node meets a start condition of the skipCodeMode; and
determining the encoding mode of the current point based on whether the current node meets the start condition of the skipCodeMode.

20. A non-transitory computer-readable storage medium, wherein the non-transitory computer-readable storage medium is configured to store a computer program and a bitstream, and the computer program enables a computer to perform the following method, to generate the bitstream:
determining an encoding mode of a current point in a current node, wherein the current node is a node to be encoded in a current picture to be encoded; and
in a case where the encoding mode of the current point is a skip encode mode (skipCodeMode), skipping encoding of geometric information of the current point.
